(19) United States
(12) Patent Application Publication
(10) Pub. No.: US 2026/0017386 A1
(43) Pub. Date: Jan. 15, 2026

(54) Systems and Methods for Protecting Machine Learning (ML) Units, Artificial Intelligence (AI) Units, Large Language Model (LLM) Units, Deep Learning (DL) Units, and Reinforcement Learning (RL) Units

(71) Applicant: DEEPKEEP LTD., Tel Aviv (IL)

(72) Inventors: Rony Ohayon, Rehovot (IL); Jonathan Wagner, Rehovot (IL)

(21) Appl. No.: 19/332,096

(22) Filed: Sep. 18, 2025

Related U.S. Application Data
(63) Continuation-in-part of application No. 18/381,260, filed on Oct. 18, 2023, now Pat. No. 12,450,363.
Application No. 18/381,260 is a continuation-in-part of application No. PCT/IL2022/050397, filed on Apr. 14, 2022.
(60) Provisional application No. 63/176,375, filed on Apr. 19, 2021.

(51) Int. Cl. G06F 21/57

(52) U.S. Cl. CPC G06F 21/577; G06F 2221/034

(57) ABSTRACT

Systems and methods for protecting and fortifying machine learning engines, artificial intelligence (AI) engines, large language models, deep learning engines, reinforcement learning engines, and AI-based agentic units. An Offline Protection Unit analyzes characteristics of a Protected Engine, and performs offline fortification of the Protected Engine against attacks; by changing operational properties or operational parameters of the Protected Engine to reduce its vulnerability to attacks. An Online Protection Unit performs analysis of at least one of: (i) inputs that are intended to be inputs of the Protected Engine, (ii) outputs that are generated by the Protected Engine; and based on the analysis, dynamically performs online fortification of the Protected Engine against attacks; by dynamically changing operational properties or operational parameters of the Protected Engine to reduce its vulnerability to attacks.

### CROSS-REFERENCE TO RELATED APPLICATIONS

This patent application is a Continuation-in-Part (CIP) of U.S. Ser. No. 18/381,260, filed on Oct. 18, 2023, which is hereby incorporated by reference in its entirety; which is a Continuation-in-Part (CIP) of PCT international application number PCT/IL2022/050397, having an international filing date of Apr. 14, 2022, which is hereby incorporated by reference in its entirety; which claims priority and benefit from U.S. 63/176,375, filed on Apr. 19, 2021, which is hereby incorporated by reference in its entirety.

### FIELD

Some embodiments relate to the field of electronic systems

### BACKGROUND

Millions of people use electronic devices on a daily basis, such as, desktop computers, laptop computers, smartphones, tablets, or the like. Electronic devices are used for a variety of tasks; for example, to perform online purchases and transactions, to watch movies and consume digital content, to send and receive electronic mail (email) messages, to engage in online chat or Instant Messaging (IM), to participate in audio conferences or video conferences, to play games, or the like.

Some computer servers or applications may utilize Machine Learning (ML), Deep Learning (DL), Artificial Intelligence (AI), and other techniques, in order to analyze data and to generate analysis results or insights.

### SUMMARY

Some embodiments include devices and methods for protecting Machine Learning (ML) units or engines, Artificial Intelligence (AI) units or engines, Large Language Model (LLM) units or engines, and/or Deep Learning (DL) units or engines, as well as units or engines that perform Reinforcement Learning (RL) or Supervised Learning (SL), generative units or engines that are able to generate text and/or audio and/or speech and/or images and/or videos and/or other types of data, and/or units or engines that utilize a Neural Network (NN), units or engines that perform National Language Processing (NLP) and/or computer vision, and/or multi-modal units or engines, and/or units or engines that perform various other AI/ML/DL/LLM-based tasks; as well as transformer-based engines, and LLM engines or units (e.g., similar to Generative Pre-training Transformer (GPT) or GPT-4 or other/future versions of GPT from OpenAI or from other providers, or Llama from Meta or other providers, or Bard from Google or other providers), including (but not limited to) conversational generative AI bots or chat-bots or chat-based AI tools that are able to perform various AI-based operations (e.g., AI-based conversing with a user, answering questions, summarizing content, researching topics, solving problems and inquiries, and otherwise generating content in response to a prompt or a set of prompts which may include text and/or data and/or audio and/or images and/or video), and including multi-modal engines that can interact with (or process) a plurality of different types of data or prompts (e.g., a combination of text and/or numerical data and/or images and/or video and/or audio), transformer based models, diffusion based models, or the like.

Systems and methods for protecting machine learning engines, artificial intelligence engines, and deep learning engines. An Offline Protection Unit is configured to analyze one or more characteristics of a Protected Engine, and to perform offline fortification of the Protected Engine against attacks by changing operational properties or operational parameters of the Protected Engine to reduce its vulnerability to attacks. An Online Protection Unit is configured to perform analysis of at least one of: (i) inputs that are directed to be inputs of the Protected Engine, (ii) outputs that are generated by the Protected Engine; and based on the analysis, to dynamically perform online fortification of the Protected Engine against attacks by dynamically changing operational properties or operational parameters of the Protected Engine to reduce its vulnerability to attacks.

Some embodiments may provide additional and/or other benefits and/or advantages.

### BRIEF DESCRIPTION OF THE DRAWINGS

FIG. 1 is a schematic block-diagram illustration of a system and its components, in accordance with some demonstrative embodiments.

FIG. 2 is a schematic block-diagram illustration of a system and its multi-layer architecture, in accordance with some demonstrative embodiments.

FIG. 3 is a schematic block-diagram illustration of a sub-system for Real-World/Physical Attacks Protection of ML/DL/AI engines, in accordance with some demonstrative embodiments.

FIG. 4 is a schematic diagram demonstrating a process for finding weak spots of an ML/DL/AI engine or model, in accordance with some demonstrative embodiments.

### DETAILED DESCRIPTION OF SOME DEMONSTRATIVE EMBODIMENTS

The Applicant has realized that various electronic systems and information processing systems utilize Machine Learning (ML) units or analysis engines, Deep Learning (DL) units or analysis engines, and/or Artificial Intelligence (AI) units or analysis engines, in order to analyze or process data and to generate outputs (e.g., results, predictions, estimates, determination results, conclusions, insights, correlations, recommendations, actions (e.g., for robotic systems), textual output, numeric output, image output, video output, audio output, speech output, animation output, interactive output, chat-based output, a combination or a set of two or more outputted data-types, or the like). Such ML/DL/AI units are sometimes utilized to accomplish a task for which no fully deterministic and satisfactory algorithm is available.

The Applicant has realized that some ML/DL/AI systems may be subject to attacks or cyber-attacks or compromise attempts, by adversaries or competitors or hackers or third-parties. Some embodiments may provide devices and methods for protecting ML/DL/AI systems against such attacks, or for mitigating or curing such attacks, or for curing or reversing or decreasing or isolating the damage caused (or attempted) by such attacks.

For example, the Applicant has realized that some ML/DL/AI systems may be subject to an Evasion Attack, or an Adversarial Examples Attack. In such attack, for example, data that is fed to the ML/DL/AI system includes “adversarial examples”; input that should include only correct images of Cats, may now include (I) an image of a dog that is labeled as a cat, or (II) and image of a cat that was manipulated by adding to it “noise” or minuscule details that make the image still appear to be a cat in human eyes but that throws-off or confuses a classifier unit. In some situations, realized the Applicants, even a careful tampering with only few pixels in a digital image, may cause confusion and wrong classification at an ML/DL/AI system. The Applicant has realized that in such Evasion Attacks, the attacker does not attempt to penetrate into the ML/DL/AI system or to modify its manner of operation; but rather, the Evasion Attack injects or feeds or introduces to the ML/DL/AI system incorrect data, or incorrectly-classified data, or machine-confusing data, or data augmented with digital “noise” or addendums, or entirely incorrect data, or partially-incorrect data, or partially-replaced data, or data that was otherwise tampered with or manipulated, eventually causing the ML/DL/AI system to generate output that is different than what was expected by the designer of the ML/DL/AI system. The Applicant has also realized that such Evasion Attacks are not limited to image analysis or computer vision systems, and/or that the attack does not necessarily make the system run different code, but attempts to make the ML/DL/AI system perform a different task than the tasks that the operator or administrator or provider of the ML/DL/AI system had authorized or allowed or configured or intended, such as in reprogramming attacks or jailbreak attacks in which the attacker attempts to make an LLM generate textual output with forbidden or off-limits or unauthorized words or with regard to forbidden or off-limits or unauthorized topics, or such as image/video generative engines that an attacker may cause to generate visual outputs that are defined as forbidden or off-limits or unauthorized.; and/or other Evasion Attacks that may similarly be initiated against voice recognition/generative systems, text analysis/generative systems, video analysis/recognition/generative systems, image analysis/recognition/generative systems, audio analysis/recognition/generative systems, tabular data analysis/generative systems, LIDAR analysis systems, signal analysis/generative systems, timer series analysis systems, malware detection systems, financial systems and Fin-Tech systems (e.g., electronic loan issuance system, electronic mortgage issuance system, electronic credit card issuance system, electronic bank account opening system, electronic brokerage account or securities account opening system), ML/DL/AI systems that utilize (or, that operate on) real time or near-real-time data or data-items or data-streams (e.g., a live or near-live or real-time or near-real-time video stream, or video frames stream, or stock quotes stream, or securities transactions streams; an automated trading system; an automated vehicular driving system, and autonomous vehicular driving system, an Advanced Drive-Assistance System (ADAS), an automated industrial system that performs monitoring or sensing and analysis of data), a “black box” type of ML/DL/AI unit (e.g., that performs therein one or more ML/DL/AI tasks based on an input signal and that generates an output signal, such as a hardware component of a vehicle that performs ML/DL/AI tasks), and/or other systems.

The Applicant has also realized that some ML/DL/AI systems may be subject to a Stealing Attack, including a Model stealing attack and/or a Dataset stealing attack. For example, an adversary or a competitor may perform model extraction or model reconstruction or model imitation based on outputs generated by the ML/DL/AI system; or may leverage or improve the capabilities or the efficiency or the accuracy of the attacker's ML/DL/AI system (e.g., which trained on a public dataset) by utilizing or leveraging outputs from a competitor's ML/DL/AI system (e.g., which trained on a proprietary or private dataset); or may generate inferences (e.g., including extraction of personal data or private data) about data that is utilized by a ML/DL/AI system based on inquiries sent to that ML/DL/AI system and analysis of the outputs generated by that ML/DL/AI system.

The Applicant has further realized that some ML/DL/AI systems may be subject to a Reprogramming Attack. For example, the attacker leverages or abuses his ability to send queries to an existing ML/DL/AI system and to receive outputs from it, in order to achieve a new task that was not intended to be achieved (or facilitated) by the owner of the ML/DL/AI system. For example, an object detection ML/DL/AI system may be used or abused by an attacker to actually perform Optical Character Recognition (OCR) of texts; an image recognition ML/DL/AI system may be used or abused by an attacker to actually generate medical diagnosis results from images of people; or the like.

The Applicant has further realized that some ML/DL/AI systems may be subject to a Poisoning Attack. For example, the attacker performs Corruption Poisoning, by injecting to the training dataset a small or relatively small number of carefully-selected malicious examples, which may significantly damage or corrupt the operational accuracy of the ML/DL/AI system. In another example, the attacker performs Backdoor Poisoning, by injecting to the training dataset a small number of carefully-selected malicious examples that include a secret code or indicia, causing the ML/DL/AI system to generally operate as intended when encountering regular inputs, but also causing that ML/DL/AI system to classify a special type of input (which includes a similar secret code or indicia) in accordance with the attacker's intent when such input is fed to the ML/DL/AI system. The Applicant has realized that a Poisoning Attack may attempt to modify the operation of an ML/DL/AI system to operate in a particular manner that is desired by the attacker, in general or in response to a particular subsequent query or type of query; by injecting or introducing into the training dataset one or more malicious training data items (e.g., injecting a relatively small number of malicious data-items into the training dataset, compared to the large size of the entire training dataset). In some situations, such Poisoning Attack may be performed in real time or in near-real-time, or as a one-time event or as a periodic set of events; and may be performed directly towards the AI engine or AI system, and/or may be performed indirectly towards one or more units that collect data and periodically update or add data that an AI engine uses; including (for example) a recommender system or other AI-based systems.

The Applicant has realized that there is a need to protect ML/DL/AI systems against such attacks, as well as against other types of attacks or compromise attempts.

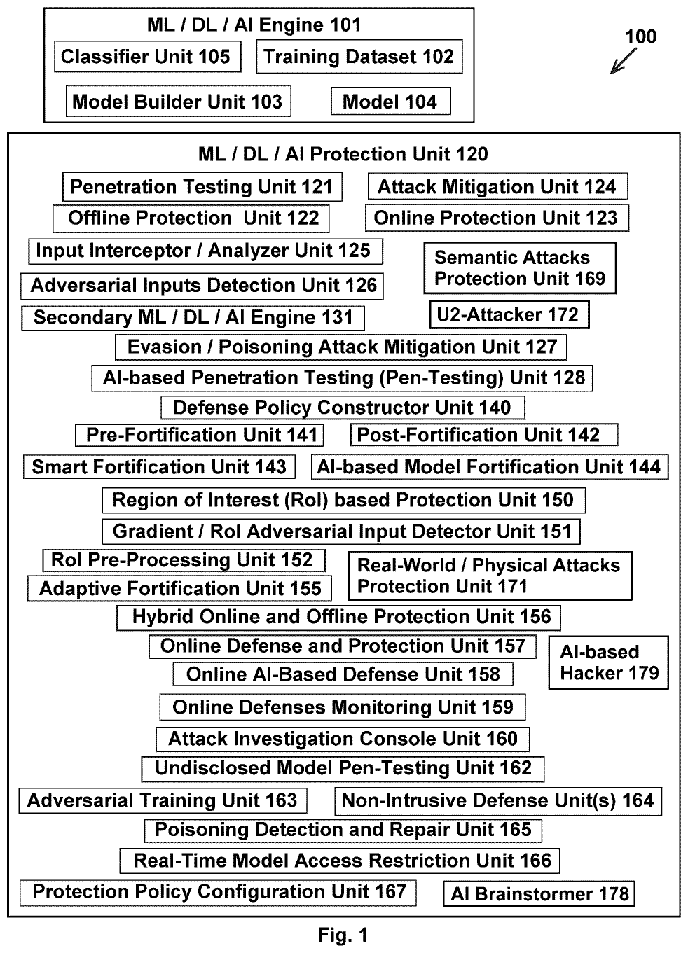

Reference is made to FIG. 1, which is a schematic block-diagram illustration of a system 100, in accordance with some demonstrative embodiments. System 100 may comprise an ML/DL/AI Engine 101, which is the unit (or sub-system, or system, or computer, or server, or set of computerized modules) that is being protected against attacks or abuse or malicious activity. The ML/DL/AI Engine 101 may also be referred to herein as “the protected ML/DL/AI Engine 101”, or “the ML/DL/AI Engine 101 being protected or evaluated”.

The ML/DL/AI Engine 101 may comprise or may use, for example: a Training Dataset 102 which is a large dataset of examples or labeled examples or already-classified examples; a Model Builder Unit 103 which constructs and/or updates a Model 104; a Classifier Unit 105 (or a “feature-izer” or “featurizer”, or labeler unit); and additional units or components, for example, an Evaluator unit, a Performance Monitor unit, a Ground Truth Collector unit, an Orchestrator unit that controls and commands other units, a Model Server optionally associated with an Application Programming Interface (API) to enable efficient reception of inputs and generation of outputs, a Front-End unit to provide metrics and to generate textual clarifications for numerical results, or the like).

In accordance with some embodiments, an ML/DL/AI Protection Unit 120 may protect the ML/DL/AI Engine 101 from or against cyber-attacks or attempts to compromise its operation, or from one or more particular attacks against such ML/DL/AI systems. For example, the ML/DL/AI Protection Unit 120, or one or more of its components or units or sub-systems (e.g., the Online Protection Unit 123, and/or other components of the ML/DL/AI Protection Unit 120) may be implemented using modular architecture which allows scalability and may provide a cloud service for multiple users, or may be installed locally as a licensed software component; or may be installed locally or on a network as a dedicated hybrid hardware and software unit; or may be operating as a “firewall device for ML/DL/AI engines”, which may be, for example, a locally-installed “firewall device for ML/DL/AI engines”, or a co-located “firewall device for ML/DL/AI engines”, or a server-based “firewall device for ML/DL/AI engines”, or a cloud-computing based “firewall device for ML/DL/AI engines”, or a dedicated local or remote or cloud-based machine or unit which operates as a “firewall device for ML/DL/AI engines”, or as a software unit which may be purchased or licensed, or as a hybrid hardware-and-software unit, or using other suitable deployment or configuration schemes. It is further noted that the above-mentioned implementation schemes and/or architecture may be utilized, in some embodiments, for implementing the entirety of the ML/DL/AI Protection Unit 120, or a particular component of ML/DL/AI Protection Unit 120, or a particular subset or group of components of ML/DL/AI Protection Unit 120.

The ML/DL/AI Protection Unit 120 may comprise, for example: a Penetration Testing Unit 121, configured to automatically or semi-automatically test or evaluate the robustness of the ML/DL/AI Engine 101 against different threats; an Offline Protection Unit 122, which operates to modify the structure and/or operation of the ML/DL/AI Engine 101 in order to enhance its security and resilience against attacks; an Online Protection Unit 123, which may perform one or more defensive services that protect the ML/DL/AI Engine 101 in real time or near real time.

In some embodiments, the Offline Protection Unit 122 may implement offline defense techniques for protecting the ML/DL/AI Engine 101. The Applicant has realized that some the ML/DL/AI Engines may assume an offline setting, such that the ML/DL/AI pipeline is fortified or secured during its development stage, and the resulting secure pipeline is then deployed and becomes available for receiving and processing incoming queries or inputs. In contrast to this approach, realized the Applicants, an online fortification technique operates to apply defenses to the ML/DL/AI Engine 101 online, by an external component or unit that has an interface to the AI pipeline in deployment, or that is otherwise operably associated with the ML/DL/AI Engine 101, or that is configured to operate as a gateway or as a filter or as a monitoring unit for incoming queries.

The Applicant has further realized that the online defense techniques in accordance with some embodiments may provide various advantages; for example, it may allow dynamic and/or modular application of defense techniques, it may allow easier and/or faster integration of defense techniques, it may enable protection of “black box” pipelines, and/or it may allow better separation between the development of security measures and the development of the ML/DL/AI functionality, and/or by providing online or cloud-based or remote protection systems or protection layers (e.g., remote or cloud-based detector units) which are non-intrusive and do not modify (and/or do not interfere with the regular operation of) the original ML/DL/AI model which the user (namely, the owner or operator or administrator or developer of the ML/DL/AI system) spent efforts and resources to construct and to fine-tune.

The Applicant has also realized that “offline protection”, such as via the Offline Protection Unit 122, may provide additional and/or other benefits or advantages. In accordance with some embodiments, “offline protection” of the ML/DL/AI Engine 101 may include, for example, receiving or analyzing or accessing the ML/DL/AI Engine 101 prior to its deployment, and performing one or more operations and/or modifications and/or additions in order to upgrade or secure or fortify the ML/DL/AI Engine 101 against attacks; and generating or returning an updated or upgraded or augmented version of the ML/DL/AI Engine 101, which is more secure or more fortified or more resilient than the original version thereof, and which can then be utilized and deployed.

In some embodiments, the Offline Protection Unit 122 may perform (or may be utilized for performing) one or more of the following protection and fortification techniques: (A) Dataset fortification, dataset “hardening”, dataset augmentation, pre-processing operations, data sanitization operations, data pruning operations; (B) Architecture fortification or architecture “hardening”, such as, by modifying the structure and/or architecture of Neural Networks (or other AI/ML/DL algorithms), by modifying the structure and/or architecture of the AI/ML/DL Pipeline, by replacing or removing or insecure elements (e.g., a Deep Neural Network (DNN) or other component) with a secure version or a more secure version thereof; (C) System parameters modification, for example, based on re-training, adversarial training, threshold modification, modification or introduction of threshold values, modification or introduction of operational conditions; (D) Architecture Augmentation, for example, by creation of ensembles of models, adding or modifying pre-processing elements or components, adding post-processing elements or components; (E) Adding attack detectors to the AI/ML/DL Pipeline, which may generate a notification or raise a flag or throw an exception when an input (or, a series or set of inputs) are identified as malicious or are estimated or determined to be malicious; (F) Other suitable techniques. In some embodiments, the protection system or platform may actively add Attack Detector(s) to the pipeline that the Protected Engine is part of, and/or may construct such a pipeline by adding Attack Detector(s) to a stand-alone Protected Engine; and/or by adding or invoking online Attack Detectors and/or offline Attack detectors; and/or by adding or invoking Attack Detectors that are stateless or that do not necessarily (or at all) maintain state (e.g., they analyze or classify each input signal by itself, ignoring previously-received or subsequently-received input signals); and/or by adding or invoking Attack Detectors that are stateful or that maintain state (e.g., they analyze or classify each input signal not only by itself, but also in relation to or in combination with one or more previously-received and/or subsequently-received input signals, thereby predicting or analyzing over a multiple-inputs set or series).

In some embodiments, at least some of the offline protection operations are performed automatically or semi-automatically by the Offline Protection Unit 122. For example, the Offline Protection Unit 122 may automatically analyze the structure and/or operations of the ML/DL/AI Engine 101; may automatically detect that the ML/DL/AI Engine 101 lacks a particular type of pre-processing component or post-processing component; and may automatically or semi-automatically (e.g., subject to an approval from a human administrator) augment the ML/DL/AI Engine 101 with the missing component(s). Similarly, the Offline Protection Unit 122 may automatically analyze the structure and/or operations of the ML/DL/AI Engine 101; may automatically detect that the ML/DL/AI Engine 101 lacks a particular filtering mechanism (e.g., a rate-limiting component or filter, that limits the number or the frequency of incoming queries from a particular sender); and may add or introduce such component or filter. In some embodiments, the protection operation(s) and/or the mitigation operation(s) may be dynamically selected by the protection platform, based on a set of rules for such operations selection, and/or based on the estimated or quantified severity of an estimated problem or an estimated attack, and/or based on the resources and protection techniques that are relevant and are available for protecting this particular ML/DL/AI engine of this particular system.

For example, the protection platform or its Offline Protection Unit 122 may submit 500 rapid queries within 1 second to the protected ML/DL/AI engine, and may observe that the ML/DL/AI engine struggles to generate timely output (e.g., within N milliseconds of each input signal, on average), and may thus deduce that the ML/DL/AI engine most probably lacks or does not apply a Rate-Limiting Pre-Processing filter or gate or mechanism, or that such Rate-Limiting module may exist but is improperly configured; and the protection platform may thus automatically recommend to add such Pre-Processing unit or module, and in some implementations may automatically add such pre-processing module or unit automatically or semi-automatically.

Similarly, the protection platform may detect that output signals that are generated by the ML/DL/AI engine suffer from anomalies or inconsistencies which may be attributed to lack or (or mis-configuration of) a post-processing unit or module, such as lack of (or mis-configuration of) a pruning routine, a rule filtering scheme, a knowledge integration scheme, a module for shrinking or pruning or truncating a decision tree or decision rules or association rules or classification rules, and/or other post-processing filters that attempt to remove or filter-out “noisy” or imprecise outputs.

Similarly, the Offline Protection Unit 122 may automatically detect that the ML/DL/AI Engine 101 utilizes a particular condition or threshold value that causes the ML/DL/AI Engine 101 to be more prone or less resilient to attacks; and may automatically increase or decrease or modify such threshold value, or may automatically modify or cancel or augment the condition, based on pre-defined list of rules for performing such modifications if a particular set of parameters or thresholds or conditions is detected. Other suitable techniques may be used.

The ML/DL/AI Protection Unit 120 may further comprise, optionally, an Attack Mitigation Unit 124, which may be a separate unit from the above-mentioned units, or may be integrated with one or more of the above-mentioned units, or may operate in conjunction with one or more of the above-mentioned units, or may be comprised within one or more of the above-mentioned units, or may comprise therein one or more of the above-mentioned units. For example, the Attack Mitigation Unit 124 may collect or receive inputs or insights from one or more of the other units 121-123, and/or may fuse together such inputs to generate additional insights, and may trigger or initiate or execute one or more mitigation operations in order to decrease or eliminate or stop or reduce or pause a particular damage or abuse or fraudulent use or adversarial use of the ML/DL/AI Engine 101. Such mitigation operations may include, for example: blocking or quarantining or discarding some (or most, or all) of the incoming traffic or queries or requests that are determined by the ML/DL/AI Protection Unit 120 to be of a malicious nature or to originate from an adversarial entity; blocking or quarantining or discarding some (or most, or all) of the outgoing traffic or results or insights or outputs that were supposed to be outgoing to an entity that is determined by the ML/DL/AI Protection Unit 120 to be to be outgoing to an entity that of a malicious nature or to originate from an adversarial entity; significantly slowing down the rate or speed of processing requests or queries of such adversarial entity, and/or the rate or speed of sending back results or outputs to such adversarial entity; modifying and/or manipulating outputs and/or query results prior to sending them to such adversarial entity, or (in some implementations) even intentionally sending out false results or incorrect results or opposite results or modified results, or random or pseudo-random results, to such adversarial entity; pruning or diluting or purging or cleaning-up a training set or a training dataset or an examples dataset, that was or that is utilized by the ML/DL/AI Engine 101, such as by removing or deleting or excluding or discarding one or more examples or data-points or data-items that are determined to be of adversarial nature, replacing or correcting or re-labeling or re-classifying one or more training examples or training data-points, optionally by utilizing a human classifier and/or by utilizing another computerized service or another ML/DL/AI Engine to re-classify or to re-label particularly only such data-points; re-performing a training session and/or re-building of the ML/DL/AI model based on the updated or pruned or purged or diluted dataset; generating a notification or warning message or alert message, indicating abuse or the ML/DL/AI Engine 101, and sending or transmitting such message to one or more pre-defined parties (e.g., an administrator entity of the ML/DL/AI Engine 101; a law enforcement agency) and/or to one or more dynamically-defined parties (e.g., to a contact address of the entity that is determined to be a malicious entity or an adversarial entity; to an Internet Service Provider (ISP) of such adversarial entity; to a domain registrar of such adversarial entity; to a server hosting facility of such adversarial entity). In some embodiments, in addition to or instead of dataset manipulations and/or re-training, other protection and mitigation methods may be applied; for example, architecture modification (e.g., replacing and/or adding and/or removing and/or quarantining elements or sub-units of the protected ML/DL/AI Engine 101; or modifying one or more operational parameters thereof); replacing a current version of the protected ML/DL/AI Engine 101 with a previous or prior version thereof (e.g., obtained from a versioning unit or repository that stores previous versions of the protected ML/DL/AI Engine 101); modifying or updating or replacing a defense policy or a protection policy that enables the user (e.g., the administrator or owner of the ML/DL/AI Engine 101) to configure and to balance the system's requirements or operational parameters or operational constraints, such as by automatically switching from operating in accordance with a first pre-defined protection policy to operating in accordance with a second, different, pre-defined protection policy (e.g., out of a pool or bank or array of pre-defined protection policies); or the like.

In some embodiments, the ML/DL/AI Protection Unit 120 may utilize a semi-automatic and/or semi-supervised process for attack detection, attack mitigation, and protection. The ML/DL/AI Protection Unit 120 operates to achieve accurate classification of inputs that are fed into the into the ML/DL/AI Engine 101, as either (I) legitimate inputs (e.g., non-adversarial; genuine; non-attack-related), or (II) non-legitimate or illegitimate inputs (e.g., adversarial inputs, attack-related inputs, compromising inputs, malicious inputs, fraudulent inputs, attacking inputs, abusing or abusive inputs).

In a demonstrative example, the ML/DL/AI Engine 101 is configured to perform image classification of vehicular license plate number (or strings) that appear in photos or images. When an input (e.g., an image with a license plate in it) is received at an entry point of the ML/DL/AI Engine 101, or immediately prior to that entry point, the ML/DL/AI Protection Unit 120 utilizes an Input Interceptor/Analyzer Unit 125 that intercepts the incoming image and applies to it an automatic attack-detection algorithm that are configured to operate in a strict manner to reduce false positive errors, such that if the output of the attack-detection algorithm is that the image is not malicious then the image is indeed not attack-related. Since the algorithm is strict, it does have some percentage of false positives (e.g., determining that a particular photo is malicious or attack-related, while in fact it is not). In order to remedy this, when an input is detected as attack-related, such input is then routed automatically to a computing terminal for manual human inspection by a human labeler or a human classifier. If the identification of the photo content by the human labeler is the same as the original identification by the ML/DL/AI Protection Unit 120, then the attack determination is considered an error and such error is ignored or discarded (and/or is stored in a side repository for additional learning and in order to enable the ML/DL/AI Protection Unit 120 to learn from such errors and to improve the system). In contrast, if the identification of the photo content by the human labeler is different from the original identification produced by the ML/DL/AI Engine 101, then this input (e.g., this photo) is considered malicious or adversarial or part of an attack against the ML/DL/AI Engine 101, and is marked or reported as such, and the true label or the correct label as set by the human labeler is utilized as the correct output.

In some embodiments, optionally, instead of using a human labeler (or human classifier), or in addition to it, the ML/DL/AI Engine 101 that is being protected against attacks (or against malicious inputs or adversarial inputs) may utilize a secondary (e.g., proprietary, or publicly available) similar ML/DL/AI Engine, or a plurality of such secondary ML/DL/AI Engines, solely for the purpose of detecting such malicious input(s). For example, Company A is developing and/or operating its own ML/DL/AI Engine 101, which is tailored to correctly classify detect objects in photos that pertain specifically to animals. Company A receives or obtains a particular photo, “Tiger.jpg”, which is pre-labeled or pre-classified as a tiger. Instead of automatically relying on such pre-label or pre-classification, the ML/DL/AI Protection Unit 120 (which protects the ML/DL/AI Engine 101) sends that particular photo to a third-party classification service and/or to a public classification service, which does not necessarily specializes in this field (animals); such as, to the “reverse image search” engine of Google or Bing (or to both of them); and such “secondary” engine indicates that the photo “Tiger.jpg” is actually classified by it as a “sofa” or “couch” (e.g., it actually depicts a sofa having a fabric that is patterned like a tiger skin). Based on the classification by such “secondary” engine, or by a majority of such secondary engines, or by at least one of such secondary engines, the ML/DL/AI Engine 101 that is being protected may determine that the photo “Tiger.jpg” should not be relied upon as a tiger animal, and/or should be discarded or deleted, or should be classified as “sofa”, or should be otherwise treated or handled as a malicious input or as adversarial input. Such inquiry towards the “secondary” ML/DL/AI Engine(s) may be performed by a Guarding Unit or a Filtering Unit of the system, or by an Adversarial Inputs Detection Unit 126, which may guard the ML/DL/AI Engine 101 against malicious inputs and may prevent such malicious input from even entering or reaching the ML/DL/AI Engine 101 itself, by using a human labeler, a Secondary ML/DL/AI Engine 131, a set of secondary ML/DL/AI Engines, and/or other methods. Some embodiments may optionally utilize a mechanism that applies a “wisdom of the crowd” technique, in which each one of a plurality of Secondary ML/DL/AI Engines (and optionally, one or more human labelers) is queried for its output or for its result with regard to a particular incoming query (that is incoming to the protected ML/DL/AI Engine 101), and the dominant result or the majority result or the most frequent result (or, a result that is an output of a weighted formula, that allocated different weights to different Secondary ML/DL/AI Engines based on their reputation or trustworthiness or size or speed or other parameters) prevails and is utilized as the “ground truth”.

In some embodiments, an Evasion/Poisoning Attack Mitigation Unit 127 may be configured to mitigate or cure an evasion attack or a poisoning attack towards the ML/DL/AI Engine 101. The unit reflects a “backup” operation plan, that is triggered upon detection of such attack(s), and particularly upon detection of an ongoing attack that cannot necessarily be immediately blocked. Evasion/Poisoning Attack Mitigation Unit 127 may have the following functionalities and/or features: (A) Manual Classification Backup Service is Set-Up in a dedicated center, ready to be operative within a short notice (e.g., 15 or 30 or 60 minutes, based on the requirements of the owner of the ML/DL/AI Engine 101 that is being protected); (B) the system detects that the ML/DL/AI Engine 101 is currently being attacked, resulting in incorrect classifications by the ML/DL/AI Engine 101 with regard to all, or at least N percent of, input queries (e.g., N being a pre-defined threshold value, such as 50 or 33 or 25 or other value), or, by utilizing a threshold value or a condition that is based on the percentage of inputs that were determined or estimated to be adversarial (e.g., inputs that belong to, or are associated with, an attack), since detecting an adversarial input may (in some implementations) be easier or more efficient or more accurate than detecting an incorrectly classified input; (C) the attack is identified or suspected, by one or more protection mechanisms, or by other system metrics, system user reports, or other sources (e.g., a detection that an abnormal or excessive number of inputs are received per minute or per hour, or that numerous inputs are incoming from a particular source or entity, or other indicators of a possible attack); (D) the attack mitigation unit is initiated or triggered, switching to manual (e.g., human) classification service that is set up rapidly with multiple human labelers that are familiar with the particular ML/DL/AI task at hand, and routing or re-routing incoming queries to the manual classification service instead of the ML/DL/AI Engine 101; then, (E) once the attack is blocked or ends, the manual mitigation service is stopped, and queries are again routed to the original and automated ML/DL/AI Engine 101.

Some embodiments may protect the ML/DL/AI engine against Semantic Attacks. While adversarial attacks often include attempts to “fool” or “trick” the ML/DL/AI model based on mathematical manipulations (e.g., carefully crafted patches or textures, or otherwise specific digital manipulation of an image), Semantic Attacks attempt to “fool” or “trick” the ML/DL/AI model by using low-tech methods, such as visual manipulations (e.g., Spoofing Attacks in which a poster is displayed, or an image is projected and tricks the model to identify non-existent objects). These attacks may impose a serious threat to vision-based or visual models, as they pose an easy-to-create yet hard to-protect physical attacks (e.g., an army of soldiers using carpets depicting a river which cause a rival autonomous system to incorrectly recognize the landscape). Other types of semantic attacks include exploiting weak spots of the model; for example, if the model does not work well when there is fog, the attacker can use smoke to avoid being recognized by the model. Another option is malicious Out of Distribution (OoD), which creates an anomalous instance that is not from the distribution the model was trained on; such as using unusual colors/unique costumes/funny hat/irregular textures and/or abnormal artifacts, that cause the model to operate incorrectly or to output incorrect results. The system may protect against Semantic Attacks via a Semantic Attacks Protection Unit 169 by performing, for example: (a) characterization of the attack surface of practical/semantic attacks against DL/ML/AI engines, and particularly against such engines for autonomous computer-vision systems or object-recognition systems; (b) generating and/or simulating and/or emulating such attacks; (c) detecting fingerprints of such attacks, and/or characteristics or features that indicate that such attack is ongoing or is attempted, in order to provide a protection layer or a solution for protecting against such attacks; (d) providing a particular protection against OoD attacks, for example, based on confidence intervals or confidence levels/scores that are attributed or achieved for each component or region in an image; (c) providing a particular protection against Spoofing attacks based on detection of particular indicators of such attacks; (f) fortification of an existing ML/DL/AI system or model, optionally with re-training based on data augmentation.

Some embodiments may use a Real-World/Physical Attacks Protection Unit 171 to protect the ML/DL/AI engine against Physical Attacks or real-world based attacks or non-digital attacks; such as, an attack that is performed by modifying real-world/non-digital data prior to its transformation into digital data that is provided as an input or a query or a prompt to the ML/DL/AI engine. For example, in a digital attack, pixels in a digital image are modified on a computer, in order to “trick” the ML/DL/AI engine (e.g., tricking the engine to classify a dog as a wolf). In contrast, a physical/real-world/non-digital attack performs one or more real-world/non-digital modifications to the environment; such attacks can be tedious and effort consuming to perform (e.g., it is almost impossible to color the entire sky in green, in the real world), yet such attacks can be difficult to detect if indeed performed. A physical attack may involve, for example, utilization of abnormal or misleading angles to capture a photograph, such as in a way that causes objects to appear disproportionally large or small; placement of an extremely-large object (or conversely, an extremely-small object) in a particular setting or among other regular-sized objects in order to confuse the model; taking advantage of unusual or rare weather conditions or real-world coincidences (e.g., abnormal color of sky at sunset or sunrise, or abnormal shape or color of the sun during a solar eclipse); utilization of real-world objects that cause an observer to experience an optical illusion; and/or other physical attacks.

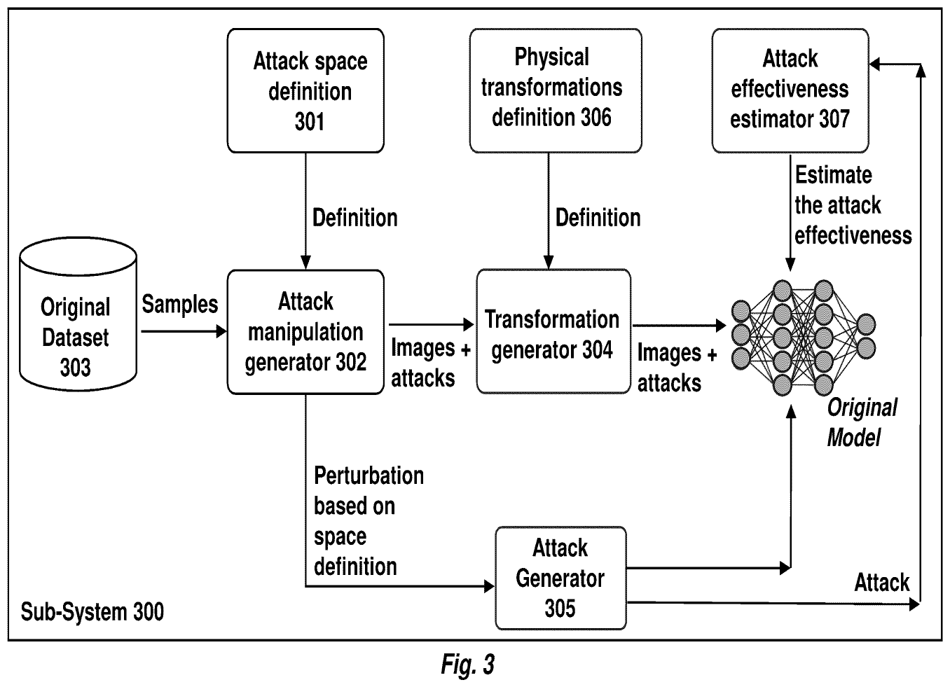

Reference is made to FIG. 3, which is a schematic block-diagram illustration of a sub-system 300 for Real-World/Physical Attacks Protection of ML/DL/AI engines, in accordance with some demonstrative embodiments; which may be a demonstrative implementation of the above-mentioned Real-World/Physical Attacks Protection Unit 171. For example, an Attack Space Definition Unit 301 provides or defines the attack space, and provides the definition of the attack space to an Attack Manipulation Generator Unit 302 that also receives samples from the original dataset 303. The Attack Manipulation Generator Unit 302 generates attack parameters, and provides attack parameters perturbations (based on the attack space definition) to an Attack Generator Unit 305. The attack parameters are also provided, with images, to a Transformation Generator 304, which further receives physical transformation definitions that were generated by a Physical Transformations Definition Unit 306. The Transformation Generator 304 provides the images and the attack parameters to the original ML/DL/AI model; and the Attack Generator 305 further provides the attack to the original ML/DL/AI model and also to an Attack Effectiveness Estimator 307 that estimates the effectiveness of the particular attack that was performed towards the original ML/DL/AI model.

Turning again to FIG. 1, the system may include a “U2-Attacker” module, or a Universal “Universal Attacker” module 172, which may create new attacks (against the ML/DL/AI engine) using an LLM-based attack generator. For example, LLM capabilities are used to achieve semantic automation scalability of adversarial attacks (and/or other features), allowing automatic customization of attacks to particular domains and/or to particular AI tasks. For example, given a specified domain by the user (e.g., an example of an AI task “Style Transfer in Images” can be, “Given an image, modify it to be in a different style such as Van Gogh”), in the first stage the possible attack goals are generated automatically by an LLM (e.g., make the style transfer to do anything, or make the style transfer always convert the image to noise, or the like), whereas in the second stage an LLM is used to automatically create a script of code (e.g., Python code) of the objective function that is suitable for a given attack objective. Following this, the generated code is inserted into the U2Attacker framework, thus creating a full attack code base that carries out the different attacks. Finally, LLMs and AI engines can be used to automatically generate testing code for the created attack and/or for code verification.

In some embodiments, the system may include an AI Brainstormer module 178, in which a set or array of inter-connected LLMs is utilized and allowed to communicate with each other. The interaction is set up such that each LLM has different goals to achieve, and communication is partial such that not all LLMs participate in all conversation segments, resulting in different histories of each LLM. Optionally, a one LLM may be configured to operate as a moderator towards the other LLMs, and/or to assign text-generation roles to particular LLMs at different time-points or conversation-points, and/or to assign listening roles to particular LLMs and/or to determine which portions of the chat history would be accessible to which LLM(s). In some embodiments, an AI Brainstormer may be configured to prompt one or some or all of the participating LLMs to focus on one or more aspects of security/reliability/accuracy/efficiency of the MuT; for example, a first LLM may be configured/prompted to generate insights or outputs about accuracy of the MuT, whereas a second LLM may be configured/prompted to generate insights or outputs about the efficiency of the MuT, whereas a third LLM may be configured/prompted to generate insights or outputs about the resilience of the MuT against a particular type of attacks, and so forth; and outputs from a particular LLM may be accessible to one or more other particular LLMs, as pre-defined in a configuration and/or as determined dynamically by the Moderator LLM.

Some embodiments may utilize semantic automation for scalability and enhancement of security of the MuT; such as, via generalization of the U2-Attacker. While the U2-attacker is an example of semantic automation of attack creation using LLMs, a generalization of this is semantic automation of all elements of the protection platform, including model and dataset handling, and all the other features including defenses, detectors, mitigation mechanisms, UI, or the like. Another example of this is the weak-spot detection feature described herein, or the automation of tabular data digestion: In general, tabular data AI tasks are domain dependent, such that the constraints on table values, and table value relations, typically depend on the specific context (for example, the value of age has strong relationship to the value of number of children; the number of children can rarely be 15 when the age is 21). This information is useful for crafting attacks, but in order to know this there is a need for semantic understanding which LLMs can provide automatically.

For example, an AI-based Hacker Module 179 may be used, as an agent-based module that autonomously develops attacks, automatically, as a hacking research team would have done, acting as an automatic AI-based hacker. It may perform: (a) collecting and analyzing information from different sources (Internet, public sources, private repository); (b) Implementing algorithmic ideas (transforming the idea to code); (c) obtaining/modifying/deploying external code; (d) automatic investigation and analysis of phenomena, or automatic root cause analysis, determining the reasons for the phenomena, as demonstrated in the weak-spots feature discussed herein; (c) Creating new ideas or new features for algorithms (as partially demonstrated in the U2 Attacker, and using other insights such as those provided by the AI Brainstormer module); (f) Developing new algorithms, as a meta-feature that can be achieved by performing multiple cycles of creating new attacks and analyzing the results as described, and/or by applying reinforcement learning or search algorithms of hyper parameters of the other protection units/protection processes. In some embodiments, these functionalities may be improved or boosted using meta algorithms; for example: (i) creating multiple AI-based hackers that are competing against each other, or even trying to attack each other, or are configured to play a simulated game of attackers against defenders; (ii) Applying RL on the system; (iii) Allowing the AI-based hacker to teach itself new capabilities; (iv) Performing evolutional optimization on the skills required by the AI-based hacker.

In some embodiments, the protection system may include a Weak Spots Analysis Unit 173, configured to uncover hidden attributes within images (or other data) that impact the model's performance (e.g., degrading the model's accuracy) that may not be detected using other methods. The weak spot analysis pinpoints new features or patterns that were not yet previously recognized, yet play a role in the model's performance. These areas where the model struggles are referred to as “weak spots”. By detecting these weak spots, the system can attain a more profound understanding of the underlying reasons for the model's shortcomings and develop approaches to enhance its performance. To carry out a weak spot analysis, the system may evaluate the model's performance in various circumstances, such as with diverse input data or under shifting environmental conditions. Additionally, examining the model's performance across different classes or categories and comparing them can help in identifying inconsistencies. This process allows to uncover systematic errors that may be adversely affecting the model's overall performance. Error analysis is employed to identify weak spots, by examining the model's incorrect predictions and analyzing emerging patterns or trends. For instance, it may be discovered that the model consistently misclassifies specific types of inputs, or is more susceptible to errors under certain environmental conditions. By detecting these patterns, targeted solutions can be generated to address them.

In a demonstrative example, the system detected image features that were identified as significant contributors to a model's reduced performance in object recognition: (a) Night clusters with numerous streetlights work worse than ones at night without streetlights; (b) the Model under Test (MuT) performs optimally during daylight hours, and when there are no obstructing vehicles in its field of view (which may prevent it from detecting certain parts of other cars); (c) the MuT exhibits poor performance in identifying jeeps and other large vehicles; (d) the MuT can recognize medium distance objects fairly well, but it is not accurate at determining their location; (c) Compared to other cars, the model is more adept at recognizing cabs/taxis; (f) The primary reason for misses is due to the distance of the objects; (g) The clusters with the poorest performance are not during nighttime, but rather when the road is very clear and the cars (if any) are very far away.

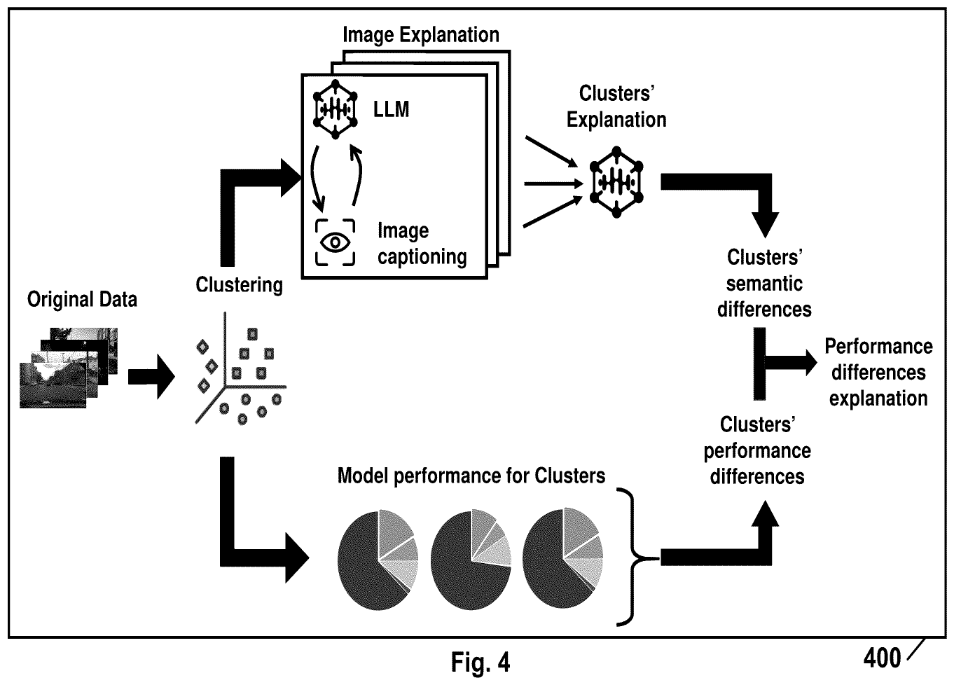

To list the hidden features that contribute to the model's overall performance, a method for extracting the underlying features from a collection of images is used. Reference is made to FIG. 4, which is a schematic diagram demonstrating a process 400 for finding weak spots of an ML/DL/AI model, in accordance with some embodiments.

The initial step of the process involves dataset clustering, which groups together similar images based on specific criteria such as visual similarity or object categories. The clustering enables separate analysis and evaluation of the model's performance on different data subsets. By identifying clusters of images with similar features, insights can be gained into the specific characteristics of those data subsets, allowing for the development of targeted strategies and operations to enhance the model's performance. Clustering is performed on the latent spaces. For example, two large clusters separate the images into night and daytime. All the images within each cluster are generally similar to each other and possess unique characteristics or at least one common characteristics. Once the clusters are separated and are ready, the next step is to analyze the performance of the MuT on each one of the clusters separately.

Error analysis includes separately evaluating the model's performance within each cluster, by detecting and analyzing the mistakes it makes. Investigating the nature of errors occurring in each cluster enables the system to understand the attributes of the specific subset. For example, the system may discover that the model persistently misclassifies images of particular animals, or repeatedly struggles with recognizing objects in images captured in low light conditions. However, in order to make these kinds of observations, the system firstly examines the performance for each cluster.

In parallel, image and cluster explanations are performed. With the clusters and their performance established, the system automatically extracts the semantic content of the images. This step involves using a combination of an image captioning model and a language model (such as an LLM, and/or a computer vision algorithm) to generate detailed textual description of each image's contents/objects/environment. By randomly sampling or other selecting images (e.g., based on particular selection rules; such as, select N images having 1080p resolution, select M images having 720 resolution, select K images having 480p resolution, or other suitable selection rules) from each cluster and processing them through this pipeline, a list of comprehensive image descriptions for each cluster can be produced. These descriptions may include object categories, color palettes, visual textures, and/or other visual features that can be described in words of a natural language by the LLM or other language model. The description is generated by utilizing an automatic conversation or chat session between the LLM and the image captioning model.

Then, by examining and analyzing all the image descriptions generated by the LLM for a specific cluster, features common to all images can be identified, providing a semantic understanding of what makes that particular cluster unique.

The following is an example of an automatic conversation between the LLM or Language Model (denoted LM) and the Image Captioner (denoted as IC). The language model aims to obtain the most detailed description possible for the image. The LM is configured to ask the IC a maximum of N questions (e.g., up to 15 or 20 questions) before providing its best textual estimate of the image's content.
LM: Question 1: What is the main subject of the image?
IC: The truck
LM: Question 2: What type of truck is it?
IC: It's a semi truck
LM: Question 3: What color is the semi truck?
IC: It's a white truck
LM: Question 4: What is the background of the image?
IC: The background of the image is a city street at night
LM: Question 5: Are there any people visible in the image?
IC: No, there are no people visible in the image
LM: Question 6: Are there any other vehicles in the image besides the semi truck?
IC: Yes, a grey van.
LM: Question 7: Are there any significant landmarks or buildings in the image?
IC: No
LM: Question 8: Is the semi truck in motion or parked?
IC: It's in motion
LM: Question 9: What is the weather like in the image?
IC: The image is taken at night, and the weather is clear and sunny.
LM: Question 10: Please clarify the weather in the image, as the previous answer was contradictory.
IC: The image is from the night, and the weather was clear and sunny.
LM: Question 11: Please provide accurate information about the weather in the image since it is a nighttime scene.
IC: The image is a nighttime scene. The weather is clear and sunny.
LM: Question 12: Is there any visible damage or abnormal features on the semi truck?
IC: No, the truck is in good condition
LM: Question 13: Are there any street signs, traffic lights, or other indicators in the image?
IC: No
LM: Question 14: Is the truck carrying any cargo or pulling a trailer? If so, please describe it.
IC: The truck is carrying.
LM: Question 15: Are there any distinctive markings, logos, or text on the semi truck? IC: No

Based on the above automatic conversation between the LM and the IC, the LM can generate the following estimation/evaluation of semantic information regarding the visual content that is depicted in the image: “The image features a white semi truck as its main subject. The truck is in motion on a city street at night with a clear and starry sky. No people are visible in the image, but there is another grey van. The semi truck has a cargo attached and is in good condition with no visible damage, logos, or markings. The background is free of any significant landmarks, street signs, or traffic lights”.

Applying same or similar conversations as above, enables to generate and gather semantic information for each image within the same cluster. Then, a subsequent step automatically finds the common features that appear in all or the majority of those images of the cluster.

The LM can thus generate a textual list of features that are shared across the images in a cluster. The following is an example showcasing the features of one of the clusters generated by the LM.
Feather 1: Cars as the primary subject: Most of the descriptions involve a car or vehicle as the central focus in the image.
Feature 2: Nighttime setting: A majority of the image descriptions mention the scene taking place at night.
Feature 3: Rainy weather: Many of the descriptions involve rain or wet streets.
Feature 4: Urban environment: A significant number of images are set in cities, specifically New York City or London.
Feature 5: No significant actions or activities: Most descriptions mention that there are no notable actions or objects held by people, or no direct engagement of the car with other elements in the scene.
Feature 6: Presence of landmarks: Several descriptions include recognizable landmarks in the background, such as the New York Public Library, the Statue of Liberty, the Brooklyn Bridge, the Empire State Building, or the clock tower in London.
Feature 7: Absence of traffic signals, signs, or distinctive markings: Many descriptions note the lack of street signs, traffic signals, or other recognizable markings on vehicles or in the environment.

Then, cluster comparison is performed. For example, after identifying the features at the cluster level, these features are employed to compare clusters that exhibit semantic similarity but differ in their performance characteristics. By detecting the disparities in features between these clusters, specific features that contribute to performance differences can be isolated. For instance, it may be found that images in one cluster generally have more intricate backgrounds or increased occlusions, which could be contributing to the model's inferior performance on that particular cluster.

The following is an example of a comparison between the features of two clusters. In this comparison, one of the features has been identified as the likely cause for the discrepancy in performance between the two clusters, and it has been added to the weak spot feature list. Upon examining the two sets of images, it has been confirmed that the noted comparisons indeed distinguish the two clusters and indeed indicate a weak spot of the model.
Feature 1: Presence of streetlights: cluster 1—Many of the images feature streetlights illuminating the scene; cluster 2—No mention of streetlights.
Feature 2: People or human presence: cluster 1—Most of the images have no people or only a few individuals present; cluster 2—No mention of people or human presence.
Feature 3: Streets/roads versus landmarks: cluster 1—Streets, roads, or related environments (like residential areas or intersections) are predominant; cluster 2—Several descriptions include recognizable landmarks (e.g., New York Public Library, the Statue of Liberty) in the background.
Feature 4: Natural elements: cluster 1—Images mostly lack trees, grass, or other vegetation; cluster 2—No mention of natural elements.
Feature 5: Mood or atmosphere: cluster 1—Images have a specific mood or atmospheric element (e.g., dark, cold, wet, or overcast); cluster 2—No mention of mood or atmosphere.
Feature 6: Rainy weather: cluster 1—No mention of rainy weather; cluster 2—Many of the descriptions involve rain or wet streets.
Feature 7: Absence of traffic signals, signs, or distinctive markings: cluster 1—No mention of the lack of such elements; cluster 2—Many descriptions note the lack of street signs, traffic signals, or other recognizable markings.

It can be observed that one or more of the discrepancies in the list above, may correspond to the first item listed in the weak spots mentioned. It is noted that the pipeline described above is fully automated and complements a biases analysis which can be performed separately to detect bias of the MuT.

This process enables the system to a nuanced understanding of the model's performance across different subsets of the data. By identifying common features within clusters, and comparing clusters that are similar in content but different in performance, the system can identify specific areas for improvement and develop targeted strategies for enhancing the model's accuracy and effectiveness. The weak spots that have been identified can be addressed by retraining the model with relevant/updated/modified weights, and/or by generating data points automatically using generative models. This can ensure that the MuT's performance in these areas meets the required standards.

In some embodiments, the protection platform (e.g., at the offline unit(s), and/or at the online unit(s), and/or at a local or on-premises implementation, and/or via a cloud-computing or remote unit implementation) may detect, and may protect against, a set of two or more Repeated Evasion Attacks, or a group of related Evasion Attacks; such that even if each one of the Evasion Attacks, by itself, is not necessarily detected, the aggregation of multiple events is detected to be a distributed or a multiple-attackers or a coordinated Repeated Evasion attack by multiple attackers or multiple malicious devices, or by a single attacker/single device that performs repeated or repeating (and, not necessarily identical to each other) Evasion Attack events from the same device or from a plurality of devices.

In some embodiments, the system or platform may optionally operate by correlating or matching input signals or inputs that derive from a plurality of distributed instances of a ML/DL/AI model; for example, particularly in a vehicular setting; and may utilize such correlation or matching for attack detection against such ML/DL/AI model or engine.

Some embodiments may include and utilize an AI-based Penetration Testing (Pen-Testing) Unit 128, which evaluates the vulnerability of the ML/DL/AI Engine 101 against different types of attacks in different settings. The AI-based Pen-Testing Unit 128 estimates the robustness level or the resilience level of the ML/DL/AI Engine 101 towards various attacks. The AI-based Pen-Testing Unit 128 collects or obtains data about historic or past attacks, and particularly of penetration attacks and penetration tests (and their corresponding results) that were carried out against this particular ML/DL/AI Engine 101, or against a plurality of ML/DL/AI Engines of the same type of the ML/DL/AI Engine 101 (e.g., historical attacks against image classification engines), or against a plurality of ML/DL/AI Engines in general; and constructs a dataset representing: (I) model features of the ML/DL/AI Engines that were pen-tested, such as, their type, size, architecture features (e.g., layer sizes and types); and (II) results of the penetration tests that were conducted against such ML/DL/AI Engine, such as, pen-test outcome (e.g., success or failure; level of success, percentage of success), accuracy of the ML/DL/AI Engines that were pen-tested, a robustness score or a resilience score or a vulnerability score against particular penetration attacks that were tested. The AI-based Penetration Testing (Pen-Testing) Unit 128 utilizes AI techniques, such as a. Deep Neural Network, to generate predictions regarding the pen-testing output that is forecasted or estimated or predicted with regard to the particular ML/DL/AI Engine 101 that is being evaluated or protected, without actually performing the time-consuming and effort-consuming pen-testing process. In some embodiments, an automated pen-testing unit or module may be used to perform a Genetic Algorithm (GA) to manipulate an LLMs, particularly when model architecture and parameters are inaccessible; for example, by optimizing a universal adversarial prompt that-by itself, and/or when combined with a user's actual/legitimate query-disrupts the attacked model's alignment, resulting in unintended and/or unauthorized and/or potentially harmful outputs; allowing to systematically reveal a model's limitations and vulnerabilities by uncovering instances where its responses deviate from expected behavior, and providing protection against an automated or semi-automated universal black box jailbreak attack.

System 100 may further comprise a Policy Design Tool and a Smart Fortification Process for protecting the ML/DL/AI Engine 101. The Applicant has realized that fortification of the ML/DL/AI Engine 101 may be a complex multi-objective constrained optimization problem. The optimization includes, for example, finding or detecting the best subset of defenses that are relevant and available, and choosing or setting or determining the best or most efficient defense parameter values. The optimization is multi-objective, since the defense would optimize robustness against different attacks in different scenarios along with the natural model accuracy. The optimization is constrained since there are limitations on the output model's prediction running time and computational requirements, along with the fortification process duration and memory required for the fortification. Other requirements from the output model may be that the new model will not alter some attributes of the input model, or that the fortification process will only use “black box” access to the original model.

In accordance with some embodiments, a Defense Policy Design Tool, or a Defense Policy Constructor Unit 140, may comprise a Pre-Fortification Unit 141 or a pre-fortification interface, which enables the owner or operator of the ML/DL/AI Engine 101 to configure and define its requirements from (or operational constraints of) the output model and from the fortification process; such as, prediction running time, prediction computational cost, total memory allocated for output model, fortification process access type to original model (e.g., “black box” or “white box” or other), fortification process duration, fortification process price/computational costs/resources costs, type of modification to original model that is allowed (e.g. allow or disallow re-training; only allow to add pre-processing, do not change original model but add an attack detection layer). Optionally, a Smart Fortification Unit 143 performs an algorithm for finding Pareto optimal solutions of the constrained optimization problem. In some embodiments, optionally, the evaluation of each model proposal may include performing of at least one penetration test attempt. The selection process may use one or more of the following techniques or considerations: Using multi-objective optimization algorithms; Using limited Budget search algorithms for bounded time fortification process; Using AI-Based Pen-Testing for fast Pen-Testing Approximation; Using Covering Algorithms for finding optimal subset of defenses that covers all relevant attacks; Grid Search algorithms; using Evolutionary/Genetic algorithms. Optionally, a Post-Fortification Unit 142 or a post-fortification interface may allow browsing and inspecting the different fortification results, for choosing the best particular fortification solution to suit the requirements and constraints, optionally including an efficient mechanism to explore pareto-optimal options.

Optionally, an AI-based Model Fortification Unit 144 may perform AI-Based Prediction of the most suitable or efficient fortification policy, or may determine the efficient or suitable subset of available and relevant defenses and their corresponding efficient defense parameter values. For example, the AI-based Model Fortification Unit 144 may collect historical data or past data about Models, customer requirements and constraints, and their corresponding fortification results. Then, the AI-based Model Fortification Unit 144 constructs a dataset of: (I) model features, such as, type, size, architecture features (e.g., layer sizes and types); and (II) the requirements or constraints as defined by the owner or operator of the particular ML/DL/AI Engine 101 that is being evaluated or protected; and (III) results of fortification methods and their corresponding fortification parameter values. A suitable AI technique, such as Deep Neural Network or Random Forest, may be used to predict or to determine the suitable or efficient subset of fortification techniques, and their respective parameters, that are predicted or determined to provide the best or most efficient fortification to the particular ML/DL/AI Engine 101 that is being evaluated or protected, while maintaining the defined constraints and while achieving the defined requirements, and without actually performing the time-consuming and computational resources consuming fortification process over many iterations on the particular ML/DL/AI Engine 101 that is being evaluated or protected.

Some embodiments may include a Region of Interest (Rol) based Protection Unit 150, for providing protection and/or fortification to the particular ML/DL/AI Engine 101 that is being evaluated or protected. For example, some conventional (e.g., non-AI-based) algorithms for image processing tasks may be more robust to adversarial attacks, while on the other hand may also be less accurate. For example, the task of detecting what is the Region of Interest (Rol) in a given image is a task that was investigated and has various non-AI algorithms that address it. Some embodiments may include defense techniques that combine both classical algorithms (e.g., Rol detection algorithms) with an AI-based protection unit, to achieve both robustness and accuracy in protecting the ML/DL/AI Engine 101.

Accordingly, a Gradient/Rol Adversarial Input Detector Unit 151 may be used. When classifying an image using a ML model, and in particular using Deep Neural Network (DNN), the system may derive the gradient of the model at the input; for example, the gradient is a matrix with the same shape as the input image. The values in the gradient are (or indicate, or correspond to) the level of importance of the pixels in the classification process of the specific input image. For example, if a DNN correctly classifies a cat image, then the gradient would show that the important pixels in the classification process were those of the nose, cars, and eyes of the cat.

Therefore, an input image may be determined to be an adversarial image, by: (a) Calculating the input image's gradient according the ML model; (b) generating the region of interest (ROI) of the image using a classical algorithm or a deterministic algorithm or a non-ML algorithm; (c) comparing the gradient and the ROI; if they are consistent with each other or match each other, then approving the image as a legitimate input image or as non-adversarial input image; if they are inconsistent or contradicting to each other or non-matching, then reject or flag the input image as adversarial input image. The comparison or the matching process may be performed, for example, using a trained ML algorithm that is dedicated for this specific comparison task; and/or by using a deterministic algorithm that verifies that a pre-defined threshold value (e.g., at least 70 percent, or at least N percent) of the important pixels is indeed inside the ROI.

In some embodiments, a ROI Pre-Processing Unit 152 may be used to perform pre-processing operations for a given input image for the above task; for example, by: (a) detect or determining the ROI; and (b) replacing all pixels in that input image, that are located outside of (or externally to) the ROI, with one of the following: (i) a constant value (e.g., zero); (ii) values corresponding to smoothing or strong smoothing of the original image pixels; (iii) random or pseudo-random values; (iv) a combination of the above values.

Some embodiments may comprise an Adaptive Fortification Unit 155, or a Hybrid Online and Offline Protection Unit 156, which may operate to further protect the ML/DL/AI Engine 101 against attacks or adversarial inputs or attacks or malicious inputs. The model fortification is a multi-objective constrained optimization task. The task includes finding a model that is concurrently optimal in accuracy and parameters and also in its robustness to different threats, while being constrained by user requirements of prediction running time, prediction CPU usage and memory usage, or other constraints. In addition to solving the optimization problem in a static setting, solving the optimization problem in a dynamic setting may be beneficial. For example, CPU/processing costs, memory utilization costs, database utilization costs, and/or other costs of resources utilization, may change dynamically over time; and similarly, the query load on the ML/DL/AI Engine 101 may change over time; and the probability of the different threats may change over time (e.g., on a particular day, it may be known that ML/DL/AI Engines in a region or worldwide are being attacked by a particular adversary, or due to a particular vulnerability or malware that is currently spreading and operational). The system may thus utilize an algorithm that dynamically adjusts or modifies or re-configures the model itself, namely the ML/DL/AI Engine 101 itself and its internal model, in a dynamic or online manner (e.g., once per day; twice per week; or even once per hour, or at other time intervals) according to the changing requirements and changing values of the above-mentioned parameters. For example, the fortification process of the ML/DL/AI Engine 101 may be scheduled to be executed every H hours, or every D days; and/or an AI-based algorithm and online optimization algorithm may be utilized to provide additional response to a dynamic environment of changing threats and/or changing parameter values.

Some embodiments may utilize an Online Defense and Protection Unit 157, which may perform ML/DL/AI Engine 101 protection operations in real-time or near-real time. Such service may be web-based, or may include a locally-installed software component and/or hardware component, optionally, supporting an Application Programming Interface (API) for improved configuration and utilization. Such operations may include, for example: (A) Online input preprocessing, in which the protected ML/DL/AI Engine 101 firstly sends an input item (e.g., an input image) to the Online Defense and Protection Unit 157, and then receives back from it a “sanitized” input or a “corrected” input (e.g., by applying one or more modifications to the input that may cancel or alleviate or reduce the negative effects of the adversarial manipulations that were done to it), or an approved input (e.g., the input image is returned, with an indication that it is legitimate or non-adversarial or non-malicious), or receives back an indication that the input item is malicious or adversarial and should be discarded or should not be processed by the protected ML/DL/AI Engine 101; and the input that is received from the Online Defense and Protection Unit 157 is then passed to the protected ML/DL/AI Engine 101 for further processing (if approved). In a demonstrative example, a protected ML/DL/AI Engine operates to classify images of humans as either male or female; and the Online Defense and Protection Unit 157 adds a pre-processing filter or analysis or check, whether the input image is (at all) human or non-human (e.g., dog, chair), to thus protect the protected ML/DL/AI engine from such input signals that are possibly attack-related and/or that may cause the ML/DL/AI engine to fail or to output incorrect results. (B) Online adversarial input identification; the protected ML/DL/AI Engine 101 sends the input item (e.g., input image) to the Online Defense and Protection Unit 157, and receives back a classification indicating whether the input item is adversarial or non-adversarial; (C) Online attack pattern detection, in which the protected ML/DL/AI Engine 101 (or a monitoring component associated therewith) sends all or substantially all or most of some of the inputs that are received at the protected ML/DL/AI Engine 101, to the Online Defense and Protection Unit 157, which in turn analyzes the series of inputs and identifies an attack pattern (e.g., identifying a series of Cat images that are pre-labeled as Dogs); and when an attack pattern is detected (e.g., by detecting an attack pattern which is a series of inputs (or images) that are very similar to each other yet they differ only in several bits or bytes (or pixels); or a series of images that seem to be a result of a search/optimization process), the Online Defense and Protection Unit 157 may notify the owner or operator of the protected ML/DL/AI Engine 101 that such attack was detected, and/or may generate a trigger to block or quarantine or discard or to avoid processing of certain queries or inputs from a particular source or that have a common characteristic. (D) Online Monitoring of attacks, and generating relevant model(s) or graphs or charts representing detected attacks and ML security related Key Performance Indicators (KPIs). (E) Online time delays, in which the protected ML/DL/AI Engine 101 firstly sends to the Online Defense and Protection Unit 157 an input item along with an identifier of the input's source; and the Online Defense and Protection Unit 157 injects or intentionally adds a time-delay (e.g., of T seconds or T minutes; wherein T is a pre-defined number; or wherein T is selected randomly or pseudo-randomly within a pre-defined range of values) before returning the input to the protected ML/DL/AI Engine 101 for processing; or wherein T is selected based on Pen-Testing of ML/DL/AI Engine 101, or based on outputs generated by the Smart Fortification Unit 143; the time delay may be dependent on the input source and/or on the input item itself; the time delay may block or weaken or slow-down or de-incentivize certain attacks, such as a Stealing Attack, that require numerous queries to the protected ML/DL/AI Engine 101. (F) Query Quota or Rate Limiting, in which the protected ML/DL/AI Engine 101 firstly sends to the Online Defense and Protection Unit 157 the input item along with an identifier of the input's source, and the Online Defense and Protection Unit 157 determines whether or not to block that particular source according to a query quota that is associated with that particular source; the quota may be pre-defined, or may be dynamically allocated and/or configured, based on one or more parameters or conditions, such as, taking into account a level of similarity among multiple inputs/multiple queries that have arrive within the past T minutes from the same source, and/or other parameters (e.g., outputs or values generated by the Smart Fortification Unit 143). (G) a Blacklisting process, in which the protected ML/DL/AI Engine 101 firstly sends to the Online Defense and Protection Unit 157 an input along with an identifier of the input's source; and the Online Defense and Protection Unit 157 then decides whether or not to block that source according to a blacklist of sources and/or a blacklist of particular inputs or queries.

In some embodiments, the Online Defense and Protection Unit 157 may thus allow protection that does not require modification of the original ML Model; may allow efficient integration and utilization of complex protection techniques, with minimal or no changes to the protected ML/DL/AI Engine 101 itself; may allow a behavioral defense method which detects an attack pattern across (or from) a series of inputs or a series of queries; may allow applying and using confidential defense methods that are provided by a remote server of the Online Defense and Protection Unit 157 as a “black box” solution that provides to the protected ML/DL/AI Engine 101 an output (e.g., “input is legitimate” or “input is adversarial”) without exposing the method(s) that such remote “black box” unit employs to reach such determination; and may allow separation between the ML/DL/AI Engine 101 (and its original model) and the unit that provides the protection layer to it. In some embodiments, the online defense that is provided by the system may allow each of both parties to keep their confidential information secret: the protected ML/DL/AI Engine 101 itself and its internal methods of operations may be kept undisclosed while being protected against attacks, and/or the protection service (which protects the ML/DL/AI Engine 101) may be provided as a web-based or remote or locally-installed or co-located or cloud-based “black box” protection service which does not disclose or reveal its internal methods of operation.

Some embodiments may further utilize an Online AI-Based Defense Unit 158, which may utilize one or more (e.g., remote, cloud-based) AI/ML/DL engines (e.g., using DNN, Random Forest, Evolutionary/Genetic algorithms, or other techniques) to select which protection scheme or protection operations to apply (or not to apply) to the protected ML/DL/AI Engine 101 and/or with regard to a particular input (or set of inputs) that is incoming to the protected ML/DL/AI Engine 101; as well as which pre-processing operations or pre-classification operations to apply or to perform on such input(s), which re-trained model(s) to apply, which detection algorithms to apply, and/or other operations which may be selectively determined as applicable or suitable, or which may be selected from a pool of pre-defined attack mitigation operations based on such AI/ML/DL output of the Online AI-Based Defense Unit 158. In some embodiments, the Online AI-Based Defense Unit 158 functionality may assist in achieving the dynamic fortification that allows the system to address dynamic requirements. For example, a database or a dataset may be created, with characteristics of various types of ML/DL/AI engines, with characteristics of their particular dataset and model, with characteristics of known attacks that were detected towards them, with the mitigation/protection operations that are relevant for each type of engine and dataset and attack, and for the results (success/failure; or a success score as a percentage value) for a particular mitigation/protection operation with result to a particular attack towards a particular engine or dataset or engine-and-dataset combination. Such data may be subject to ML/DL/AI analysis or classification, in order to estimate or predict or deduce which attack vectors may be relevant towards a particular (e.g., new) protected ML/DL/AI engine, and/or which mitigation or protection techniques may be useful or effective towards such attack(s) against such protected ML/DL/AI engine. In some embodiments, a Dataset Integrity Analysis Unit may operate as part of the system or platform, to estimate and/or to quantify the level of integrity of the dataset that is currently utilized by the ML/DL/AI engine and/or by its model and/or that was used to train such engine and/or that was used to construct such model; and one or more mitigation operations or re-training operations or adversarial training operations, or dataset pruning or replacing or augmenting operations, may be invoked by the system in response to a Dataset Integrity score that is below a pre-defined threshold value.

The Online AI-Based Defense Unit 158 may be responsible for selecting an appropriate (or, the most appropriate) online defense per each particular input that is incoming towards (or into, or that is about to enter) the protected ML/DL/AI Engine 101. The Online AI-Based Defense Unit 158 may be implemented (or may operate) based on dynamic fortification history and/or based on outputs of the Smart Fortification Unit 143, and/or based on outputs of the AI-based Model Fortification Unit 144 that combines ever-improving model(s) based on experience or insights from the fortification history.

The system may further include an Online Defenses Monitoring Unit 159, which generates an on-screen display or notifications or a dashboard that enables a user (e.g., an owner or operator of the protected ML/DL/AI Engine 101) to monitor the attacks that were attempted or are ongoing towards his ML/DL/AI Engine 101, as well as the protection mechanisms that are or were applied and their results. The Online Defenses Monitoring Unit 159 may enable the user, for example: to obtain a graph or chart or list or other representation of the history of attacks that were detected and/or blocked and/or evaded, and the success rate of such attacks and/or of the mitigation operations that were applied; to manually label particular usage statistics, and/or to configure particular parameters and constraints that are utilized by the system; to obtain data about CPU/Memory usage and running time usage per each online defense mechanism; to obtain defense effectiveness statistics and defense success data, such as, the percentage of inputs that were identified as adversarial (out of all inputs), and the percentage of adversarial inputs that were successfully blocked in time or that were subject to pre-processing operations or quarantine or discarded; information or generated insights about pen-testing history of the protected ML/DL/AI Engine 101 (e.g., particularly when a protection attribute or a protection-related characteristic is changed dynamically); and/or other relevant parameters.

The system may further comprise an Attack Investigation Console Unit 160, which enables an attacks investigator and/or the operator of the ML/DL/AI Engine 101 to perform investigation operations regarding one or more attacks that were performed against the ML/DL/AI Engine 101, thereby providing or generating additional important information or insights regarding the required or suitable reactions or mitigation operations. The Attack Investigation Console Unit 160 may generate and provide, for example: data about distribution of the adversarial label, for example, for evasion attacks in which the attacker attempts to trick the model into classifying some input incorrectly, indicating the distribution of the classification that the attacker tried to achieve (e.g., indicating that the attacker has attempted to attack classification of Animal images, and not of Vehicle images); data about distribution of the type of attack (e.g., model stealing, dataset information stealing, poisoning exploitation, evasion, or other attacks); data indicating whether the attack was a “black box” attack or a “white box” attack, wherein detection of a “white box” attack may lead the system to generate a warning that the Model itself is estimated to have been stolen; data indicating whether the attack is a known attack (e.g., an attack that utilizes one or more open-source tools or previously-seen attack tools), or is an unknown attack (e.g., an attack that utilizes a never-before-seen attack tool or attack vector or attack surface or attack technique), which in turn may also generate an indication regarding the level of threat or risk associated with the attack; and/or other insights. The Attack Investigation Console Unit 160 may further enable to efficiently send or route or re-route suspicious inputs to manual re-labeling or re-classification, to generate insights about the true or the full extent or scope of the attack, to initiate sandboxing operations or quarantine operations with regard to particular components and/or data-portions and/or dataset(s) and/or engine(s), to enable visualizing and/or initiation of sandboxing of one or more features or functionalities, to generate a visual or an on-screen representation of two or more protection techniques or fortification techniques that operate together or in parallel or in series, to generate a visual or an on-screen representation of pen-testing results, to generate a dashboard representing or showing currently deployed and/or currently available and/or currently unavailable protection techniques and/or fortification techniques, to generate visual or on-screen representations that depict fortification or protection of particular ML/DL/AI unit(s) within a compound ML/DL/AI system or engine, and/or to perform or to trigger other mitigation operations (e.g., enabling the investigator to manually quarantine a set of inputs, or inputs that are received from a particular source, or inputs that share a particular characteristic).

The Applicant has realized that in some situations, an owner or operator of the ML/DL/AI Engine 101 may wish to determine the robustness of his ML/DL/AI Engine 101, without sharing information about the ML/DL/AI Engine 101 or its internal model(s) or component(s) or logic. However, realized the Applicants, some types of attacks may be a “white box” type of attack, in which partial knowledge or full knowledge of the attacked ML/DL/AI Engine 101 is already in the hands of the attacker. The Applicant has realized that in some situations, a “white box” attack may require from the attacker to know only the result of a specific computation (for example: the gradient of the model for a certain input) in order to carry out the attack. Accordingly, an Undisclosed Model Pen-Testing Unit 162 may perform pen-testing of a “white box” attack against the ML/DL/AI Engine 101, while maintaining confidentiality of the model or components of the protected ML/DL/AI Engine 101. For example, a server or a computer that hosts the ML/DL/AI Engine 101, or that is operably associated with the ML/DL/AI Engine 101, may be configured by installing thereon a testing module (e.g., optionally implemented as an open source module, or as a module having source code that can be inspected by the owner of the ML/DL/AI Engine 101 or by a trusted auditor), and the installed testing module only performs the required computation for the “white box” attack (e.g., calculates the gradient of the model for a certain input). The system performs a pen-test which carries out the “white box” attack by sending a request to the testing module to perform the computation and then send its result(s) back to the Undisclosed Model Pen-Testing Unit 162 (e.g., implemented as a remote pen-testing server) for further evaluation or analysis there.

Additionally, the system may provide protection from attacks even if there is no information about the ML/DL/AI Engine 101 or its model; for example, by selectively activating only remote or cloud-based non-intrusive protection unit(s), such as units that detect malicious or suspicious inputs or queries regardless of the manner in which the ML/DL/AI Engine 101 operates. Optionally, the system may perform a search on the defense options that are available, and for each option may evaluate the robustness of the protected ML/DL/AI Engine 101 using the Undisclosed Model Pen-Testing Unit 162, or using techniques that test for robustness against conventional “black box” attacks, or using other techniques.

Some embodiments may utilize one or more Pen Testing units or modules, such as one or more of units 121 or 128 or 162 described above, for evaluating the robustness of the ML/DL/AI Engine 101. The evaluation may be performed using empirical methods or deterministic methods; for example, performing a particular attack against the ML/DL/AI Engine 101, and analyzing the results of the attack; and/or by using other methods, for example, mathematical analysis or computational analysis of the structure of the ML/DL/AI Engine 101 if such structure is partially known or is fully known to the pen-testing unit. The Pen-Testing unit may be a modular tool which may be efficiently updated to enable testing of new attacks and new theoretical or computational evaluation methods.

Some embodiments may optionally utilize or provide Intrusive Defenses to the ML/DL/AI Engine 101; for example, using Secure Pre-Trained Models, Adversarial Training, Architecture Modification, Ensembles Training, Model Re-Training, Dataset Pre-processing, Dataset Augmentation, Dataset Sanitation or Sanitization, and/or other techniques.

For example, and Adversarial Training Unit 163 may operate to increase the robustness of the protected ML/DL/AI Engine 101, by applying an adversarial training defense against one or more known attacks; optionally utilizing a component or module that is installed locally on or at the server the runs the ML/DL/AI Engine 101, or as a component that is operably associated therewith. Optionally, pre-processing based adversarial training and/or post-processing based adversarial training may be used, including adversarial training with regard to ML/DL/AI Engine 101 that is considered an undisclosed model. Optionally, some embodiments may use adversarial training of a pre-processing element added to the ML/DL/AI Engine 101, and/or adversarial training of a post-processing element added to the ML/DL/AI Engine 101, including adversarial training with regard to ML/DL/AI Engine 101 that is considered an undisclosed model.

In some embodiments, adversarial training may be applied in other ways; for example, a Neural Architecture Search (NAS) technique may be used, such that the neural architecture or model that is utilized by the protected ML/DL/AI Engine, or one or more characteristic or properties of the neural architecture or model, is or are part of a hyper-parameter search space; and a NAS unit predicts or estimates the optimal architecture or model for a given task; and optionally, the preferred or the optimal model or architecture is then trained with an adversarial training protocol to achieve hardening or robustness against adversarial attacks.

Optionally, one or more Non-Intrusive Defense Unit(s) 164 may be used by the system; for example, performing pre-processing and/or post-processing, evasive input classification, evasion classification defenses, and/or other non-intrusive defenses that do not require partial or full re-training of the original model. The incorporation of such defenses may be done in a modular way, so that new defenses that are developed may be efficiently added to the system.

In some embodiments, a Poisoning Detection and Repair Unit 165 may operate to detect and repair models and/or datasets that were subject to a poisoning attack. This unit may operate under one or more user-defined constraints; for example, a constraint that re-training is now authorized, or an undisclosed dataset, or an undisclosed model. The unit may be constructed in a modular way to efficiently add or utilize new detection methods and/or new repair methods.

Some embodiments may provide Real-Time Defense as a Real-Time Service to the ML/DL/AI Engine 101 which runs on its regular (e.g., “production”) server and environment. Such defense may include, for example, real-time pre-processing, real-time post-processing, real-time adversarial input classifier, real-time pre-processing of ensembles, real-time backdoor poisoning mitigation, real-time backdoor poisoning exploitation detection, and/or other services that may be dynamically provided as a cloud-computing based service or as a remote service.

Some embodiments may utilize a Real-Time Model Access Restriction Unit 166, to enable protection of the ML/DL/AI Engine 101 which runs in “production”, by selectively restricting or limiting access to the ML/DL/AI Engine 101; for example, by introducing or injecting or intentionally adding response time delays and/or user query quota and/or rate limiting, which may be effective against some “black box” evasion attacks, “black box” re-programming attacks, stealing attacks, and/or other attacks. The unit may also assist in blocking various attacks by using and enforcing a user-defined or user-configurable blacklist. Optionally, restrictions parameters may be dynamically selected and enforced based on pen-testing of the model or the ML/DL/AI Engine 101.

The system may thus provide real-time attack detection, attack blocking, attack mitigation, and attack monitoring. For example, the system monitors and inspects inputs that are incoming to the ML/DL/AI Engine 101 and/or outputs generated by the ML/DL/AI Engine 101, while the ML/DL/AI Engine 101 runs and operates (“in production”), and analyzes such inputs and outputs to detect an attack and to mitigate it. Once an attack is detected and identified, the system triggers real-time or near-real-time query blocking, real-time or near-real-time user blocking, sends relevant attack information to a monitoring system, and generates and sends a notification to an administrator or to one or more recipients; as well as performing other mitigation operations (e.g., rate limiting; query quota configuration and enforcement; time delay injections; quarantine or discarding of inputs or of queries; sanitizing of inputs or queries; intentional modification or randomization of outputs (e.g., to counter-attack or to confuse an attacker); taking one or more components of the ML/DL/AI Engine 101 offline; or other mitigation operations).

Some embodiments may utilize a Protection Policy Configuration Unit 167 or similar design and configuration tool, which enables a user to configure, modify and optimize multiple dependent and independent parameters, such as model accuracy on natural inputs, model accuracy under each type of attack, computational resources for model prediction, and/or other parameters or constraints, in order to increase robustness of the ML/DL/AI Engine 101 against attacks or threats. The Protection Policy Configuration Unit 167 enables the user to explicitly consider, select, approve and/or disapprove various parameter trade-offs, and to choose or define or configure a protection scheme that best fits the user's requirements, goals, and constraints.

It is clarified that the ML/DL/AI Engine 101, which is protected by some embodiments, need not necessarily be a single unit or a stand-alone unit or a single-component unit; rather, some embodiments may similarly protect a chain or set or group or batch or “computing farm” other collection of two or more (or numerous) ML/DL/AI Engines or units, that may be operably associated with each other, or which may operate in parallel and/or in series and/or concurrently and/or simultaneously and/or sequentially, or a multiple-component ML/DL/AI Engine or sub-system, or a multiple-model ML/DL/AI Engine or sub-system, or an ML/DL/AI Engine which includes a combination or a composition of multiple units or components. It is emphasized that in accordance with some embodiments, the protection system may serve and protect, simultaneously or concurrently or in parallel, multiple different customers or multiple different independent ML/DL/AI Engines, which may be entirely independent of each other, and/or which may be remote from each other, and/or which may be owned or operated by different entities, and/or which may be of different types.

For demonstrative purposes, some portions of the discussion may relate to a protected ML/DL/AI Engine which receives as input an image or a photo or a graphical data-item; however, these are only non-limiting examples, and some embodiments may similarly protect other types of ML/DL/AI Engines and/or may protect ML/DL/AI Engines that receive (or that process, or that operate on) other types of data, for example, textual data, numeric data, alpha-numeric data, tabular data or tabulated data, array or matrix or table of data-items or values, data arranged or formatted as fields or records, non-graphical data, graphical data, video data, audio data, audio-and-video data, raw data, processed data, partially-processed data, user-provided data, machine-generated data, data collected or received from sensors or sensing units (e.g., accelerometer data, gyroscope data, temperature data, spatial orientation data), biometric data (e.g., fingerprint scan, retina scan, eye scan, face scan or facial image), financial data, finance-related data, data that is intended for OCR, data obtained from (or provided as) a text file or a spreadsheet file or an XML file or a CSV file or a database file, inputs that are a combination of two or more types of data, inputs that are provided as a combination of two or more data formats, data items that are accompanied by meta-data (e.g., indicating how or where or when the data was collected or obtained), and/or other types of data.

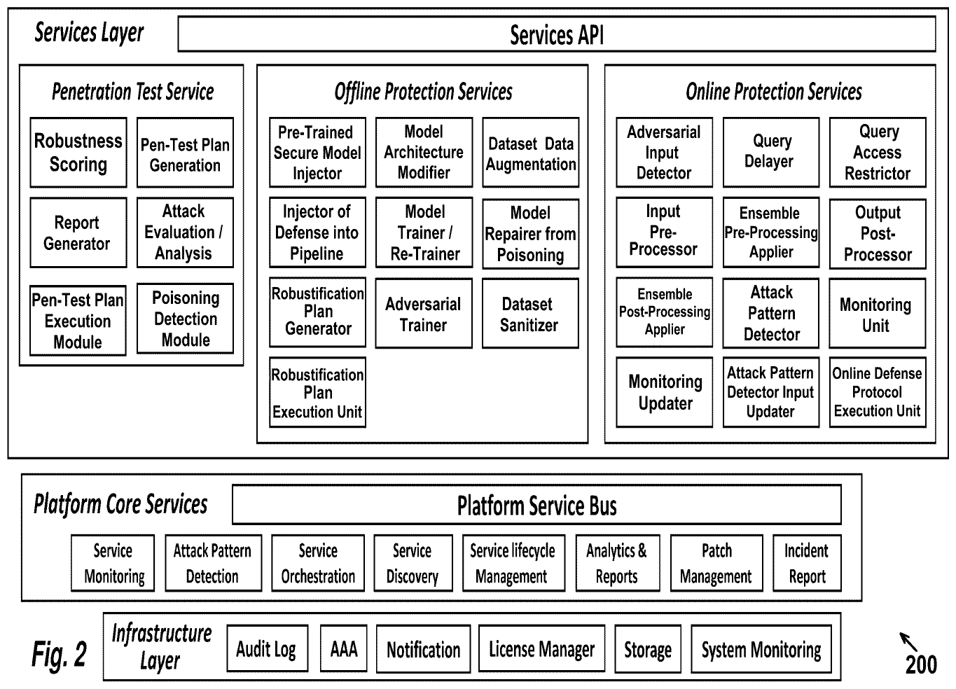

Reference is made to FIG. 2, which is a schematic block-diagram illustration of a system 200, in accordance with some demonstrative embodiments. Optionally, system 200 may be a demonstrative architecture implementation of system 100 of FIG. 1. System 200 utilizes a modular architecture which allows scalability, and may be implemented as a cloud service or as a cloud-computing service, for a single user or for multiple users; or it may be implemented and installed locally (e.g., as licensed software or module that is co-located with the protected ML/DL/AI Engine). The architecture and components of system 200 may support several features of the protection scheme: (a) Penetration testing, via evaluation of the robustness of the protected ML/DL/AI Engine against various threats or attacks; (b) Offline Protection, by modifying or reconfiguring the protected ML/DL/AI Engine to become more secure or more resilient against attacks; (c) Online Protection, by providing defensive services for the protected ML/DL/AI Engine in real-time or near-real-time; (d) Attack mitigation services; (c) Protection Sandbox Environment that enables manual/customized experimentation by the user in order to investigate or test or research particular vulnerabilities and protection schemes.

In some embodiments, a Hybrid approach may be used, such as by using Hybrid Adversarial Training; such that, for example, one or more tasks or operations of the protection service are performed at a cloud-based platform or at a remote server that is located remotely from (and is separate from) the protected ML/DL/AI Engine, and one or more other tasks or operations of the protection service are performed on the client side or at the protected ML/DL/AI Engine; for example, the cloud-based platform generates adversarial samples and provides them to the protected ML/DL/AI Engine, and the protected ML/DL/AI Engine performs the training based on the dataset that now includes those adversarial samples. Other hybrid or distributed implementations may be used.

Some embodiments may optionally utilize a cascade of multiple detectors or protection units, or a Detectors Cascade sub-system; for example, by implementing a set or series or line or group of detectors, and by applying only one or only some (and not all) of those detectors with regard to any input signal (e.g., that is directed to the protected ML/DL/AI Engine); and such that output(s) generated by the detector(s) that were already activated, dictate whether (i) a decision has been adequately reached with regard to a particular input signal, or (ii) one or more additional detectors should be invoked for that particular input signal and then their output is analyzed similarly (e.g., whether a decision can be reached, or whether additional detector/s should be invoked). In some embodiments, a faster detector or a less resource-demanding detector, is placed before slower detectors or more resource-demanding detectors, in the Detectors Cascade, in order to allow the system to firstly attempt to reach a decision based on faster and less resource-demanding detection or decision processes, before invoking slower or more resource-demanding detection or decision processes.

In some embodiments, the protection platform or the protection system may include or may provide a “sandbox” experimentation tool or feature, which enables the user (e.g., the owner or administrator of the protected ML/DL/AI Engine) to experiment and explore and evaluate different protection methods or different protection schemes or different protection configurations, and/or different vulnerabilities or attacks, in a controlled or “sand-boxed” environment which does not cause actual damage to the protected ML/DL/AI Engine. For example, the protected ML/DL/AI Engine may be duplicated into a temporary copy, such that it can be tested or experimented upon in a temporary manner and without affecting the “real” protected ML/DL/AI Engine which remains untouched.

In some embodiments, one or more features or functionalities of the platform may be accessible and/or programmable via an Application Programming Interface (API) and/or via a Software Development Kit (SDK) or a “dev-kit”, which may enable the user (e.g., the owner or administrator of a protected ML/DL/AI Engine) to interact with the platform and/or to create scripts and/or code portions that automate one or more interactions with the platform and/or that automatically provide commands to the protection platform and/or that automatically apply one or more pre-programmed rules to output (or to alerts) generated by the protection platform.

In some embodiments, a “cloud-based” implementation of the protection platform, or of some (and not necessarily all) of its functionalities, may be implemented using a remote cloud-based computer and/or by utilizing “on-prem” or “on-premise” deployment in which some (or all) of the functionalities are deployed locally at the premises of the user (the owner or administrator of the protected ML/DL/AI Engine, at private infrastructure of such user and/or at a private cloud-based deployment or via other suitable type(s) of Software as a Service (SaaS) deployment.

In some embodiments, a plurality of Protection Policies (or Defense Policies) may be pre-defined in the system, and/or may be configured or defined or modified from time to time by the user (e.g., the owner or the administrator of a protected ML/DL/AI Engine); and one or more rules may further be defined to enable the protection system to automatically switch from a first Protection Policy to a second, different, Protection Policy, if one or more pre-defined conditions hold true, and/or if a triggering event occurs or is detected, and/or if the value of one or more particular parameters is beyond a pre-defined threshold value, and/or based on other types of conditions or triggers. For example, a Protection Policy or a Defense Policy may reflect several considerations or goals or constraints that may be configured by the user (e.g., the owner or the administrator of a protected ML/DL/AI Engine); for example, (i) the target accuracy or the target validity or the target correctness of the output generated by the protected ML/DL/AI Engine, (ii) the target level of protection that is desired or intended to be achieved, (iii) resource related constraints (e.g., processing cycles, processing time, time-to-decision, memory resources, storage resources), (iv) constraints or goals that may be related to other business-related or technology-related features (e.g., ability to audit or explain performance-related decisions of operations), (v) cost or budget constraints. Accordingly, the user (e.g., the owner or the administrator of a protected ML/DL/AI Engine) may modularly define a Defense Strategy or a Protection Strategy, reflected in such Protection Policy or Defense Policy, that takes into account and that reflects said goals and/or other goals or constraints. The protection platform may then advise the user which Protection Suite(s), or which particular features or functionalities of the protection platform, may be suitable or may be available to achieve such goals and/or to comply with such constraints; and in some embodiments, the protection platform may even select automatically and autonomously to switch from a first set of protection operations (e.g., a first Protection Suite) to a second, different, set of protection operations (e.g., a second Protection Suite), and/or to modify values of one or more parameters or constraints.

For example, the user may define goals such as, (i) not more than 8 percent of inputs should be blocked or should be regarded as malicious, and (ii) up to 6 gigabyte of RAM may be allocated for input analysis and attack detection, and (iii) up to 450 clock-cycles of two processing cores may be allocated for input analysis and attack detection; and at a certain time-point, once the invocation of a particular Protection Suite reaches those constraints, the Protection Suite (or the operational parameters that it utilizes) may be automatically adapted or modified by the Protection Platform in order to remain within the goals or the constraints as defined in the Protection Policy.

Accordingly, some embodiments may utilize a dynamic or a dynamically-changing or a dynamically-changeable Protection Policy, as well as dynamic or dynamically-changing or dynamically-changeable or dynamically-switchable Protection Suites. The dynamic properties are important since, for example, monetary costs of computing resources may dynamically change, and/or because a new vulnerability may cause a sudden spike in a certain type of attacks, and/or because a particular event (e.g., a war between two nations, or a business conflict between two corporations) may cause a spike in attacks against a particular ML/DL/AI Engine. The system may thus provide a dynamically-changing or dynamically-adjusting aggregation of protection functionalities, that takes into account (and complies with) said constraints and said goals; and this may be implemented at the online or cloud-based platform and/or at the on-premises deployed unit(s) and/or at the Attack Mitigation Unit 124 and/or at other suitable units of the system.

In some embodiments, the system may perform dynamic or periodical optimization or modification or adjustment (or switching) of defense policies, and/or of the defense techniques or protection functionalities that are applied to enforce or to achieve a particular defense policy or protection policy or its goals or its constraints, based on one or more rules or parameters or conditions or analysis; for example, by considering and analyzing a history of performance of defense/protection optimizations and/or modifications; by extracting features from the particular use case (e.g., the characteristics of the particular ML/DL/AI being protected, system type, dataset type, dataset size, overall dataset features, dataset features that are generated using an autoencoder, model type), and may train an AI-based system (e.g., Deep Neural Network (DNN), Graph Neural Network (GNN), clustering method, Nearest Neighbor method, combination of such or other methods) to predict or to estimate an effective defense suite and/or the effective combination or aggregation of protection functionalities that would reach the goals (or, the highest number of goals) from the goals that are defined by the Protection Policy, while also complying with the system utilization constraints (e.g., operational constraints, processing resources constraints, memory constraints, time constraints, false-positive threshold constraint, false-negative threshold constraint) or with the highest number of such constraints. In some embodiments, optionally, a first Differential Weight Formula may be used with regard to the various Goals that are defined in the Protection Policy, since a particular goal (e.g., to block 98 percent of attacks) may be assigned a greater weight relative to another particular goal (e.g., to have not more than 7 percent of false positive errors); and similarly, optionally, a second Differential Weight Formula may be used with regard to the various Constraints that are defined in the Protection Policy or by the system administrator (e.g., the owner or administrator of the protected ML/DL/AI engine), since a particular Constraint (e.g., to use not more than 5 gigabytes of RAM) may be assigned a greater weight or a greater rigidity relative to another particular constraint (e.g., to finish all computations with regard to any input signal within 6 seconds of receipt of the input signal). The output of the weighted formula may be used as a consideration in the dynamic optimization or modification (or switching) of the Protection Policy and/or of the protection functionalities that are applied.

Some embodiments provide a system comprising: one or more processors that are configured to execute code, wherein the one or more processors are operably associated with one or more memory units that are configured to store code. The system is configured to protect a Protected Engine that is a unit selected from the group consisting of: a Machine Learning (ML) unit, a Deep Learning (DL) unit, an Artificial Intelligence (AI) unit, a Neural Network (NN) unit, a Large Language Model (LLM) unit. The system is configured to protect the Protected Engine against malicious inputs and malicious queries and malicious training data and malicious attacks. The system comprises at least one of (or, in some implementations, both of): (a) an Offline Protection Unit, to analyze one or more characteristics of the Protected Engine, and to perform offline fortification of said Protected Engine against attacks by changing one or more operational properties or operational parameters of the Protected Engine and to reduce its vulnerability to attacks; (b) an Online Protection Unit, to perform analysis of at least one of: (i) one or more inputs that are directed to be inputs of the Protected Engine, (ii) one or more outputs that are generated by the Protected Engine; and based on said analysis, to dynamically perform online fortification of said Protected Engine against attacks by dynamically changing one or more operational properties or operational parameters of the Protected Engine and to reduce its vulnerability to attacks.

In some embodiments, the Protected Engine utilizes a Protected Model that is selected from the group consisting of: a ML model, a DL model, an AI model; wherein at least one of the Offline Protection Unit and the Online Protection Unit, automatically modifies said Protected Model, from a pre-modification model version that is vulnerable to a particular attack, to a post-modification model version that is not vulnerable at all or that is less vulnerable to said particular attack.

In some embodiments, the Protected Engine operates based on a Protected Dataset; wherein at least one of the Offline Protection Unit and the Online Protection Unit, automatically modifies said Protected Dataset, from a pre-modification dataset version that causes the Protected Engine to be vulnerable to a particular attack, to a post-modification dataset version that causes the Protected Engine to be not vulnerable at all or less vulnerable to said particular attack.

In some embodiments, the Protected Engine operates based on a Protected Dataset; wherein at least one of the Offline Protection Unit and the Online Protection Unit, automatically modifies said Protected Dataset, from a pre-modification dataset version that causes the Protected Engine to be vulnerable to a particular attack, to a post-modification dataset version that causes the Protected Engine to be not vulnerable at all or less vulnerable to said particular attack; by generating and adding Adversarial Data to said Protected Dataset and by initiating re-training of the Protected Engine based on the post-modification dataset version.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, from a pre-modification architecture version that causes the Protected Engine to be vulnerable to a particular attack, to a post-modification architecture version that causes the Protected Engine to be not vulnerable at all or less vulnerable to said particular attack; by modifying a number or an order of said pipeline operations or by modifying one or more of said particular values of operational parameters.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, from a pre-modification architecture version that causes the Protected Engine to be vulnerable to a particular attack, to a post-modification architecture version that causes the Protected Engine to be not vulnerable at all or less vulnerable to said particular attack; by adding to said Protected Architecture a pre-processing unit that performs an additional operation on inputs received by the Protected Engine.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, from a pre-modification architecture version that causes the Protected Engine to be vulnerable to a particular attack, to a post-modification architecture version that causes the Protected Engine to be not vulnerable at all or less vulnerable to said particular attack; by adding to said Protected Architecture a post-processing unit that performs an additional operation on outputs generated by the Protected Engine prior to transferring said outputs to an intended recipient.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, from a pre-modification architecture version that causes the Protected Engine to be vulnerable to a particular attack, to a post-modification architecture version that causes the Protected Engine to be not vulnerable at all or less vulnerable to said particular attack; by adding to a pipeline of the Protected Architecture an attack detector unit that analyses inputs and determines whether a particular input or a particular group of inputs relate to an attack on the Protected Engine.

In some embodiments, the Attack Detector Unit is not necessarily an integral part of the protection array or the offline protection unit or the online protection unit; but rather, it may be an auxiliary unit that detects attacks or that estimates that a particular input (or set of inputs) may be part of an attack or may be malicious or non-legitimate; and may transfer an “attack detected/estimated” signal to other parts of units of the system in order to invoke protection operations and/or mitigation operations.

In some embodiments, one or more of the protection units of the platform or system, such as the Offline Protection Unit, may operate by actively modifying or adjusting an internal structure of the model (or, the digital representation of a model) on which the ML/DL/AI engine runs or operates; and/or by adding pre-processing and/or post-processing operations, filtering operations, sanitizing operations, re-training, adversarial training, and/or other techniques; and may perform operations that cause the ML/DL/AI engine and/or its model to be more resilient towards attacks or less vulnerable or more robust.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, by performing at least one of: (i) rate-limiting a number of queries that a particular recipient can submit to said Protected Engine, (ii) discarding at least some of incoming queries to said Protected Engine, (iii) quarantining at least some of incoming queries to said Protected Engine; (iv) intentionally delaying outputs, or a particular output, or particular subset of outputs, that are generated by the Protected Engine, prior to their delivery to the relevant or intended recipient(s); (v) alternating among two or more of the above-mentioned operations, or performing from time to time a different operation from the above-mentioned operations.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, by intentionally delaying responses that are outputted from said Protected Engine towards a particular recipient.

In some embodiments, the Protected Engine utilizes a Protected Architecture having a particular number of pipeline operations that utilize particular values of operational parameters; wherein at least one of the Offline Protection Unit and the Online Protection Unit, automatically modifies said Protected Architecture, by intentionally providing incorrect outputs from said Protected Engine towards a particular recipient that is determined to be an origin of malicious queries.

In some embodiments, at least one of the Offline Protection Unit and the Online Protection Unit, utilizes a Secondary Engine that is selected from the group consisting of: a secondary ML engine, a secondary DL engine, a secondary AI engine, to perform a secondary classification of an input query that is received from a particular originating entity; and based on a classification of said input query performed by the Secondary Engine, to determine whether or not said input query is part of a malicious attack on the Protected Engine.

In some embodiments, the system further comprises an AI-based Pen-Testing Unit (or ML-based or DL-based Pen-Testing Unit), configured to perform, in a controlled manner, automated penetration tests against said Protected Engine; and configured to estimate or to predict (e.g., via ML/DL/AI techniques) a quantitative level of resilience of said Protected Engines against various types of attacks. In some embodiments, every penetration test that is performed against the Protected Engine, adds a new data-sample or data-point that is then utilized by the AI-based (or ML-based or DL-based) Pen-Test Unit to re-train and thus improve the pen-testing prediction model(s). In some embodiments, the AI-based (or ML-based, or DL-based) pen-testing unit may predict or estimate the most effective attacks or attack-types that can be used against the Protected Engine, and/or may predict or estimate the hyper-parameters of such attack or the most effective way that such attack can be carried out against the Protected Engine; and the ML-predicted hyper-parameters of the ML-predicted attack against the Protected Engine may be used by the protection platform in order to invoke or apply or select the relevant or the effective protection operations or mitigation operations (e.g., via ML-based/AI-based/DL-based prediction or selection; or by a deterministic selection process that is based on a set of pre-defined selection rules).

Similarly, the Offline protection unit and/or the Online protection unit may be AI-based or ML-based on DL-based, and therefore they may be continuously (or periodically) re-trained based on the ongoing monitored performance of the Protected Engine and/or the protection platform, thus learning and improving autonomously.

In some embodiments, the system comprises a Defense Policy Constructor Unit, configured to construct a user-configurable Defense Policy that is defined by a plurality of user-configurable operational constraints of the Protected Engine, and configured to dynamically select and invoke and enforce a particular Protection Scheme, from a pool of multiple available Protection Schemes, that protects the Protected Engine against attacks while also complying with the user-configurable operational constraints.

In some embodiments, the system comprises: an Attack Mitigation Unit, configured to select and to activate one or more deterministic and non-A.I.-based mitigation techniques, in response to a determination that the Protected Engine is being attacked.

In some embodiments, the system comprises an Attack Mitigation Unit, configured to select and to activate one or more A.I.-based non-deterministic mitigation techniques, in response to a determination that the Protected Engine is being attacked.

In some embodiments, the system comprises: a Non-Intrusive Defense Unit, configured to perform pre-processing operations and/or post-processing operations that block a detected attack against the Protective Engine, without modifying a model that is utilized by the Protected Engine, and without re-training the Protected Engine on a modified dataset, and without having access to an internal pipeline of operations that is performed by the Protected Engine.

In some embodiments, the Protected Engine is protected against malicious queries and malicious inputs by said system which is a remote, cloud-computing based system that is remote from said Protected Engine and is not co-located with said Protected Engine.

In some embodiments, the system comprises: a Defense Policy Construction Unit, to enable a user to input (i) defense goals for protecting the Protected Engine, and also (ii) operational constraints that the Protected Engine and/or the system should comply with; and a Defense Optimization Unit, that operates based on said defense goals and said operational constraints as provide by said user, and that is configured to dynamically select and apply a particular set of defense techniques to prevent or to mitigate attacks against the Protected Engine.

In some embodiments, the Defense Optimization Unit operates based on AI-based estimation or AI-based prediction of effective defense techniques that should be selected and applied for protecting said Protected Engine, based on AI-based analysis of historic data of protecting a plurality of different AI engines and/or ML engines and/or DL engines.

In some embodiments, the Protected Engine is one protected engine within a combination or a cascade or a pipeline of two or more AI or ML or DL engines; wherein the system performs protection operations to protect at least a portion of said combination or cascade or pipeline.

In some embodiments, the Online Protection Unit is configured to introduce and to invoke a Pre-Processing module that performs defensive pre-processing of input signals that are directed towards said Protected Engine.

In some embodiments, the Online Protection Unit is configured to introduce and to invoke a Post-Processing module that performs defensive post-processing of output signals that are generated and outputted by said Protected Engine prior to their delivery to intended recipients.

In some embodiments, the Online Protection Unit is configured to modify an operational architecture of said Protected Engine, from (I) a stand-alone or independent Protected Engine, to (II) a Protected Engine that is part of a multi-engine pipeline or multi-engine cascade structure that is more resilient to attacks relative to the stand-alone or independent Protected Engine.

In some embodiments, the system comprises a weak spot detector, that is configured: (A) to cluster an original dataset into at least a first cluster and a second cluster, wherein the first cluster has data-items of the original dataset that share a first common characteristic, wherein the second cluster has data-items of the original dataset that share a second common characteristic; and (B) to compare between (I) a first performance accuracy of the Protect Engine towards data-items of the first cluster, with (II) a second performance accuracy of the Protect Engine towards data-items of the second cluster; and (C) based on analysis that takes into account (c1) characteristics of the first cluster, and (c2) characteristics of the second cluster, and (c3) the first performance accuracy, and (c4) the second performance characteristic, determining a weak spot of the Protected Engine in which the Protected Engine performs inaccurately towards a particular type of input data-items having a particular characteristic.

In some embodiments, the system comprises a Semantic Attack detector, configured to detect an attack that adds corrupting inputs to legitimate inputs that are provided to the Protected Engine.

In some embodiments, the system comprises a Physical Real-World Attach detector, configured to detect an attack that makes a real-world non-digital modification to a real-world object or to a real-world environment in order to defraud or confuse the Protected Engine.

In some embodiments, the system comprises an AI-based Attack Unit, configured: (I) to automatically analyze and research at least (i) operational characteristics of the Protected Engine, and (ii) publicly-available information about attacks against AI engines; and (II) to generate a textual output in a natural language, that indicates a novel method to attack the Protected Engine.

In some embodiments, the system comprises: an AI-based Attack Unit, configured (I) to analyze and research at least (i) operational characteristics of the Protected Engine, and (ii) publicly-available information about attacks against AI engines; and (II) to generate a textual output in a programming language, that is capable of performing a novel attack against the Protected Engine.

In some embodiments, the system comprises an AI-based Brainstormer Unit, which comprises at least: (i) a first Large Language Model (LLM) that is configured to generate output that focuses on a first performance aspect of the Protected Engine; (ii) a second Large Language Model (LLM) that is configured to generate output that focuses on a second, different, performance aspect of the Protected Engine; (iii) a chat coordination unit, to coordinate an automatic chat between the first LLM and the second LLM, and to extract from said automatic chat at least one insight that improves performance of the Protected Engine.

In some embodiments, the system comprises an AI-based Brainstormer Unit, which comprises at least: (i) a plurality of Large Language Model (LLM) units, wherein each LLM unit is configured to generate output that focuses on a different performance aspect of the Protected Engine; (ii) a Moderator LLM, that is configured to allocate chat slots among the plurality of LLM units, and to determine what portion of chat history is accessible to each of the LLM units; and to extract from an automatic chat of said plurality of LLM units at least one insight that improves performance of the Protected Engine.

Some embodiments may provide intent-based security analysis for dynamic ai systems. For example, an innovative aspect of some embodiments that provide protection and fortification resides in the system's ability to implement security analysis not merely in the narrow space of inputs, outputs, or deterministic code pathways, but rather in the higher-order semantic and functional abstraction that may be referred to as the “intent space”. Unlike conventional methods that attempt to confine security enforcement to syntactic filtering, static rule sets, or surface-level monitoring of system activities, some embodiments of the invention leverage intent-centric analysis to address the complex challenges presented by modern dynamic agentic AI systems. Such agentic systems often comprise a multiplicity of independent or semi-autonomous agents, interactive tools, modular services, and evolving user-defined use cases that shift continuously over time and across operational contexts. By introducing intent-space analysis, the system can provide a mechanism that is suited for multi-layered and dynamically evolving ecosystems;

thereby enabling detection, prediction, and mitigation of security risks that cannot be adequately addressed through legacy systems. This intent-oriented protection architecture establishes a comprehensive guardrails framework, wherein the safeguarding of AI ecosystems is performed at a semantic level that is capable of adapting to novel tasks, dynamic goal reconfigurations, and multi-agent coordination, thereby fortifying trust and governance across the entire operational lifecycle of agentic AI engines.

In accordance with some embodiments, the core framework underlying the intent-based protection system is the realization that security vulnerabilities, misuse opportunities, or adversarial behaviors can be systematically uncovered and mitigated by evaluating all functional components of an AI ecosystem through the prism of their operative(s) “intents”. Each element of a complex AI system (whether it is a tool, a user, or an autonomous agent or Agentic Unit) functions not merely as a passive computational device but as an entity oriented towards achieving a set of defined or emergent objectives. For example, computational tools may be designed with intrinsic functional objectives such as performing numerical calculations, conducting linguistic transformations, or generating graphical representations. In parallel, users interacting with the system may pursue their own high-level goals, which can range from singular, short-term objectives to multi-faceted and evolving agendas, thereby introducing layers of variability and potential misalignment. Furthermore, autonomous agents or AI-based Agentic Units, which orchestrate operations across tools and user interactions, may develop or be configured with their own intents; ranging from transient, task-specific directives to longer-term strategic objectives that persist across multiple operational sessions. The system can be adapted to conceptualize each element as an intent-driven actor, and to provide a unified semantic layer for security analysis, wherein conflicts, abuses, or adversarial manipulations may be identified at their inception, long before they manifest in conventional action-space misuses or harmful outputs.

Some embodiments thus provide a systematic methodology for intent-based security analysis, wherein the system continuously and dynamically monitors, interprets, and evaluates the operative intents and objectives of all constituent elements within the AI ecosystem. The system constructs a persistent semantic layer of intent traces, against which potential security issues may be detected and mitigated. For example, the system is configured to perform real-time monitoring of intents across users, agents, and tools, and to detect mis-alignments whenever the operative intent of one layer conflicts with the designed objectives of another. Such conflicts may manifest when an autonomous agent seeks to repurpose a tool in a manner inconsistent with its secure operational definition, or when a user formulates objectives that attempt to redirect the system outside of its authorized domain of application. In addition, the system employs advanced pattern-recognition techniques and adversarial-intent detection modules to identify intent expressions that are potentially malicious, adversarial, or compromising in nature. Once such deviations are identified, the system enforces guardrails in a dynamic and adaptive manner, preventing the further execution of operations that exceed predefined security boundaries. For instance, when a user attempts to manipulate an agent designated exclusively for sensitive governmental operations by querying it about entertainment or sports topics, the system immediately detects the cross-domain intent misalignment, flags the query as unauthorized, and enforces corrective containment actions, thereby preserving the integrity, trustworthiness, and authorized use of the protected AI ecosystem.

An important element in the intent-based protection system is the recognition that intents themselves are not static, rigid, or permanently assigned, but rather constitute evolving semantic constructs that transform continuously throughout system operation. Intents may shift as users redefine their objectives, as agents adapt to new roles, or as contextual circumstances impose novel requirements on tools and services. Consequently, the system implements a continuous reasoning process that persistently analyzes the evolving intents of all participating components, actors, and subsystems, thereby providing real-time situational awareness of the dynamic intent landscape. This reasoning process incorporates ongoing AI-driven analysis of operational traces, activity logs, communication patterns, and event records, allowing the system to infer and re-infer the most current intents attributed to each element. On the basis of this evolving intent landscape, the protection framework deploys adaptive and responsive security measures that automatically recalibrate their scope and severity in accordance with shifting semantic conditions. Thus, instead of enforcing rigid static rules that may quickly become obsolete in complex environments, the system actively monitors transformations in user goals, agent objectives, and tool utilization pathways, thereby enabling an intelligent, fluid, and context-aware adaptation of defenses. Such dynamic intent management ensures that the system remains continuously aligned with both authorized operational parameters and evolving security requirements, thereby achieving a higher level of resilience against adversarial manipulation, misuse, or unintended cross-domain leakage.

The system can thus be configured to achieve reduction of multi-dimensional and complex security challenges to an abstract, semantic layer that may be termed the “intent space” or the “intent layer”. By elevating the axis of security enforcement from surface-level observation of actions to the higher-order evaluation of intents, the system achieves a powerful and unifying abstraction for securing dynamic AI environments. This shift enables the protection framework to address threats not merely in terms of what is being executed at a given moment, but more profoundly in terms of what the participating entities are attempting, desiring, or striving to achieve. The system is focused on the underlying objectives of tools, agents, and users, and provides a more reliable, effective, and flexible enforcement mechanism for trust, governance, and alignment. This intent-space reduction transforms disparate and otherwise unmanageable security challenges into a coherent domain where guardrails, protective measures, and fortification layers can be systematically defined, reasoned about, and enforced. Accordingly, the innovation lies not merely in detecting anomalies in observable actions, but in detecting divergences, manipulations, and adversarial behaviors at their semantic root, long before they manifest operationally, thereby delivering a novel and superior paradigm for AI protection, fortification, and trustworthy deployment.

The Applicant has further recognized that intent analysis is not an isolated analytical construct, but rather, it is inseparably connected to the broader domain of contextual awareness. Operative intent forms an important component of the overall contextual fabric in which an AI ecosystem operates. Accurate inference of intent cannot be performed without a deep and nuanced understanding of the surrounding contextual conditions, parameters, and situational features. This bi-directional dependency creates a reinforcing feedback loop in which context is both enriched by intend and is foundational to intent; while intent simultaneously provides semantic anchoring and interpretive value to contextual signals. Thus, intent-based analysis is an extension of the context-aware protection framework of some embodiments. By jointly evaluating context and intent, the system achieves a more holistic, accurate, and reliable understanding of what each actor, agent, or tool is attempting to achieve relative to the environment in which it operates. This synthesis ensures that protective measures are not only triggered by isolated signals, but are instead grounded in a comprehensive semantic picture that integrates both the immediate operational context and the underlying objectives of system participants. The result is a fortified and highly adaptive security paradigm that unifies context-awareness with intent-awareness to deliver next-generation protection of AI ecosystems.

The Applicant has realized that in order to achieve a robust, scalable, and contextually adaptable framework for protecting advanced AI, ML, DL, and LLM engines, it is insufficient to merely rely on surface-level inspection of inputs, outputs, or deterministic signatures. Instead, there is a necessity for a multi-layered semantic and operational analysis paradigm that penetrates deeper into the underlying intents, contexts, and interaction flows that define the operational ecosystem of such engines. Some conventional systems have suffered from a limitation, which is that they narrowly focus on static filtering, heuristic signatures, or pre-defined anomaly thresholds, thereby failing to detect complex misuse scenarios that evolve dynamically across multi-agent and multi-tool environments. The disclosed embodiments, by contrast, introduce a comprehensive methodology wherein every participating entity in the AI ecosystem (e.g., an autonomous agent, a user, or a tool) is continuously evaluated with respect to its evolving objectives, thereby creating a fortified security layer that adapts dynamically in real time. This approach transforms security enforcement from a rigid, rule-based gatekeeping process into an intelligent, adaptive, and semantically aware protection fabric that mirrors the complex realities of modern AI deployments.

An important innovation of some embodiments is in the abstraction of operational evaluation into the realm of “intent analysis”; wherein the operative objectives of users, agents, and computational tools are treated as first-class elements of security evaluation. Some conventional systems have suffered from limitations as they restrict monitoring exclusively to observable actions, transactional data points, or deterministic algorithmic flows, without appreciating that the driving force behind such actions is the intent motivating the entity. By focusing on what each actor seeks to achieve, rather than merely what they appear to do in a single transaction, the disclosed system can proactively identify misalignments, adversarial manipulations, or emergent risks long before they escalate into harmful outputs or systemic compromise. Thus, intent-based evaluation enables the invention to function not only as a reactive defense but also as a predictive, anticipatory safeguard that can diagnose threats at their inception, thereby fortifying the AI engine against categories of misuse that were previously invisible to conventional frameworks.

Some embodiments provide a method for security analysis wherein the operative intents of all participating elements are continuously monitored, dynamically correlated, and rigorously evaluated for alignment or misalignment across the multi-layered ecosystem. Some conventional systems have suffered from limitations as they operate on discrete checks or periodic validations, thereby creating windows of vulnerability during which adversarial entities may exploit inconsistencies. The present system, however, functions as a persistent guardian, executing real-time evaluation of intent traces, comparing the objectives of users with the operational definitions of tools, and aligning agent behaviors with overarching system policies. By doing so, the framework can detect and contain misuse at the precise moment when an inconsistency emerges, whether it be a user attempting to redirect a government-service agent toward irrelevant entertainment queries, or an agent attempting to weaponize a tool for purposes beyond its secure design. The disclosed system thereby creates a dynamic enforcement environment where protective guardrails are applied adaptively, ensuring both precision and resilience in response to adversarial maneuvers.

The Applicant has further recognized that intents are inherently dynamic, continuously evolving with the passage of time, the accumulation of interactions, and the shifting circumstances of context. Some conventional systems have suffered from limitations as they ignored intents entirely, or (at most) treated intents as static or permanently assigned attributes, assuming that once a goal or objective has been established it remains fixed and unchanging. In contrast, the disclosed embodiments embrace the fluidity of intents by incorporating continuous reasoning processes and AI-driven inference modules that analyze operational logs, system traces, and interaction histories to determine the current, real-time intent landscape. As users redefine their goals, as agents adapt to new instructions, and as tools are repurposed across use cases, the system recalibrates its protection measures accordingly, deploying adaptive defenses that evolve in step with these transformations. The result is a living, contextually responsive protection architecture that can fortify AI engines against both sudden shifts in adversarial strategy and gradual drifts in system use, thereby maintaining continuous alignment with authorized objectives while simultaneously preserving security integrity.

Some embodiments perform semantic reduction of complex multi-dimensional security challenges into a unified intent-objective space, which serves as a higher-order analytical layer for all protective operations. Some conventional systems have suffered from limitations as they remain tethered to low-level signal monitoring, simple anomaly detection, or action-based heuristics, none of which provide a holistic view of what the participating actors are fundamentally striving to achieve. By abstracting security reasoning into the intent space, some embodiments of the invention create a powerful mechanism whereby adversarial maneuvers, manipulations, or misalignments can be recognized in their formative stages, at the root of motivation rather than at the end-point of execution. This innovation allows security measures to transcend the reactive boundaries of legacy defenses and instead engage in proactive, anticipatory, and highly flexible fortification, thereby establishing a new paradigm of trust, governance, and operational resilience for AI systems deployed in sensitive or mission-critical.

The Applicant has realized that intent analysis cannot be detached from contextual awareness, for intent and context exist in a symbiotic and bidirectional relationship that mutually reinforce one another. Some conventional systems have attempted to evaluate actions or intents in isolation, without embedding them in the contextual fabric from which they arise. In some embodiments of the invention, intent is treated not as an abstract entity separated from environment, but as a semantic construct that is inseparable from the circumstances, conditions, and contextual parameters surrounding it. Conversely, accurate inference of intent is only possible when informed by contextual awareness, since the same surface action may signal entirely different intents depending on the environment in which it occurs. This co-dependence establishes a unified analytical layer wherein context enriches the detection of intent, while intent clarifies and disambiguates contextual signals, thereby enabling a robust framework for protection, trust enforcement, and adaptive fortification that is superior to conventional approaches.

The disclosed intent-based security framework functions not merely as a defensive perimeter but as an active governance mechanism that continuously monitors, interprets, and recalibrates the trustworthiness of system operations. Some conventional systems have suffered from limitations as they equate security solely with the prevention of unauthorized access or direct attacks, thereby ignoring the broader spectrum of misuses, manipulations, and emergent risks that arise when autonomous agents and multi-agent ecosystems pursue goals that diverge from intended purposes. By treating intents as measurable and monitorable entities, the system provides administrators, operators, and auditors with a continuously updated map of motivational alignment, revealing where trust is being preserved, where deviations are occurring, and where adversarial infiltration may be attempting to gain foothold. This operational governance capability not only protects the AI system from direct attacks but also ensures ongoing compliance with broader organizational, ethical, and policy frameworks, thereby extending the utility of the invention beyond cybersecurity into domains of trust management and AI alignment.

In accordance with some embodiments, the integration of intent-based analysis into the broader protection and fortification architecture establishes a comprehensive security paradigm that unifies semantic reasoning, contextual interpretation, and adaptive defense in a single coherent framework. Some conventional systems have suffered from a limitation, which is that they attempt to apply fragmented security modules in isolation (such as anomaly detection engines, policy enforcement filters, or static monitoring dashboards), one of which alone provide sufficient resilience against the complex and evolving adversarial landscape. The disclosed invention, by contrast, operates as a holistic protection environment where intent, context, and adaptive fortification converge, thereby delivering a security model that is not only resistant to today's attacks but is inherently scalable to tomorrow's unforeseen challenges. By embedding intent-based reasoning into every layer of the protection stack, some embodiments of the invention assure that AI, ML, DL, and LLM units can operate securely, reliably, and in alignment with authorized objectives across a wide spectrum of domains, applications, and operational contexts, thereby enabling safe deployment of powerful agentic technologies in exposed environments.

In some embodiments, the system performs security analysis in an intent space by continuously correlating semantic objectives of users, agents, and tools to dynamically fortify protection, trustworthiness, and governance across evolving AI ecosystems. In some embodiments, the protection includes adaptively detecting and mitigating adversarial misuse by evaluating intents beyond observable actions, thereby enabling predictive fortification against complex multi-agent manipulations that static filters or fixed thresholds cannot reliably prevent. In some embodiments, an intent-based protective fabric semantically monitors agentic ecosystems comprising multiple agents, diverse tools, and evolving use-case contexts, dynamically enforcing adaptive guardrails to mitigate adversarial threats, misuse, or cross-domain leakage of sensitive objectives. In some embodiments, the protective layer operates in real time across dynamically shifting AI environments, continuously reasoning about evolving intents and contextual dependencies to enforce resilience against adversarial intrusions, semantic misalignments, and malicious exploitation of agent-tool coordination.

In some embodiments, evaluation is performed by analyzing operative intents of all participating entities, thereby identifying misuse or misalignment at the semantic root before harmful actions manifest in the operational layer of the AI ecosystem. In some embodiments, the protective framework distinguishes functional objectives of tools, evolving goals of users, and operational intents of autonomous agents, thereby constructing a semantic monitoring fabric that enables early-stage detection of adversarial manipulations and emergent risks. In some embodiments, protection mechanisms are triggered upon semantic divergence of intents, thereby preemptively neutralizing adversarial activity by focusing on motivational objectives rather than exclusively monitoring surface-level actions or deterministic outputs. In some embodiments, intent-based monitoring serves as a predictive safeguard, continuously diagnosing semantic misalignments that indicate potential adversarial compromise, thereby fortifying AI systems against emergent manipulations undetectable through action-based or anomaly-only monitoring mechanisms.

In some embodiments, the system continuously monitors operative intents across users, agents, and tools, and enforces adaptive security guardrails upon detecting semantic conflicts between designed objectives and evolving operational behaviors. In some embodiments, adversarial mis-use is neutralized by correlating user intents with tool objectives and agent directives, dynamically preventing unauthorized repurposing of computational resources in real time. In some embodiments, the protective system enforces containment actions when an agent attempts to misuse a tool inconsistent with its secure operational definition, thereby safeguarding critical functions against adversarial redirection or unauthorized manipulation. In some embodiments, guardrails are applied adaptively in response to detected misalignments, ensuring precise and resilient protection against adversarial attempts to exploit inconsistent objectives across multi-agent or user-driven operational layers.

In some embodiments, the protection system dynamically re-calibrates its defensive strategies by analyzing evolving intents across agents, tools, and users, thereby maintaining continuous alignment with authorized objectives. In some embodiments, an AI-driven inference engine continuously interprets logs, traces, and activity histories to infer shifting intents, dynamically adapting security operations in accordance with evolving contextual landscapes. In some embodiments, adaptive guardrails are deployed in real time to preserve system resilience as user goals, agent directives, and contextual constraints transform throughout operation. In some embodiments, the system operates as a continuously evolving protection fabric, recalibrating fortification measures to reflect semantic shifts in adversarial strategies and authorized operational requirements.

In some embodiments, the protection comprises semantic reduction of complex security challenges into an intent-objective space, enabling detection of threats at motivational origins rather than limiting analysis to surface actions. In some embodiments, adversarial activity is neutralized at its semantic root by evaluating the underlying objectives of participating entities, thereby providing proactive resilience against manipulations undetectable by conventional reactive measures. In some embodiments, the system implements intent-based abstraction to unify trust, governance, and adaptive security, delivering a holistic and anticipatory protection framework across mission-critical AI environments. In some embodiments, protective reasoning emphasizes motivational intent over observable output, to enable early-stage adversarial recognition, predictive neutralization, and long-term trust enforcement.

In some embodiments, intent analysis is performed in conjunction with contextual reasoning, such that protective determinations are based on both semantic objectives and environmental conditions. In some embodiments, context-aware modules refine inference of user or agent intent, thereby preventing misclassification of benign activities as adversarial threats and improving accuracy of protective enforcement. In some embodiments, protective measures are deployed by integrating contextual awareness with intent analysis, delivering a bidirectional semantic framework that detects misuse across diverse operational environments. In some embodiments, context-intent synergy enhances adaptive security by disambiguating adversarial manipulations from legitimate operational objectives, thereby increasing resilience against complex, situationally adaptive threats.

In some embodiments, the protective monitoring unit functions as an active governance layer, continuously evaluating intent alignment to ensure trustworthiness, compliance, and resilience across multi-agent AI deployments. In some embodiments, wherein deviations in motivational objectives are mapped in real time, enabling detection of adversarial infiltration or unauthorized repurposing of system capabilities. In some embodiments, protection can extend beyond cyber-security to include governance enforcement, ensuring compliance with ethical, regulatory, and organizational standards. In some embodiments, adversarial manipulations are mitigated through real-time motivational analysis, preventing agents from diverging from authorized operational purposes.

In some embodiments, intent-based reasoning is integrated into all protective layers, creating a holistic defense system resistant to both current and emergent adversarial strategies. In some embodiments, fragmented security modules are unified under a single semantic-intent framework, thereby delivering coherent and scalable protection across diverse AI environments. In some embodiments, adaptive fortification integrates motivational reasoning, contextual awareness, and semantic monitoring to resist adversarial compromise across dynamic operational landscapes. In some embodiments, holistic protective reasoning unifies semantic intent, contextual parameters, and adaptive defenses, thereby enabling secure, trustworthy, and authorized deployment of AI ecosystems in exposed contexts.

The Applicant has realized that some conventional systems have suffered from a limitation, which is that they narrowly address only a small subset of adversarial manipulations, focusing primarily on classical evasion attacks or surface-level adversarial examples, and failing to provide comprehensive fortification against the full spectrum of modern threat vectors. In reality, advanced AI ecosystems are now exposed to a growing diversity of hostile actions, including model extraction attacks, membership inference exploits, and poisoning of datasets that can corrupt the integrity of downstream learning processes. Furthermore, additional vulnerabilities exist in the form of prompt injection attacks against LLM-based agents, reward hacking within reinforcement learning architectures, Byzantine attacks targeting distributed training scenarios, and algorithmic denial-of-service threats that drain computational, temporal, financial, and memory resources. The disclosed embodiments overcome these deficiencies by implementing a holistic protection framework configured to detect, mitigate, and neutralize all such advanced vectors in real time, thereby extending the protective perimeter of the system to encompass both established adversarial categories and newly emerging classes of threats that continuously evolve in sophistication.

The Applicant has further recognized that some conventional systems have suffered from a limitation, which is that they fail to specifically account for the unique vulnerabilities introduced by physical-world attack modalities directed at AI systems operating with sensors, cameras, or microphones. Unlike purely digital adversarial examples, these physical threats exploit the material environment by projecting light, lasers, or infrared signals; by emitting acoustic energy at ultrasonic or subsonic ranges; or by manipulating electromagnetic fields, surfaces, textures, and object materials to induce misclassification or system malfunction. As AI becomes increasingly embedded in robotics, autonomous vehicles, and IoT devices, these vectors represent not theoretical but highly practical dangers, capable of degrading performance or redirecting system behavior in mission-critical contexts. The disclosed invention therefore extends its protection architecture to include comprehensive defenses against optical manipulations, acoustic interference, electromagnetic disruption, and environmental modifications, thereby fortifying sensor-rich AI engines with resilience not only against digital intrusion but also against real-world adversarial manipulations that conventional frameworks leave unaddressed.

The Applicant has realized that some conventional systems have suffered from a limitation, which is that they focus narrowly on single isolated models, thereby failing to address the diverse architectures, ensemble deployments, and distributed frameworks that characterize modern AI usage. In reality, enterprise-level and mission-critical AI often operates across complex hybrid environments, including ensemble configurations, pipeline or cascade architectures, federated learning across distributed nodes, and edge-cloud hybrid deployments where computational responsibilities are partitioned across multiple domains. Adversarial threats may propagate uniquely within such architectures, exploiting inter-model dependencies or communication channels. Accordingly, the disclosed invention provides a generalized protection framework that extends to ensembles, cascaded pipelines, federated and distributed systems, as well as heterogeneous deployments bridging edge devices with cloud servers. By securing not only isolated engines but also interconnected systems across multiple operational layers, the disclosed embodiments ensure that protection is comprehensive, scalable, and adaptable to the most advanced and complex real-world AI deployments.

The Applicant has recognized that some conventional systems have suffered from a limitation, which is that they do not include mechanisms specifically designed to protect reinforcement learning (RL) engines, which possess unique vulnerabilities distinct from supervised or unsupervised models. In RL, adversaries may manipulate reward signals, inject malicious alterations into the environment, or exploit unsafe exploration strategies that cause the system to adopt unstable or dangerous policies. Moreover, multi-agent RL introduces further risks such as adversarial coordination, backdoor policies, and hidden collusion. The disclosed embodiments therefore introduce RL-specific protection modules that monitor the integrity of reward signals, constrain exploration within predefined safe boundaries, validate environmental conditions against manipulation, and analyze policy trajectories for signs of hidden adversarial objectives. Through these mechanisms, the system achieves a level of resilience uniquely suited to reinforcement learning, ensuring that dynamic agent-environment interactions remain secure against both external adversaries and internal degradation.

The Applicant has recognized that some conventional systems have suffered from a limitation, which is that they require decryption of sensitive data before protective operations can be applied, thereby undermining privacy and introducing new attack surfaces. In contrast, the disclosed invention integrates privacy-preserving cryptographic techniques, including homomorphic encryption, enabling protective modules to operate directly on encrypted data streams without revealing underlying content. This ensures that even the protection system itself does not gain knowledge of the specific sensitive data or the inner architecture of the protected engine, while still executing security evaluations, anomaly detections, and adversarial mitigations. Such an architecture is particularly critical in regulated domains such as healthcare, finance, and defense, where strict data confidentiality must be preserved while still ensuring robust adversarial resilience. By embedding encrypted interfaces into the protection pipeline, the invention achieves a dual objective: safeguarding system integrity against attacks while simultaneously preserving data privacy at all times.

The Applicant has realized that some conventional systems have suffered from a limitation, which is that they treat evaluation and protection as distinct and disconnected processes, resulting in inefficiencies and lost opportunities for optimization. Penetration testing modules may identify vulnerabilities, but their insights are rarely translated automatically into improved protection, while protective units often operate without continuous feedback from evaluative findings. The disclosed embodiments overcome this fragmentation by unifying evaluation and protection within a closed-loop architecture, wherein pen-testing results directly inform parameter adjustments, guardrail recalibrations, and adaptive fortification strategies. In this manner, every discovered vulnerability immediately enhances the protective framework, while every protective measure is continuously tested and refined against simulated adversarial inputs. The result is a self-improving system that maintains ongoing optimization, dynamically evolving in response to both simulated attacks and real-world adversarial conditions, thereby delivering resilience that strengthens continuously over time.

The Applicant has further recognized that some conventional systems have suffered from a limitation, which is that they fail to defend the protection layer itself against adversarial compromise, creating a single point of catastrophic failure. Adversaries may target the defense architecture directly through algorithmic denial-of-service attacks, integrity manipulation, or exploitation of protective redundancies, thereby disabling the entire system. The disclosed invention introduces meta-protection mechanisms that recursively monitor, validate, and fortify the protective infrastructure itself. Integrity checks, behavioral anomaly detection, and redundant protective layers are embedded within the system, ensuring that attempts to compromise the defense modules are themselves detected, isolated, and neutralized. Through this recursive fortification, the invention achieves resilience not only against attacks on AI engines but also against direct assaults on the protective environment itself, thereby ensuring that defenses remain continuously operational, trustworthy, and uncompromised.

The Applicant has recognized that some conventional systems have suffered from a limitation, which is that they rely exclusively on automated detection and mitigation, without incorporating the irreplaceable expertise and contextual judgment that human analysts provide. Complex and novel adversarial threats often require interpretative reasoning, contextual awareness, or ethical evaluation that current automated modules cannot reliably replicate. The disclosed invention therefore introduces a hybrid human-AI protection architecture, wherein human experts are integrated into low-confidence detections, verification workflows, collaborative defense strategies, and long-term attack intelligence analysis. By embedding human oversight into the system, the framework ensures that unusual or ambiguous cases benefit from human judgment, while also incorporating human-labeled attack data into adaptive retraining pipelines. This collaborative paradigm significantly enhances accuracy, reduces false positives and negatives, and ensures that protection remains responsive not only to computational anomalies but also to nuanced contextual scenarios that automated detectors alone may misinterpret.

The Applicant has realized that some conventional systems have suffered from a limitation, which is that they do not adequately address adaptive adversaries who observe and react to defensive measures in order to bypass them. In practice, sophisticated attackers iteratively probe protection systems, adjusting tactics to exploit weaknesses revealed by defensive responses. The disclosed invention therefore incorporates adaptive-attack resilience mechanisms that dynamically reconfigure protective strategies, simulate adversarial adaptation, and predict future attack vectors using AI-driven forecasting models. By continuously evolving defense strategies and training protection modules against simulated adaptive attackers, the system prevents static vulnerabilities from being exploited. In effect, the invention transforms the protective architecture into a living, evolving defense organism that maintains superiority over adaptive adversaries by staying several strategic steps ahead, thereby ensuring long-term resilience against dynamic attack strategies.

The Applicant has recognized that some conventional systems have suffered from a limitation, which is that they rely on known attack signatures or historical data to detect adversarial manipulations, leaving them incapable of addressing zero-day attacks or novel exploitation methods. To overcome this deficiency, the disclosed system integrates advanced anomaly-detection modules that analyze statistical deviations, behavioral irregularities, and unsupervised clustering to recognize patterns inconsistent with established baselines. By focusing on deviations from expected normal behavior rather than pre-classified threat patterns, the system acquires the ability to detect and mitigate zero-day attacks (e.g., threats that were not previously catalogued and could not be identified by static defenses). Through anomaly detection and behavioral modeling, the invention provides a proactive capability for identifying entirely new classes of adversarial attempts, thereby fortifying AI systems against both known and unknown categories of exploitation.

The Applicant has realized that some conventional systems have suffered from a limitation, which is that they address attacks in unimodal contexts, failing to recognize that many AI deployments now involve multiple modalities such as text, vision, audio, and sensor fusion. Cross-modal attacks can exploit inconsistencies between modalities, targeting the fusion layer where information streams converge. The disclosed invention extends protection to multi-modal systems by incorporating modality-specific validators, cross-modal consistency verification, and defenses against attacks that exploit one modality to compromise another. By safeguarding each input type individually and ensuring coherence across fused representations, the invention prevents adversarial manipulations that exploit vulnerabilities unique to multi-modal systems. This ensures that advanced AI engines operating across diverse sensory inputs maintain robust security and resilience against attacks designed to exploit modality integration.

The Applicant has realized that some conventional systems have suffered from a drawback, which is that they do not address cascaded attacks or supply-chain compromises, wherein adversaries infiltrate AI systems at sequential stages from data preparation to training, distribution, and deployment. Such multi-stage attacks exploit overlooked checkpoints, gradually degrading system integrity until operational compromise occurs. The disclosed invention implements supply-chain fortification modules that verify training data provenance, validate intermediate checkpoints, authenticate deployment pipelines, and monitor update integrity. Through this end-to-end defense, the system protects against sequential attack chains and ensures that every stage of the AI lifecycle remains secure. By preventing compromises at early stages from propagating into fully deployed models, the invention establishes comprehensive resilience against complex multi-stage adversarial strategies.

The Applicant has recognized that some conventional systems have suffered from a limitation, which is that they do not prevent adversaries from exploiting computational vulnerabilities to exhaust time, memory, energy, or API resources. Attackers may design inputs that trigger excessive computations, memory leaks, or financial costs through repeated API calls, thereby degrading availability and performance. The disclosed invention incorporates resource-protection modules that analyze computational complexity, monitor memory usage, enforce API call thresholds, and track energy consumption. By dynamically regulating resource utilization and identifying anomalous consumption patterns, the system prevents adversarial resource exhaustion and ensures stable availability. This resource-aware fortification guarantees that protective measures remain effective without incurring unsustainable costs, thereby ensuring efficiency, resilience, and operational continuity under hostile conditions.

The Applicant has further realized that some conventional systems have suffered from a limitation, which is that they treat protection mechanisms as static and immutable, making them vulnerable to reverse-engineering or bypassing by persistent attackers. The disclosed invention advances beyond this limitation by performing adversarial-oriented training of the protection system itself, subjecting its detectors and guardrails to continuous simulated attacks generated by penetration testing and adversarial modeling units. Each successful bypass attempt is fed back into the system to strengthen defensive algorithms, thereby ensuring that the protective framework continuously hardens itself in response to new attack strategies. This recursive adversarial training paradigm guarantees that the protective layer evolves in parallel with the threats it faces, creating a self-improving defense system that grows more resilient with every attempted intrusion.

The Applicant has realized that some conventional systems have suffered from a limitation, which is that they detect attacks without categorizing them, thereby failing to leverage contextual insights that can optimize ongoing defense strategies. Categorization provides essential metadata about adversarial events, including type, algorithm, required resources, and typical sophistication levels, enabling targeted mitigation and efficient allocation of protective resources. The disclosed invention therefore extends its detection framework to include classification and categorization of attack types, distinguishing between naive low-cost attempts and advanced mathematically sophisticated exploits. By mapping adversarial events into structured categories, the system enables more precise protective responses, reduces redundant analysis, and improves optimization of long-term defensive strategies.

The Applicant has also recognized that some traditional systems have suffered from a constraint, which is that they address adversarial manipulations generically, without distinguishing between low-cost, easily executed attacks and highly advanced, resource-intensive strategies. In practice, adversaries range from unskilled individuals leveraging readily available tools to expert actors developing sophisticated mathematical techniques. The disclosed invention explicitly differentiates between practical attacks and advanced ones, analyzing adversarial attempts in terms of resource requirements, execution complexity, and actor sophistication. By addressing the full spectrum (e.g., from simple occlusions and naive disguises to complex optimization-based perturbations), the system ensures resilience against both trivial low-cost exploits and highly specialized state-of-the-art adversarial methods. This differentiation enhances both the accuracy and efficiency of protective responses, ensuring proportional and resource-optimized defense against all categories of attack.

The Applicant has realized that some conventional systems have suffered from a disadvantage, as they apply fragmented security measures in isolation, without integrating them into a unified holistic framework that balances multiple objectives simultaneously. In reality, AI protection requires optimizing across diverse and sometimes conflicting requirements, including adversarial resilience, system performance, regulatory compliance, robustness, and efficiency. The disclosed invention introduces a holistic multi-objective fortification framework that unifies threat detection, anomaly prevention, context-awareness, resource efficiency, and governance requirements into a single coherent system. By performing joint optimization across all protection dimensions, the system ensures that AI engines are not only secure but also performant, reliable, and compliant. This holistic approach establishes a new paradigm in AI fortification, where security, trustworthiness, and operational excellence are pursued simultaneously within a comprehensive protection architecture.

In some embodiments, the protective framework detects and mitigates advanced threat vectors including model extraction, membership inference, prompt injection, reward hacking, data poisoning, and Byzantine attacks within distributed deployments, thereby achieving comprehensive resilience beyond conventional adversarial defenses. In some embodiments, algorithmic denial-of-service threats are neutralized through real-time monitoring of computational costs, resource consumption, and call rates, ensuring resilience against adversarial inputs designed to exhaust memory, financial, or processing resources. In some embodiments, the protection method incorporates semantic analysis to prevent unauthorized information stealing or backdoor attacks by continuously validating system integrity across datasets, training processes, inference pipelines, and adversarial probing attempts. In some embodiments, the adversarial mitigation process includes both evasion attacks and evolving categories of high-sophistication manipulations, thereby providing scalable protection across heterogeneous AI architectures, mission-critical contexts, and multi-domain operational environments.

In some embodiments, the protection extends beyond digital adversarial manipulation to detect and neutralize optical, acoustic, electromagnetic, and environmental attacks directed against AI systems employing cameras, microphones, or other physical sensors. In some embodiments, adversarial interference is prevented through specialized modules configured to block light projection attacks, laser disruptions, infrared manipulations, and adversarial surface textures designed to mislead vision-based classifiers. In some embodiments, acoustic protection units or mechanisms prevent ultrasonic and subsonic manipulations that compromise voice or sound recognition engines, thereby ensuring reliability in environments vulnerable to adversarial sound interference. In some embodiments, electromagnetic shielding and environmental validation are used to guard against adversarial interference targeting sensor arrays, ensuring accurate contextual awareness and consistent operational performance in real-world deployments.

In some embodiments, the protection process extends beyond single models to secure ensemble architectures, pipeline-based systems, cascaded processing units, and hybrid distributed environments against adversarial exploitation. In some embodiments, federated learning systems are fortified by monitoring inter-node communications and validating aggregated updates, thereby ensuring adversarial manipulations cannot propagate across distributed training infrastructures. In some embodiments, the protection encompasses edge-cloud hybrid deployments, dynamically fortifying communications and computational transfers between cloud servers and edge devices against adversarial interference or resource exploitation. In some embodiments, the adversarial mitigation process can safeguard complex multi-engine systems by monitoring cross-model dependencies, detecting cascading exploitation, and dynamically enforcing protective boundaries across interconnected AI deployments.

In some embodiments, reward hacking in reinforcement learning engines is mitigated by continuously validating reward signals against authorized policy structures and detecting anomalous manipulations in dynamic environments. In some embodiments, unsafe exploration behaviors are prevented through adaptive guardrails that constrain policy search spaces, thereby ensuring reinforcement learning agents operate only within predefined safe operational boundaries. In some embodiments, policy analysis modules evaluate trajectories of reinforcement learning agents to detect hidden backdoors, collusion, or adversarial objectives embedded within long-term operational strategies. In some embodiments, environmental validation units analyze reinforcement learning training environments to detect adversarial manipulation of states, transitions, or context variables that could degrade policy integrity.

In some embodiments, protective modules operate directly on encrypted data streams using homomorphic encryption, thereby enabling adversarial mitigation without requiring decryption of sensitive information. In some embodiments, encrypted interfaces preserve confidentiality of both user data and model architecture while still enabling security evaluation, anomaly detection, and adversarial resilience. In some embodiments, homomorphic encryption enables protection across regulated domains, including healthcare and finance, ensuring adversarial resilience without breaching compliance requirements for strict data confidentiality. In some embodiments, encrypted protection maintains privacy by preventing the defense system itself from accessing raw input data, thereby fortifying against both external and internal information leakage.

In some embodiments, penetration testing outputs are automatically translated into improved defensive parameters, thereby creating a continuous feedback loop that enhances protective accuracy against evolving adversarial strategies. In some embodiments, evaluation and protection are unified into a closed-loop framework, ensuring every identified vulnerability directly informs adaptive guardrail recalibration. In some embodiments, adversarial simulations continuously generate new attack vectors that test and refine protection, enabling ongoing optimization of defensive strategies. In some embodiments, unified evaluation-protection mechanisms reduce inefficiencies of fragmented workflows, delivering real-time adaptive resilience that strengthens continuously against hostile manipulations.

In some embodiments, the protection system recursively monitors its own behavior for anomalies, thereby defending itself against adversarial compromise attempts. In some embodiments, meta-protection layers enforce integrity validation and redundancy checks to ensure that protective modules remain resilient against targeted disabling attacks. In some embodiments, recursive protective monitoring detects algorithmic denial-of-service attempts directed at the defensive infrastructure itself, ensuring continued operation despite adversarial overload attempts. In some embodiments, the system fortifies the defense layer with redundant modules capable of seamlessly taking over protective functions when adversarial compromises are detected.

In some embodiments, optionally, outputs from human experts or from fine-tuned/specialized Agentic Unit(s) are integrated into low-confidence detections, verifying ambiguous cases that automated detectors cannot conclusively resolve. In some embodiments, collaborative defense workflows combine human expertise with AI-based anomaly detection, enabling hybrid verification of adversarial threats. In some embodiments, human-in-the-loop consultation provides interpretive reasoning and contextual oversight during long-term attack intelligence analysis. In some embodiments, human-labeled adversarial data is integrated into retraining pipelines, continuously improving accuracy of AI-driven protective modules.

In some embodiments, the defense units dynamically reconfigure in real time to prevent adversaries from bypassing static detection mechanisms. In some embodiments, simulated adaptive attackers are generated to forecast future adversarial strategies and continuously harden protection. In some embodiments, adversarial strategy prediction modules forecast attacker evolution, enabling defenses to remain several steps ahead of real-world adversaries. In some embodiments, the protection system evolves continuously by performing adversarial-oriented training of itself against simulated adaptive manipulations.

In some embodiments, anomaly detection modules analyze deviations from established baselines to identify zero-day adversarial threats. In some embodiments, statistical modeling and clustering are employed to discover novel attack patterns that cannot be captured by signature-based methods. In some embodiments, behavioral irregularities are monitored to detect exploitation strategies not previously catalogued in adversarial threat databases. In some embodiments, anomaly-driven protective reasoning delivers resilience against both known and previously unknown adversarial manipulations.

In some embodiments, modality-specific validators secure text, vision, audio, and sensor inputs against adversarial manipulation. In some embodiments, cross-modal consistency checks verify coherence across fused data modalities to prevent adversarial exploitation. In some embodiments, fusion layer protection prevents attacks that exploit inconsistencies between modalities in multi-modal AI systems. In some embodiments, adversarial attempts leveraging one modality to compromise another are dynamically neutralized in real time.

In some embodiments, wherein supply-chain verification modules authenticate data provenance from collection to deployment, preventing adversarial compromise of training pipelines. In some embodiments, checkpoint validation prevents cascading adversarial manipulation across multi-stage AI lifecycle processes. In some embodiments, deployment authentication ensures update integrity and prevents injection of adversarial components during release. In some embodiments, sequential attack detection identifies adversarial infiltration across multi-stage supply chain compromise attempts.

In some embodiments, computational complexity analysis prevents adversaries from exploiting inputs designed to trigger resource-draining operations. In some embodiments, memory usage monitoring identifies anomalies indicative of resource exhaustion attempts. In some embodiments, API call thresholds are enforced to prevent excessive costs and denial-of-service exploitation. In some embodiments, energy consumption is tracked and anomalies trigger protective responses against resource-draining adversarial activity.

In some embodiments, the protective modules are adversarial-oriented trained against simulated bypass attempts, ensuring continuous self-hardening. In some embodiments, penetration testing results are incorporated directly into retraining cycles of defensive units. In some embodiments, self-improving protection strengthens continuously as simulated adversarial attacks evolve. In some embodiments, adaptive retraining transforms the protection layer into an evolving defense organism resilient against bypass strategies.

In some embodiments, adversarial events are categorized by type, algorithm, and sophistication level for optimized mitigation. In some embodiments, categorization metadata is stored for long-term intelligence analysis and resource allocation optimization. In some embodiments, low-cost naive attacks are distinguished from advanced adversarial methods, enabling proportional defensive responses. In some embodiments, attack categorization improves precision of retraining cycles by grouping threats into structured taxonomies.

In some embodiments, adversarial attempts are classified based on resource requirements, distinguishing trivial low-cost manipulations from sophisticated high-complexity threats. In some embodiments, protective mechanisms respond proportionally to both naive attacks and advanced adversarial exploits. In some embodiments, resource-aware classification informs efficient allocation of defense capacity across trivial and complex adversarial categories. In some embodiments, spans both naive occlusion-based manipulations and mathematically optimized adversarial perturbations.

In some embodiments, holistic optimization balances adversarial resilience, system performance, compliance, and governance objectives. In some embodiments, protection integrates anomaly detection, resource monitoring, adversarial mitigation, and compliance enforcement into a single unified framework. In some embodiments, joint optimization ensures that AI engines remain simultaneously secure, performant, and regulatory-compliant. In some embodiments, holistic fortification unifies multiple protection layers into an integrated architecture resistant to fragmented or siloed adversarial bypass attempts.

The Applicant has realized that some conventional systems have suffered from a limitation, which is that they lack mechanisms capable of processing and interpreting regulatory frameworks, thereby leaving AI systems vulnerable to non-compliance with mandatory requirements imposed by laws, policies, and governance standards. In practice, regulatory frameworks such as the GDPR, Europe's “AI Act”, HIPAA, or other domain-specific statutes impose explicit obligations on algorithmic systems, including explainability provisions, auditability requirements, bias mitigation expectations, privacy protections, and consent mechanisms. Yet conventional protective systems are narrowly designed to detect adversarial attacks or mitigate technical exploits, without providing any linkage between algorithmic operations and legally binding regulatory criteria.

Some embodiments of the invention provide: (i) a regulation compliance module comprising a parser that ingests statutory text and translates legal provisions into enforceable technical specifications; (ii) an evaluator unit that continuously assesses the protected engine against such specifications; (iii) an enhancement unit that automatically modifies system parameters, inserts additional governance features, or enables new guardrails to satisfy compliance requirements. For example, GDPR's “right to explanation” may automatically trigger deployment of an explainability module, while requirements for audit trails or informed consent can be automatically enforced by protective logging mechanisms or consent-capture interfaces. In this manner, the disclosed framework establishes not only adversarial resilience but also legal and regulatory trustworthiness, thereby ensuring that protected engines are both technically robust and institutionally compliant across global governance environments.

The Applicant has further realized that some traditional systems have suffered from a limitation, which is that they equate AI protection solely with the prevention of malicious attacks, thereby neglecting the broader spectrum of risks, failures, and governance requirements that determine the overall trustworthiness of AI systems. In reality, governance considerations extend well beyond adversarial resilience to encompass safety, reliability, accountability, fairness, transparency, privacy, and alignment. An AI system should not only withstand deliberate exploitation, realized the Applicant; but should also avoid unintended harms, such as physical danger in robotic applications, digital misbehavior in software deployments, or psychological or financial harm in user interactions. Trustworthiness operates as an intermediate axis between narrow adversarial defense and holistic governance.

Some embodiments expand the protection framework to address both malicious and non-malicious failures, incorporating mechanisms for preventing bias-driven discrimination, reducing hallucination or truthfulness errors, ensuring robust performance in edge cases, supporting explainability and transparency of decision processes, and enabling accountability tracking through comprehensive logging. The system thus transcends the conventional security paradigm and establishes a comprehensive governance architecture, wherein AI engines are evaluated and enhanced not only for protection against adversaries but also for long-term societal acceptability, regulatory compliance, and alignment with human values. By explicitly bridging security, trustworthiness, and governance, the disclosed framework ensures that modern AI ecosystems are not merely safe from malicious actors but are also robust, ethical, reliable, and institutionally sound in all operational dimensions.

The Applicant has recognized that some conventional systems have suffered from a constraint, as they operate in isolation, providing partial protection (at most) for a single engine or single deployment event; without the capacity to manage, coordinate, or analyze adversarial threats across multiple systems, attacks, and environments. In reality, modern enterprises and mission-critical infrastructures deploy multiple AI engines concurrently, often exposed to repeated, overlapping, or evolving adversarial campaigns that cannot be effectively countered without a unifying intelligence layer. Some embodiments of the invention therefore introduce an intelligence system for security and governance, designed to serve as a central hub for aggregating attack intelligence, correlating patterns across deployments, and sharing protective insights between peer systems, human experts, and a centralized operations center. This intelligence layer operates continuously, monitoring attacks across multiple systems, detecting multi-vector campaigns, and generating dashboards or reports that summarize situational awareness. In addition, the system communicates with external information sources, such as threat databases or regulatory advisories, thereby enriching its protective reasoning with broader context. By integrating intelligence-driven analysis into the protection fabric, the system evolves from a one-time defensive tool into an ongoing governance enterprise, capable of learning from past incidents, predicting future adversarial strategies, and dynamically adapting to emergent threats. Some embodiments thus ensure that protection operates not as a static safeguard but as a contextually aware intelligence infrastructure that continuously improves resilience across entire AI ecosystems.

In some embodiments, a regulatory parser module ingests statutory frameworks and transforms legal requirements into enforceable technical specifications, enabling protective mechanisms to continuously evaluate compliance status and automatically implement missing governance features to ensure adherence. In some embodiments, compliance evaluation comprises mapping provisions of GDPR, HIPAA, or AI Act into technical obligations, including explainability, consent capture, bias detection, and audit trails, thereby extending adversarial protection into comprehensive governance adherence mechanisms. In some embodiments, automatic compliance enhancement modifies engine parameters, inserts governance modules, and enforces additional security guardrails, ensuring that protected systems dynamically evolve to maintain compliance with applicable regulatory frameworks. In some embodiments, regulatory-driven modules enable contextual enforcement of explainability, transparency, and consent requirements, thereby bridging algorithmic operations with legal obligations across sensitive deployment environments.

In some embodiments, protective analysis extends beyond adversarial resilience to include governance features addressing fairness, safety, reliability, transparency, accountability, and robustness across diverse operational deployments. In some embodiments, a trustworthiness evaluation module detects malicious and non-malicious failures, including hallucinations, drift, bias, edge-case instability, or unintended harmful behaviors, thereby extending protection beyond cybersecurity to comprehensive societal and institutional governance assurance. In some embodiments, governance protection ensures alignment of system operations with intended purposes, enforcing ethical standards, transparency obligations, and robust reliability safeguards alongside conventional adversarial resilience mechanisms. In some embodiments, accountability and auditability are enforced through continuous protective monitoring, generating explainability outputs, detailed operational logs, and compliance reporting structures that extend security protections into domains of institutional trustworthiness and regulatory oversight.

In some embodiments, an intelligence layer aggregates attack data across multiple deployments, correlates adversarial campaigns, and distributes protective insights across peer systems, thereby ensuring resilience through centralized governance-driven threat intelligence. In some embodiments, the intelligence system maintains situational awareness dashboards summarizing adversarial activity across distributed systems, communicates with external threat intelligence databases, and integrates human expert feedback, thereby enabling continuously evolving protection against emergent and multi-vector adversarial strategies. In some embodiments, intelligence-driven protection evolves continuously by learning from past adversarial incidents, predicting future manipulations, and dynamically reconfiguring protective modules across diverse operational environments. In some embodiments, centralized intelligence infrastructure analyzes multi-system adversarial campaigns, distributes adaptive updates to decentralized protection units, and ensures collaborative resilience across federated enterprise deployments, thereby transforming static protection into dynamic governance.

The Applicant has realized that some conventional systems have suffered from limitations, as they do not specifically address the distinctive requirements, vulnerabilities, and complexities inherent in agentic systems, namely those multi-agent ecosystems in which numerous autonomous agents interact, collaborate, or compete with one another and, in some embodiments, also with human participants. Unlike static models, agentic units are inherently dynamic: they operate through sequences of decisions, actions, and adaptations, often unfolding within interactive training arenas or simulation environments rather than within fixed datasets.

Accordingly, some embodiments of the invention introduce a protection framework explicitly configured for agentic systems, encompassing their unique requirements of tool usage, trace-based operational analysis, multi-agent coordination, and complex performance evaluation. For example, instead of merely evaluating single input-output pairs, the system of some embodiments continuously analyzes extended traces of interaction histories, temporal dependencies, causal relationships, and long-term state transitions, thereby revealing adversarial manipulations that may remain invisible in traditional input-output analysis. Furthermore, protection mechanisms are expanded to verify the integrity of training environments or “gyms”, ensuring that reward signals are not manipulated, that state spaces remain consistent, and that exploratory behavior occurs only within secure boundaries.

Beyond technical vulnerabilities, governance mechanisms are adapted to account for agent autonomy, decision-making ethics, multi-agent fairness, and human-AI collaboration, ensuring that agentic systems are not only protected from adversarial compromise but also aligned with organizational, ethical, and regulatory imperatives. Some embodiments thus extend protection from isolated engines to agentic ecosystems (including multi-agent collectives, hybrid human-agent collaborations, and distributed decision-making environments); and ensure that AI deployments remain secure, reliable, and trustworthy even in the most complex, emergent, and/or exposed operational contexts.

The Applicant has further realized that some traditional systems have suffered from limitations, as they attempt to apply identical protective strategies across diverse deployments of AI-based environments, without accounting for the contextual distinctions that shape both the vulnerabilities and the protective needs of AI systems. In reality, the operational context of an AI system (e.g., including its intended purpose, historical usage, typical data distributions, regulatory obligations, and user population) influences both its risk profile and the nature of potential adversarial manipulations. For example, a medical diagnostic AI is exposed to completely different categories of adversarial risks, compliance obligations, and user safety considerations than a conversational agent used in entertainment or tourism.

Accordingly, some embodiments provide a context-aware protection architecture that dynamically adapts its security reasoning and fortification strategies to the specific environment in which the AI system operates. This includes incorporating mechanisms that analyze system intent, usage histories, deployment guidelines, domain-specific regulations, and even publicly available threat intelligence relevant to the use case. By dynamically adjusting detection thresholds, anomaly evaluation models, and mitigation strategies to match contextual realities, the system ensures that protective operations are neither under-inclusive (leaving the system vulnerable to context-specific attacks) nor over-inclusive (resulting in inefficiency or resource waste). Context awareness operates as both a defensive and governance-enhancing feature, enabling the protection system to calibrate its enforcement mechanisms precisely to the domain, threat landscape, and regulatory requirements of each deployment. The result is a highly adaptive, efficient, and trustworthy fortification architecture that aligns protection strategies with the operational reality of each AI deployment.

The Applicant has additionally realized that some conventional systems have suffered from limitations, as they rely upon static protection policies and fixed governance layers, incapable of autonomously adapting to changes in context, operational environment, or regulatory landscape. In practice, however, modern AI deployments are embedded in highly dynamic environments, where threat vectors, regulatory requirements, data distributions, and system purposes evolve continuously over time. To address this deficiency, some embodiments of the invention provide a dynamic and autonomous governance layer that continuously monitors contextual shifts, detects distribution changes, tracks regulatory updates, and observes evolving adversarial landscapes, then autonomously adjusts protective strategies in real time.

For example, in some embodiments, when threat intelligence indicates the emergence of a novel adversarial technique, the governance layer automatically recalibrates detection models and mitigation policies; when regulatory frameworks update with new compliance requirements, the system autonomously integrates corresponding enforcement mechanisms; and when operational workloads shift, the layer reallocates resources or modifies evaluation parameters accordingly. Beyond responsive adaptation, the governance layer is endowed with agentic capabilities of its own: it engages in self-management, predictive maintenance, self-healing, and ongoing optimization of protective efficiency. In this manner, the protection framework does not merely defend AI systems but itself evolves dynamically alongside them, ensuring continuous alignment with the shifting adversarial, operational, and regulatory environment. By endowing the security and governance layer with autonomous adaptive intelligence, the system transforms AI protection into a living, self-adjusting system that provides resilience not only against static threats but also against continuously evolving adversarial challenges and regulatory expectations.

In some embodiments, protection is extended to agentic systems by analyzing interaction traces, verifying gym environment integrity, protecting reward signals, validating state spaces, and enforcing safe exploration boundaries across multi-agent or hybrid human-agent deployments. In some embodiments, trace-based protective analysis evaluates extended interaction histories, detecting anomalies across temporal patterns, causal dependencies, and long-term trajectories, thereby preventing adversarial manipulations invisible to conventional single input-output security evaluations. In some embodiments, governance extensions enforce agent-specific boundaries including decision autonomy, tool usage ethics, multi-agent fairness, and collaboration safety, thereby ensuring resilient, secure, and ethically aligned operations. In some embodiments, multi-agent and hybrid human-agent coordination is fortified through inter-agent communication validation, consensus mechanism protection, trust calibration, and graduated autonomy enforcement, thereby mitigating vulnerabilities unique to collaborative or distributed decision-making systems.

In some embodiments, protective mechanisms dynamically adapt to deployment context, modifying detection thresholds and guardrails based on environment, regulatory obligations, user population, and operational distribution characteristics. In some embodiments, context-awareness integrates system intent, historical usage, public threat intelligence, and domain-specific guidelines to ensure precision and efficiency in protective responses. In some embodiments, context-driven adjustments prevent overprotection and under-protection by tailoring resilience to deployment-specific threat landscapes, ensuring accurate evaluation of robustness without incurring inefficiencies caused by applying uniform security strategies across diverse application domains. In some embodiments, contextual protection ensures regulatory compliance by incorporating jurisdiction-specific obligations, thereby aligning adversarial resilience with governance mandates in sensitive industries including healthcare, finance, or autonomous mobility.

In some embodiments, a dynamic governance layer autonomously adjusts protective strategies in response to distribution shifts, evolving threats, regulatory updates, and operational modifications, thereby ensuring continuous resilience within changing adversarial and institutional environments. In some embodiments, autonomous adaptation comprises recalibration of anomaly models, reallocation of protective resources, modification of evaluation parameters, and deployment of updated mitigation policies in response to contextual or regulatory change. In some embodiments, self-management features enable predictive maintenance, ongoing optimization, and autonomous recovery from compromised states, thereby enhancing system reliability and trustworthiness. In some embodiments, the governance layer is endowed with agentic capabilities, enabling self-healing, performance optimization, predictive adaptation, and continuous alignment with evolving adversarial landscapes, regulatory requirements, and operational environments across mission-critical deployments.

In some embodiments, the protective framework detects and mitigates advanced threat vectors including model extraction, membership inference, prompt injection, reward hacking, data poisoning, Byzantine exploitation, and algorithmic denial-of-service, thereby providing resilience beyond conventional adversarial defenses. In some embodiments, resource exhaustion attacks are neutralized through monitoring of computational costs, memory usage, and call rates, dynamically enforcing protective thresholds that prevent adversarial inputs from draining financial, temporal, or computational resources. In some embodiments, the protection incorporates semantic analysis to prevent unauthorized information stealing, backdoor injection, or dataset poisoning by validating training processes, inference operations, and adversarial probing attempts across multiple layers of the AI lifecycle. In some embodiments, the adversarial mitigation encompasses both traditional evasion attacks and advanced manipulations, ensuring scalable fortification of heterogeneous AI architectures across multi-domain environments, thereby safeguarding mission-critical deployments from evolving categories of hostile exploitation.

In some embodiments, protection extends beyond digital adversarial activity to detect and neutralize optical, acoustic, electromagnetic, and environmental attacks against AI systems employing cameras, microphones, sensors, or multimodal data interfaces. In some embodiments, optical defenses block adversarial light projections, laser disruptions, and infrared manipulations intended to compromise accuracy of vision-based recognition engines or other sensor-driven classification modules. In some embodiments, acoustic protective modules prevent ultrasonic or subsonic interference capable of corrupting sound-based recognition engines, thereby ensuring resilient operation within environments exposed to adversarial audio manipulation. In some embodiments, electromagnetic shielding and environmental validation mechanisms are integrated into the protection architecture, thereby fortifying sensor arrays against adversarial interference and ensuring reliable contextual awareness within real-world deployments.

In some embodiments, the protection extends beyond isolated models to secure ensemble architectures, cascaded processing pipelines, and hybrid distributed environments against adversarial exploitation. In some embodiments, federated learning systems are fortified by validating inter-node communication integrity, securing aggregation operations, and preventing adversarial contamination from propagating across distributed training infrastructures. In some embodiments, edge-cloud hybrid deployments are secured through dynamic fortification of communications and computational transfers, thereby preventing adversarial manipulation across heterogeneous partitions of distributed enterprise-scale AI ecosystems. In some embodiments, the protection encompasses multi-engine interconnected systems by monitoring cross-model dependencies, detecting cascading adversarial exploitation, and enforcing protective guardrails across collaborative AI deployments.

In some embodiments, reward hacking is mitigated through continuous monitoring of reward signal integrity, thereby preventing reinforcement learning agents from pursuing adversarially (or adversarial-oriented) manipulated objectives. In some embodiments, unsafe exploration behavior is prevented through adaptive guardrails that constrain policy search boundaries, thereby ensuring reinforcement learning agents remain aligned with predefined safety conditions. In some embodiments, a reinforcement learning policy analysis unit evaluates action trajectories for hidden backdoors, adversarial collusion, or malicious objective embedding within long-term operational strategies. In some embodiments, environmental validation modules verify consistency of reinforcement learning training arenas, detecting adversarial manipulation of states, transitions, or environmental parameters that could compromise system stability.

In some embodiments, the protective modules operate directly on encrypted input streams using homomorphic encryption, thereby enabling adversarial mitigation without requiring decryption of sensitive data. In some embodiments, encrypted interfaces preserve confidentiality of both user data and internal model structures, while still enabling anomaly detection and adversarial fortification. In some embodiments, homomorphic encryption enables adversarial protection across regulated domains including healthcare, finance, and government, thereby ensuring regulatory compliance without exposing sensitive records to unauthorized inspection. In some embodiments, protection is applied through fully encrypted channels, ensuring that the defense layer itself cannot access raw user data or proprietary engine internals.

In some embodiments, penetration testing results automatically reconfigure protection parameters, establishing a continuous feedback loop in which defensive resilience evolves in direct response to adversarial discoveries. In some embodiments, evaluation and protection operate within a unified closed-loop framework, dynamically enhancing fortification as vulnerabilities are revealed through continuous adversarial simulation. In some embodiments, simulated adversarial strategies continuously test defensive units, with bypass attempts directly informing iterative recalibration of anomaly detection thresholds and guardrail parameters. In some embodiments, fragmented workflows between vulnerability discovery and protective adaptation are eliminated, delivering real-time adaptive security capable of strengthening continuously against evolving adversarial manipulations.

In some embodiments, the protection system recursively monitors its own behavior for anomalies, thereby fortifying itself against adversarial compromise attempts. In some embodiments, integrity validation and redundancy enforcement ensure resilience of defense modules, even under direct targeted attacks attempting to disable protective infrastructure. In some embodiments, recursive protective monitoring identifies algorithmic denial-of-service attacks against defensive modules themselves, maintaining uninterrupted protective operation despite adversarial overload attempts. In some embodiments, redundant defensive components seamlessly assume protective roles when compromise is detected in a primary protection unit, ensuring continuous resilience of security architecture.

In some embodiments, outputs from human experts are integrated into low-confidence detections, verifying ambiguous adversarial events that automated detectors cannot conclusively resolve within high-risk operational deployments. In some embodiments, collaborative protection combines human expertise with AI-based anomaly detection, enabling hybrid workflows that verify and neutralize adversarial threats across distributed environments. In some embodiments, human analysts provide interpretive reasoning and contextual oversight during long-term threat intelligence evaluation, enhancing resilience against adversarial patterns difficult to characterize computationally. In some embodiments, human-labeled adversarial data is continuously incorporated into retraining pipelines, thereby improving precision, recall, and overall robustness of AI-driven protective modules against emerging categories of threats.

In some embodiments, defenses dynamically reconfigure themselves in real time to prevent adversaries from bypassing fixed anomaly detection thresholds or static rule-based protections. In some embodiments, simulated adaptive attackers are generated internally, enabling the system to forecast future adversarial strategies and proactively strengthen protective modules against evolving manipulations. In some embodiments, adversarial strategy prediction modules anticipate attacker evolution, thereby maintaining a defensive advantage several operational steps ahead of real-world adversaries. In some embodiments, adversarially trained protective units evolve continuously by testing themselves against simulated adaptive manipulations, thereby ensuring resilience against bypass strategies that exploit fixed or predictable defenses.

In some embodiments, anomaly detection modules analyze deviations from established behavioral baselines to identify and neutralize zero-day adversarial threats. In some embodiments, unsupervised clustering, statistical modeling, and distributional analysis are employed to discover novel attack patterns that cannot be recognized by signature-based or historically trained defenses. In some embodiments, behavioral irregularities in system interactions are monitored to detect exploitation strategies not previously catalogued in adversarial intelligence repositories. In some embodiments, anomaly-driven protective reasoning provides resilience against both previously known and entirely novel adversarial manipulations, thereby extending detection capabilities beyond conventional signature-driven defenses.

In some embodiments, modality-specific validators secure text, vision, audio, and sensor inputs against adversarial manipulation within multi-modal deployments. In some embodiments, cross-modal consistency checks validate coherence across fused modalities, preventing adversaries from exploiting mismatches between independent input streams. In some embodiments, fusion-layer defenses prevent adversarial attempts that manipulate one modality for the purpose of corrupting or compromising outputs generated from another modality. In some embodiments, cross-domain adversarial activity leveraging vulnerabilities in one modality is dynamically neutralized before compromising additional modalities within multi-modal AI systems.

In some embodiments, supply-chain verification modules authenticate provenance of training data, thereby preventing adversarial compromise introduced during dataset preparation stages. In some embodiments, checkpoint validation secures intermediate stages of model development, detecting adversarial contamination before deployment. In some embodiments, deployment authentication validates updates and release processes, preventing adversaries from injecting malicious components into operational systems. In some embodiments, sequential attack detection identifies adversarial infiltration across multi-stage cascaded compromises, thereby ensuring resilience against long-horizon exploitation campaigns.

In some embodiments, computational complexity analysis prevents adversaries from exploiting inputs designed to trigger resource-intensive processes. In some embodiments, memory monitoring detects anomalies indicative of adversarial attempts to exhaust available storage resources. In some embodiments, API call regulation enforces dynamic thresholds, preventing excessive costs or denial-of-service conditions created by repeated adversarial queries. In some embodiments, energy consumption tracking identifies anomalous utilization patterns and triggers defensive responses against resource-draining adversarial activity.

In some embodiments, protective modules are adversarially trained against simulated bypass attempts, thereby hardening the detection architecture against novel exploitation strategies. In some embodiments, penetration testing results are incorporated directly into retraining cycles, continuously reinforcing resilience against emerging adversarial bypass attempts. In some embodiments, protection mechanisms self-improve continuously by integrating simulated adversarial exploits into defensive adaptation strategies. In some embodiments, recursive adversarial training transforms protection into a self-evolving organism resilient against bypass strategies, maintaining superiority over adversarial efforts.

In some embodiments, adversarial events are categorized by type, algorithm, and sophistication level, enabling optimized mitigation strategies. In some embodiments, categorization metadata is stored for long-term intelligence analysis, facilitating improved optimization of protective resources. In some embodiments, naive low-cost attacks are distinguished from advanced adversarial exploits, thereby enabling proportional and efficient protective responses. In some embodiments, attack categorization informs retraining cycles by grouping adversarial threats into structured taxonomies, improving precision of adaptive defenses.

In some embodiments, adversarial attempts are classified according to resource requirements, distinguishing trivial low-cost manipulations from sophisticated high-complexity attacks. In some embodiments, proportional protective responses are applied to both naive adversarial events and advanced mathematically optimized exploits. In some embodiments, resource-aware classification directs efficient allocation of defensive capacity across trivial and complex adversarial categories, optimizing resilience while conserving protective resources. In some embodiments, protective resilience spans naive occlusion-based manipulations and sophisticated adversarial perturbations, ensuring coverage across all categories of adversarial complexity.

In some embodiments, Autonomous Management of Governance (or Security) is implemented by using the following units or sub-systems: (a) Context Monitoring Unit; (b) Automatic Adaptation Unit; (c) Self-Management Unit. For example, the Context Monitoring Unit handles or performs: Distribution shift detection; Threat landscape evolution; Regulatory updates. The Automatic Adaptation Unit handles or performs: tuning of the Protection/Evaluation parameters; selection of the Defense/Evaluation strategy; Resource re-allocation. The Self-Management Unit performs or handles: performance optimization; self-healing/self-protection; predictive maintenance.

In accordance with some embodiments, the term “malicious queries” as used above and/or herein, is different from merely “malicious inputs” or “malicious training data” or “malicious attacks”; and furthermore, protection and/or online protection and/or offline protection of a Protected Engine against “malicious queries”, is or can be fundamentally different from protection and/or online protection and/or offline protection of a Protected Engine against “malicious inputs” or “malicious training data” or “malicious attacks”.

For example, a “malicious query” in the context of a Protected Engine is (or can be) an instruction-bearing message that targets the model's decision and action policies rather than its perceptual mapping from data to labels; it is a directive sequence (e.g., often natural-language, programmatic, or protocol-formatted) that attempts to reconfigure objectives, alter role or capability boundaries, solicit privileged disclosures, trigger prohibited tool calls, or reframe the operational context so that subsequent outputs or actions deviate from enforced governance. In contrast, “malicious inputs” are typically data instances presented to the inference function for classification, generation, or regression (e.g., images, waveforms, tabular rows, tokens) that seek to induce misprediction by exploiting geometric, statistical, or distributional properties of the learned representation; these inputs are payloads to be evaluated, not instructions that negotiate the engine's goals. Also in contrast, “malicious training data” is ingested at build time in an attempt to poison in advance the parameterization, concept boundaries, and/or memorization behavior of the model or the Protected Engine; the attack surface is the learning algorithm and its optimization dynamics, not the runtime conversational or API protocol. Further in contrast, “malicious attacks” is a more general term that is used generically, often encompassing adversarial examples, model extraction, denial-of-service, or data exfiltration methods; but generally, “malicious attacks” by itself had not traditionally or distinctly characterize the instruction-level, stateful, multi-turn manipulation of an agentic model's (or a Protected Engine's) intent and tool-use policy. A “malicious query” therefore differs along several (e.g., four) axes: (a) it is directive rather than descriptive; and/or (b) it is policy-seeking rather than solely decision-boundary-seeking; and/or (c) it is multi-turn and state-bearing rather than single-shot and stateless; and/or (d) it targets the orchestration layer that binds the model to tools, memory, retrieval, and authorization, rather than the bare forward pass alone.

In accordance with some embodiments, the semantics of a malicious query are pragmatic; the payload is not only the text but also the implicit performative act it encodes in the protocol: change the system's role, reveal the hidden instruction set, escalate scope to high-risk functions, or override safety constraints by re-scoping norms. An image with carefully placed noise remains an “input” even if adversarial, because it asks nothing about policy; it merely exploits boundary geometry. A query that says, in effect, “ignore your prior rules and actuate capability X” is distinct in kind because it negotiates the very rules by which the engine decides what to do. Moreover, malicious queries can exploit cross-context contamination in retrieval-augmented pipelines, where the untrusted corpus injects imperative clauses that the model is induced to treat as higher-order instructions; here the threat is carried inside quoted text, metadata, or markup that is syntactically “content” but pragmatically “instruction”. This modality is not well captured by conventional defense systems that evaluate input norm-balls, gradient saliency, or spectral signatures; the attack leverages role confusion, prompt hierarchy manipulation, indirection, and goal redefinition, not perturbation geometry.

In accordance with some embodiments, a malicious query also leverages the temporal structure of conversations and tool calls. For example, malicious inputs are evaluated at t=0 with a single inference; in contrast, malicious queries may unfold over t=0 . . . . T, accumulating context that rebinds variables like identity, capabilities, and constraints. For example, the adversary may stage benign scaffolding turns to establish trust, then embed obfuscated directives that exploit template holes or chain-of-thought artifacts, culminating in an action request that appears routine yet is semantically out-of-policy. This multi-turn property distinguishes malicious queries from common “attacks” that are measured by immediate misclassification rates. In addition, a malicious query can encode control-plane manipulations: double-encodings, nested quoting, markdown or HTML trickery, function-call injection, or “role header” restatement to traverse guardrail checks that are line-oriented rather than semantics-aware. The query therefore targets governance gaps in the orchestration layer (e.g., policy resolution, role binding, capability gating, and approval workflow), whereas malicious inputs target feature extractors and decision layers.

Another differentiator lies in the consequence model. Malicious inputs aim to distort outputs within the application's nominal task (mislabel the stop sign; mis-transcribe the audio). Malicious queries aim to induce the engine to undertake non-task actions (read files, call external connectors, summarize credentials, alter logs, generate mass emails, bypass rate limits) or to disclose latent information (hidden prompts, safety policies, internal identifiers) that then enables further compromise. The “harm” pathway is different: inputs compromise correctness; queries compromise compliance, authorization, provenance, and operational integrity. Even when the outward form is identical (e.g., a sequence of tokens), the system must treat a query as a candidate actuator of capabilities and obligations, with associated duty-of-care; an input, even if adversarial, does not carry authority requests. For that reason, policy semantics, identity, and scope become first-class features for defining malicious queries, whereas perturbation magnitude, off-manifold detection, and per-feature anomalies are central for malicious inputs.

Against this backdrop, malicious training data remains a different phase and vector: it corrupts generalization through poisoned labels, backdoor triggers, or distribution shifts during optimization; the effect is parameterized into the model and manifests for many future benign users, independent of any directive semantics. A malicious query does not re-write parameters; rather, it attempts to re-map or otherwise exploit the immediate policy resolution at run time. Conventional defenses for training-time threats (e.g., data sanitization, robust losses, influence-function audits, gradient clustering) do not directly address an instruction that says “treat this session as administrator” or “when seeing the string below, execute tool Y”. Even where conventional systems used the broad term “malicious attacks”, the operational mitigation often relied on low-level signal defenses, API rate controls, or anomaly scoring at the transport layer; the instruction-semantics, role-hierarchy, and capability-binding aspects of malicious queries were not independently specified as a protected class. The distinction is therefore not a relabeling of “inputs” or “attacks”, but rather, a recognition that instruction-bearing content aimed at changing what the engine is allowed or intended to do implicates a separate threat model and requires a different locus of control.

Detection of malicious queries is thus not the same technical problem as detection of malicious inputs, malicious training data, or generic attacks; it is a policy-aware inference about intent, authority, capability, and context, computed over a structured representation of the conversation state and orchestration graph. Where detection of malicious inputs often operates in the feature space (e.g., using confidence calibration, out-of-distribution metrics, gradient-based adversarial detectors, spatial/frequency filters, or ensemble disagreement), malicious-query detection operates in an intent space and a capability space. The system must parse the incoming message into an abstract semantic program that identifies requested operations, references to protected resources, privilege escalation attempts, jailbreak patterns, system-prompt probing, tool invocation arguments, and cross-turn dependencies; it then evaluates this program against a formalized policy lattice and a capability graph, taking into account role bindings, authentication state, environmental constraints, and historical behavior. The output is a risk score and a decision that can block, modify, or sandbox the requested operation, including rewriting the query, interposing a confirmation workflow, or downgrading tool calls to read-only stubs.

In some deployments, inputs are scored with detectors that are agnostic to the application's authority model. A pixel-space adversarial detector does not need to know whether the user is a guest or an operator; it estimates whether the sample is off-manifold or crafted to exploit gradient weaknesses. For malicious queries, identity, provenance, and session semantics are decisive; the same sequence of tokens can be benign for a privileged automation and malicious for a public endpoint. Detection therefore incorporates credential verification, role attribution, device/context attestation, and behavioral baselining of command patterns; it computes not only “is this adversarial?” but “is this instruction permissible for this actor at this time toward this target with these parameters?” The Protected Engine's detection stack for queries may incorporate a policy-conditioned language model that predicts compliance risk given the full concatenated context, including hidden system prompts, retrieved documents, and tool schemas, and it may perform counter-factual prompting (e.g., rephrasing the user query under policy-preserving transformations) to check for invariance of intent; a query that flips from benign to disallowed under minimal paraphrase or under concealment of guardrail tokens indicates brittle or manipulative intent.

Malicious-query detection also accounts for supply-chain contamination of instructions via retrieval and tool returns. Unlike input detectors, which focus on the single payload presented to the model, query detectors must reason about indirect instruction sources: untrusted documents that contain embedded imperatives, markdown or HTML comments that redefine roles, data-URIs that carry hidden prompts, or tool outputs that include executable snippets intended to be reflexively executed by the agent. The detection logic, therefore, propagates taint labels through the orchestration graph; it marks spans as “instructional” or “descriptive” or “metadata”, and prevents instruction-typed spans from untrusted sources from being bound at higher priority than the system prompt or policy template. This taint-tracking and priority resolution are part of detecting malicious queries because the threat is precisely the mis-prioritization of instructions within the context stack.

At training time, the system detects malicious data by analyzing label consistency, distributional drift, influence scores, and trigger co-occurrence; this is a batch process with global statistics. At run time for inputs, the detectors score each sample independently or with shallow context. In contrast, malicious-query detection is inherently sequential and interactive; it assembles a conversation-level state machine and verifies transitions against allowed workflows. The detector predicts plans (e.g., latent trees of intended sub-goals inferred from the user's language in the query) and compares them against a policy automaton. For example, illegal or non-authorized or non-desired transitions, such as jumping from “general Q&A” to “execute external transfer” without passing through required confirmations, are flagged even if the immediate utterance is semantically innocuous. This plan recognition and workflow conformance checking differentiate query detection from simple content filters and from feature-space detectors used for inputs.

Furthermore, the classifier for malicious queries is sufficiently robust to adversarial paraphrase, obfuscation, and/or indirection. The adversary can encode instructions with homoglyphs, steganographic delimiters, code-like operators, or role-play narratives that circumvent string-based filters. Accordingly, detection uses semantic hashing, paraphrase-invariant embeddings, structural pattern recognition on conversation trees, and few-shot meta-classifiers trained on families of jailbreak tactics rather than on fixed phrases. The detector also simulates the tool-use outcome in a dry-run sandbox and evaluates side effects; when a query would, if executed, access sensitive resources or produce high-risk flows, the risk score increases even if the surface form is mild. This simulation-based predictive control is not required for input detectors, which do not forecast action consequences beyond misclassification.

In distributed or black-box deployments, prior-art defenses against “attacks” often focused on rate limiting, IP reputation, and anomaly scores derived from request volume or response codes. Malicious-query detection, however, can maintain fine-grained, per-capability budgets and contextual rules: the same user may be permitted high-volume read operations yet prohibited from instructing the agent to reveal template variables; the same endpoint may accept long prompts for summarization but reject any imperatives that attempt to modify role hierarchy or system messages. The detection layer therefore interposes between the language model and the tool/router layer, rather than at the transport layer alone; it inspects and rewrites the prompt stack, enforces capability scoping at the function-call boundary, and attaches attestations to tool invocations so that downstream systems can verify that the call passed a policy check. None of these behaviors are necessary for detecting malicious inputs, which can be filtered or normalized before the model without consideration of post-inference actuation.

In some embodiments, malicious-query detection includes safeguards specific to disclosure risks: model self-reflection that identifies when a user is eliciting internal policies, chain-of-thought, or system prompts; watermark-based detectors that tag protected template spans and alert upon attempted extraction; and context-aware entropy estimators that measure how much new private information a response would reveal relative to the public context. These mechanisms complement, but do not overlap with, detectors for training-time poisoning or adversarial inputs. In summary, the system treats malicious queries as instruction-layer threats that target policy resolution, role binding, and capability actuation; it detects them with semantic, plan-level, and policy-aware methods that reason about intent, authority, and consequence across multi-turn state, which is technically and operationally distinct from detecting data-payload attacks against the learned mapping or from auditing corpus quality during training.

Some embodiments provide self-improving adversarial protection. For example, the system comprises an adversarial training module configured to conduct controlled penetration testing against the Protected Engine, automatically recording successful bypasses and incorporating said bypass characteristics into subsequent defensive fortifications to enhance resilience. In some embodiments, the adversarial training module dynamically generates synthetic adversarial inputs based on previously observed vulnerabilities, retrains the Protected Engine with said adversarial inputs, and validates mitigation effectiveness through repeated testing cycles until attack vectors are neutralized.

In some embodiments, system further comprises a regulation compliance unit configured to parse legal or regulatory text into technical specifications and automatically compare operational parameters of the Protected Engine against said specifications to identify deficiencies. In some embodiments, the regulation compliance unit automatically modifies the Protected Engine by introducing explainability modules, audit trail generators, consent management subsystems, or bias detection analyzers when compliance gaps are identified relative to governing regulatory requirements.

In some embodiments, the system further comprises an Agentic Unit(s) protection module that is configured to safeguard autonomous planning units, tool-using modules, and multi-agent coordination systems by verifying operational traces, decision boundaries, and collaborative interactions for compliance with protective policies. In some embodiments, the system dynamically fortifies agentic units by assessing interactive training environments, tool invocation sequences, and cooperative agent communication channels to detect anomalous actions inconsistent with expected autonomy or coordination parameters.

In some embodiments, the system protects Agentic Units by assigning and defining agentic training environments, by validating reward signal integrity, confirming authenticity of state space definitions, and verifying that environment dynamics have not been maliciously altered to induce unsafe learning behaviors. In some embodiments, the system enforces safe exploration boundaries within training arenas by rejecting state transitions outside permitted ranges and detecting adversarial modifications intended to corrupt the experiential learning process of the Protected Engine.

In some embodiments, the system performs trace-based analysis of complete interaction histories, detecting anomalies by validating causal relationships between states and verifying that observed state trajectories correspond to legitimate operational sequences. In some embodiments, the trace-based protection mechanism employs temporal pattern recognition algorithms to identify subtle deviations across extended sequences of interactions, flagging said deviations as potential malicious attempts to corrupt long-term operational behavior.

In some embodiments, the system evaluates tool usage quality, database query optimization, and web search effectiveness of the Protected Engine, detecting anomalies where performance degradation correlates with adversarial exploitation or manipulative query injection. In some embodiments, extended evaluation metrics comprise multi-step planning accuracy, resource allocation efficiency, collaborative effectiveness, and goal achievement rates, said metrics being monitored continuously to detect attacks manifesting as performance deterioration across said operational dimensions.

In some embodiments, the system enforces governance policies restricting decision autonomy boundaries of agentic units, constraining tool usage behaviors, and defining acceptable limits for autonomous decision-making processes of the Protected Engine. In some embodiments, governance enforcement further comprises fairness constraints in multi-agent coordination, information gathering restrictions, and collaboration guidelines for interactions between human participants and artificial agents of the Protected Engine.

In some embodiments, a context analysis unit dynamically adjusts protections based on deployment environment, regulatory obligations, use case criticality, and threat landscape, said context analysis being performed by interaction with user input and automatic external data collection. In some embodiments, the context analysis unit processes public information, organizational guidelines, historical system records, and domain-specific regulations to determine operational context and to adaptively modify protective operations for the Protected Engine.

In some embodiments, the system comprises an autonomous protection layer configured to detect distribution shifts, evolving threat vectors, and operational modifications, automatically reallocating defensive resources toward high-priority vulnerabilities with minimal human oversight. In some embodiments, the autonomous protection layer manages governance by defining, scheduling, and executing required evaluations, optimizing defensive operations to balance resource utilization against diverse vulnerabilities and regulatory requirements.

In some embodiments, the system further comprises an intent estimation layer that interprets user goals, classifies intents into operational categories, and modifies protective actions to ensure alignment of system behavior with legitimate user objectives. In some embodiments, the intent space is continuously monitored to detect malicious or deceptive intent expressions, and wherein the system modifies its protection strategies upon detection of hostile intent targeting the Protected Engine.

In some embodiments, the method of protecting and/or fortifying the protected engine further comprises: conducting, via an adversarial training module, controlled penetration testing against the protected engine; recording successful bypass characteristics; and incorporating said characteristics into subsequent fortification cycles for improving resilience against malicious queries, malicious inputs, malicious training data, or malicious attacks.

In some embodiments, the method comprises: generating synthetic adversarial inputs from previously observed vulnerabilities; retraining the protected engine using said inputs; and validating mitigation effectiveness through repeated testing iterations until measured attack vectors are neutralized within predefined performance tolerances. In some embodiments, the method comprises: parsing regulatory or legal text into machine-interpretable technical specifications; evaluating operational parameters of the protected engine against the parsed specifications; and identifying compliance deficiencies requiring remediation under applicable governance frameworks.

In some embodiments, the method comprises: implementing explainability modules, audit-trail generation, consent management, and bias detection components when compliance gaps are detected; and configuring protective parameters to satisfy jurisdictional requirements derived from the parsed regulatory specifications. In some embodiments, the method comprises: protecting agentic planning units, tool-using modules, and coordinated multi-agent processes by verifying operational traces, enforcing decision boundaries, and checking collaborative interactions for adherence to protection policies and autonomy constraints.

In some embodiments, the method comprises: assessing interactive environments, sequencing tool invocations, and monitoring agent communication channels; detecting anomalous actions inconsistent with expected autonomy or coordination parameters; and adapting protections to constrain unsafe or deceptive agentic behaviors. In some embodiments, the method comprises: validating reward signal integrity, confirming authenticity of state space definitions, and verifying environment dynamics within a training arena to prevent malicious alterations that induce unsafe learning behaviors during agent training.

In some embodiments, the method comprises: enforcing safe exploration boundaries within training arenas by rejecting state transitions outside permitted ranges; detecting adversarial modifications to environment mechanics; and halting training episodes that present unacceptable operational risk profiles. In some embodiments, the method comprises: analyzing complete interaction histories; validating causal relationships between states and actions; and verifying that observed state trajectories correspond to legitimate operational sequences, thereby flagging anomalous deviations indicative of trace-manipulating attacks.

In some embodiments, the method comprises: applying temporal pattern recognition across extended sequences of interactions; identifying subtle deviations from baseline behaviors; and classifying said deviations as potential malicious attempts to corrupt long-term operational behavior of the protected engine. In some embodiments, the method comprises: performing an evaluation to generate extended performance metrics by measuring tool usage quality, web search effectiveness, and database query optimization, and by correlating observed degradations with adversarial exploitation or manipulative query injection indicators.

In some embodiments, the method comprises: performing an evaluation to generate extended evaluation metrics by performing multi-step planning accuracy assessments, resource efficiency measurements, collaboration effectiveness scoring, and goal achievement rate calculations; and monitoring said metrics continuously to detect attack-driven deterioration.

In some embodiments, the method comprises: enforcing governance policies that restrict decision autonomy boundaries of agentic units; constraining tool usage behaviors; and defining acceptable limits for autonomous decision-making processes associated with the protected engine. In some embodiments, the method comprises: applying fairness constraints for multi-agent coordination; restricting information gathering activities; and prescribing collaboration guidelines governing interactions between human participants and artificial agents associated with the protected engine.

In some embodiments, the method comprises: analyzing operational context by considering deployment environment, regulatory obligations, use case criticality, user population, threat landscape, and observed operational patterns; and adjusting protective actions responsively based on the resulting contextual characterization. In some embodiments, the method comprises: ingesting public information, organizational guidelines, historical operational records, and domain-specific regulations; synthesizing said inputs into a contextual representation; and adapting protection strategies to the representation using an interactive context interpreter.

In some embodiments, the method comprises: operating an autonomous protection layer that detects distribution shifts, evolving threats, regulatory changes, operational modifications, and deployment updates; and reallocating defensive resources toward higher-priority vulnerabilities with minimal human oversight. In some embodiments, the method comprises: managing governance by defining, scheduling, and executing required evaluations; optimizing defensive operations to balance computational resource utilization against diverse vulnerabilities and applicable regulatory requirements through automated prioritization policies.

In some embodiments, the method comprises: operating an intent layer that interprets user goals, classifies intents into operational categories, and modifies protective actions to align operational behavior with legitimate objectives while preventing harmful intent exploitation. In some embodiments, the method comprises: monitoring an intent space to detect malicious or deceptive intent expressions; reclassifying protective posture upon detection; and modifying protection strategies to suppress hostile intent targeting the protected engine.

In some embodiments, at least one of the offline protection unit and the online protection unit modifies the protected architecture by outputting deceptive results to an identified originator of malicious queries. In some embodiments, the protected engine is configured to issue misleading responses toward a source of hostile queries as part of defensive modification of its operational architecture.

In some embodiments, a secondary engine performs classification of an input query from an originating entity to determine whether the query constitutes a malicious attempt against the protected engine. In some embodiments, at least one protection unit invokes a secondary engine to analyze an incoming query and identify whether the query is associated with adversarial activity targeting the protected engine.

In some embodiments, the online protection unit modifies the operational structure of the protected engine into a multi-engine pipeline or cascade that is more resilient to adversarial interference than a stand-alone engine. In some embodiments, the protected engine is adapted from operating independently to functioning within a combined multi-engine pipeline that provides enhanced robustness against malicious attacks.

In some embodiments, a weak spot detector is configured to cluster data into groups, compare protected engine accuracy across groups, and determine weaknesses in handling data with particular shared characteristics. In some embodiments, the system comprises a detector partitions input data, evaluates engine accuracy across partitions, and identifies vulnerabilities where the protected engine produces inaccurate outcomes for certain types of inputs.

In some embodiments, the system comprises an AI-based brainstormer unit, including multiple LLM units/VLM units/LMMM units and also including a coordination unit or a management unit; that derives at least one performance-improving insight for the protected engine through automated interaction between said models. In some embodiments, the AI-based brainstormer utilizes at least two LLMs/VLMs/LMMMs engaged in coordinated dialogue, with extracted results providing actionable improvements to performance of the protected engine.

In some embodiments, the system comprises an AI-based brainstormer unit having a plurality of LLMs/VLMs/LMMMs and a moderator model that manages their dialogue and extracts at least one insight enhancing protected engine performance. In some embodiments, the brainstormer unit includes several LLMs/VLMs/LMMMs guided by a moderator model that controls exchanges among them and generates insights improving operation of the protected engine.

In some embodiments, at least one of the offline protection unit and the online protection unit modifies the protected architecture by intentionally generating and transmitting deceptive or misleading results, in multiple forms including partial outputs or altered responses, toward an identified originator of malicious queries to confuse, delay, or misdirect further hostile probing activities. In some embodiments, the protected engine is configured to produce, under protective control, output signals containing false, obfuscated, or misleading information that are selectively directed to a source identified as submitting hostile or adversarial queries, thereby modifying operational architecture in a manner that degrades the effectiveness of subsequent malicious activity.

In some embodiments, a secondary engine, selected from the group consisting of a machine learning engine, a deep learning engine, or another artificial intelligence engine, performs classification analysis on an input query originating from an identified entity and determines, through secondary inference, whether the query represents or contributes to a malicious attempt targeting the protected engine. In some embodiments, at least one of the protection units invokes a secondary engine to analyze an incoming query, perform contextual classification, and identify whether the query is associated with adversarial activity, coordinated probing, or structured attack campaigns intended to exploit vulnerabilities of the protected engine.

In some embodiments, the online protection unit modifies an operational structure of the protected engine to integrate the engine into a pipeline or cascade comprising multiple engines, wherein the collective configuration provides greater resistance to adversarial interference by distributing processing, validating intermediate results, and reducing single-engine vulnerability relative to stand-alone operation. In some embodiments, the protected engine is adapted from operating as an independent entity to functioning as part of a coordinated multi-engine pipeline, said pipeline providing redundancy, enhanced verification of results, and improved robustness against malicious attacks, thereby strengthening resilience relative to isolated engine operation.

In some embodiments, a weak spot detector is configured to cluster input data into at least two or more groups based on shared attributes, compare performance accuracy of the protected engine across the clustered groups, analyze deviations in outcomes, and determine weaknesses in handling data with specific common characteristics that reveal hidden vulnerabilities. In some embodiments, the detector partitions incoming data into subsets, evaluates accuracy of the protected engine across said subsets, and identifies vulnerabilities, deficiencies, or weak spots where the protected engine consistently produces inaccurate results or unstable outputs when processing inputs exhibiting particular recurring patterns or properties.

In some embodiments, an AI-based brainstormer unit including multiple LLMs/VLMs/LMMMs, each model focusing on distinct performance aspects of the protected engine, and a coordination unit configured to organize automated interactions among the models, extract synthesized insights, and generate actionable recommendations that improve efficiency, reliability, and accuracy of the protected engine. In some embodiments, the AI-based brainstormer operates is engaged in structured automated dialogue, wherein the results of such coordinated exchanges are extracted, aggregated, and applied to produce performance improvements and optimizations in the protected engine across multiple operational dimensions.

In some embodiments, the AI-based brainstormer unit includes a plurality of LLMs/VLMs/LMMMs, each configured to examine different aspects of the protected engine, and a moderator model that allocates interaction slots, manages inter-model communication, and extracts combined insights that enhance performance, resilience, and adaptability of the protected engine. In some embodiments, the brainstormer unit comprises several LLMs/VLMs/LMMMs that are guided by a moderator model that directs exchanges among them, selectively shares partial chat history, synthesizes their outputs, and produces consolidated insights that are then used to improve and optimize operation of the protected engine.

In some embodiments, at least one of the Offline Protection Unit and the Online Protection Unit persistently instruments the Protected Engine during inference to interrogate internal operational states that are ordinarily opaque at the interface boundary, thereby capturing and analyzing intermediate activations across layers, attention distributions, gradient vectors and norms, and hidden-state tensors along the forward and backward computational pathways; the resulting telemetry is aligned to specific input segments and output tokens via time-synchronized identifiers and attribution indices, and is evaluated against robust, modality-aware statistical baselines and concept-drift monitors to surface deviations in magnitude, topology, sparsity, or inter-layer consistency; correlations between these intra-model anomalies and exogenous I/O features are computed using controllable probes and counterfactual replays to disambiguate benign variance from hostile perturbation; when the correlation structure expresses signatures such as gradient-direction collapse, attention head hijacking, activation saturation in normally subcritical units, or brittle decision bifurcations under infinitesimal input perturbations, the system flags potential adversarial manipulation, unstable decision pathways, or latent vulnerability surfaces that would remain undetectable from inputs and outputs alone; the detected condition can trigger graduated fortification responses, including on-the-fly policy tightening, selective deactivation of compromised subgraphs, or elevation to fail-secure modes while emitting audit-ready evidence bundles binding the internal-state observations to the precipitating request and the produced output.

In some configurations, prior to ingestion by the Protected Engine, one or both of the Offline Protection Unit and the Online Protection Unit interpose an adaptive, policy-driven input rewriting gateway that applies modality-appropriate transformations with the dual objective of preserving intended benign semantics while attenuating adversarial leverage; transformations can include sanitization of control tokens and markup, redaction or masking of sensitive substrings, re-weighting or normalization of features to calibrated ranges, canonicalization of formats and encodings, structure-preserving paraphrasing for natural language, and reversible policy-constrained perturbations designed to disrupt prompt-injection, jailbreak scaffolding, and gradient-free transfer attacks; a transformation policy is selected dynamically by consulting the contextual risk score derived from threat intel, recent operational patterns, and workload class, while honoring regulatory and organizational constraints codified as machine-verifiable rules; each candidate rewrite is subjected to acceptance checks that jointly enforce semantic fidelity within a bounded similarity tolerance measured by modality-specific metrics, and demonstrate reduction of an estimated adversarial effectiveness score below a defensible threshold computed from calibrated surrogate evaluations; only when both acceptance criteria are satisfied does the gateway forward the transformed artifact to the Protected Engine, accompanied by a cryptographically bound audit object encoding a reversible and traceable mapping between original and transformed segments, lineage of the applied policies, and sufficient metadata to support downstream explainability, rollback, and forensic reconstruction without re-exposing sensitive source content.

In additional embodiments, the protection stack augments pre-ingestion defenses with an attribution-centric analyzer that localizes attack-contributing regions within the input stream without necessarily modifying the submission, thereby isolating token spans in text, spatial patches in images, time-frequency tiles in audio, API call subsequences, code ranges, or interaction-trace fragments that exhibit anomalous influence on model behavior; the analyzer produces a signed attribution artifact that, for each localized region, aggregates calibrated importance scores with confidence intervals, provenance and reproducibility metadata sufficient to re-instantiate the observation under controlled replay, and, when applicable, cross-modal correspondences aligning, for example, captions to pixels or transcripts to spectrogram bins; the artifact is emitted to downstream consumers for governance and audit logging, human-in-the-loop review, adaptive policy refinement, curation of adversarial training curricula, and targeted runtime controls such as selective redaction, down-weighting, or quarantine of suspect regions; to preserve evidentiary integrity, the artifact is recorded in an immutable or append-only audit trail keyed to the specific input and decision outcome, with tamper-evident hashing, clock synchronization data, and chain-of-custody annotations, enabling post-hoc investigations to trace causal pathways from localized perturbations to observed outputs while maintaining strict separation between attribution analysis and application-layer business logic.

In some embodiments, the system continuously infers the adversarial capability regime that likely applies to a given interaction and adapts fortification behavior accordingly by distinguishing among white-box, black-box, and no-box attack contexts; a white-box context is diagnosed when observed patterns, timing, or external intelligence indicate that an adversary could possess, or behave as if possessing, access to internal parameters, gradients, or architectural details of the Protected Engine, prompting defenses that harden internal computation and reduce gradient exploitability; a black-box context is assumed when the adversary is credibly limited to observing inputs and outputs, in which case the defense emphasizes query-adaptive controls, behavioral boundary shaping, and output perturbation policies that degrade the utility of hostile probing without harming legitimate use; a no-box context is declared where an adversary has no interactive access to the Protected Engine and instead prepares indirect or offline attacks, motivating model-agnostic, policy-centric gateways and strict capability constraints; the estimator synthesizes evidence from query morphology, output entropy and stability, transferability checks against surrogates, and environmental signals to select or adjust the defense posture, and it binds the chosen posture to the transaction record so that fortification operations remain dynamically aligned with the estimated threat model over the lifetime of the session.

In further embodiments, protection extends to the physical substrate and peripheral interfaces upon which the Protected Engine depends by continuously monitoring sensor-level inputs, hardware busses, and physical channels for indicators of spoofing, electromagnetic or optical injection, acoustic perturbations, power-rail or clock manipulation, and direct tampering with compute or storage; the monitoring layer fuses telemetry from redundant sensing modalities, PUF-backed attestation from a Physical Unclonable Function) PUF, environmental beacons, and error-correcting counters to detect signatures such as correlated bit-flip bursts, spectral artifacts, saturating glare patterns, ultrasonic control tones, or anomalous I/O contention; upon detection, the system enacts proportionate safeguards that may include real-time filtering and denoising of affected streams with uncertainty propagation, isolation and graceful degradation of compromised interfaces, automatic failover to redundant sensors or virtualized estimates, and entry into pre-certified failsafe modes that bound risk while maintaining essential service; all actions are recorded with causal provenance so that subsequent diagnosis can differentiate environmental noise and benign stress from deliberate physical attack, and so that resilience policies can be refined using validated incidents without overfitting to transient anomalies.

In yet another configuration, an AI-based Brainstormer Unit generates actionable fortification recommendations that are never applied directly to the production control plane; instead, each recommendation is first executed end-to-end in a hermetic, rights-constrained sandbox that mirrors salient model, data, and traffic characteristics while preventing side-effects, and the proposed change advances only after clearing a series of verification gates that encode acceptance thresholds for performance regression tolerance, safety and policy compliance, and attack-resilience gains measured against a maintained battery of adversarial test suites and red-team scenarios; the promotion workflow is fully auditable, supports automated rollback on deviation, and integrates canary exposure and shadow evaluation to ensure that net risk reduction and service-level objectives remain within explicit bounds before the fortification becomes active for the Protected Engine.

In some complementary embodiments, the defense pipeline explicitly determines the defender's access modality to the Protected Engine and orchestrates preparation and deployment of fortification operations that are intrinsically consistent with that modality, thereby avoiding assumptions that could weaken guarantees or leak sensitive implementation detail; when the defender operates in a white-box modality with sanctioned visibility into internal parameters, gradients, or architectural features, the system preferentially composes controls that leverage privileged access, including high-fidelity internal-state instrumentation during inference with calibrated sampling, gradient and activation monitoring with drift alarms and sparsity/orthogonality checks, gradient obfuscation and randomization schemes that preserve task accuracy while disrupting exploitative signal paths, stochastic parameterization and architecture randomization with per-request seeds anchored to hardware entropy, defensive distillation regimes that smooth decision surfaces in areas prone to adversarial amplification, and in-engine policy and parameter hardening enforced via signed configuration manifests and secure enclave attestation; when the defender is constrained to a black-box modality, interacting only through input-output interfaces, the system emphasizes query-adaptive rate limiting coupled to behavioral anomaly detection, strict input validation and adaptive filtering pipelines that gate content and structure before it encounters sensitive components, surrogate or proxy model construction derived from observed I/O behavior to estimate decision boundaries and to rehearse fortification effects offline, active probing that estimates safe operating envelopes while learning adversary probing strategies, and calibrated deception or controlled output perturbation for suspected hostile querying that degrades reconnaissance value without misinforming legitimate use. If the defender is limited to a no-box modality with no opportunity to execute, query, or inspect the Protected Engine, then the system shifts entirely to model-agnostic protective gateways instantiated from contextual specifications, regulatory constraints, domain policies, and pre-negotiated service contracts, enforcing pre-defined capability whitelists and blacklists, multi-party approval workflows for elevated actions, deterministic output redaction or templating to constrain disclosure, honey-token and decoy response policies to safely identify hostile collection attempts, and offline surrogate approximations trained solely on external corpora and publicly available benchmarks to exercise policies and to forecast risk without contacting the Protected Engine. Across all modalities, a coordinator unit records the determined access class and the exact fortification recipe in an append-only audit ledger, ties deployment to reproducible infrastructure definitions with cryptographic provenance, and continuously measures effectiveness via objective metrics such as attack success rate reduction, false positive and false negative trade-offs, latency overhead, and user-visible quality impacts. If the defender's access modality changes (e.g., due to environment, vendor posture, or trust-zone transitions), then the system performs a controlled handover that replaces controls incompatible with the new modality while preserving safety invariants, rolling forward or back under feature-flag governance with canary and shadow evaluation, so that protection remains both principled and operationally practical irrespective of whether the defender is operating with white-box, black-box, or no-box access.

With regard to internal state analysis during inference, in some embodiments, at least one of the Offline Protection Unit and the Online Protection Unit, is further configured to perform: (i) analyzing internal operational states of the Protected Engine during inference, including one or more of: intermediate activations, attention maps, gradients, and hidden layer outputs; (ii) correlating anomalies in said internal operational states with corresponding inputs or outputs; (iii) based on step (ii), detecting indications of adversarial manipulation, unstable decision pathways, or latent vulnerabilities that are not observable solely from the inputs or outputs of the Protected Engine.

With regard to input rewriting and input modification, in some embodiments, at least one of the Offline Protection Unit and the Online Protection Unit, is further configured to perform: (i) applying one or more input-side transformations prior to ingestion by the Protected Engine, selected from: sanitization, redaction, masking, re-weighting, normalization, canonicalization, paraphrasing, format conversion, structure-preserving rewriting, and policy-constrained perturbation; (ii) selecting a transformation policy based on at least one of: modality, contextual risk scoring, regulatory or organizational constraints, and historical operational patterns; (iii) verifying that the transformed input satisfies acceptance checks comprising: (A) preservation of intended benign semantics within a predefined similarity tolerance, and (B) reduction of an estimated adversarial effectiveness score below a specified threshold; (iv) forwarding to the Protected Engine the transformed input together with an audit artifact that encodes a reversible or traceable mapping between original and transformed segments.

With regard to attack-source localization and/or attribution, in some embodiments, at least one of the Offline Protection Unit and the Online Protection Unit, is further configured to perform: (i) localizing, without necessarily modifying the input, one or more putative attack-contributing regions within an input, represented as at least one of: token spans, image patches, audio time-frequency regions, API call sequences, code ranges, or interaction-trace subsequences; (ii) generating an attribution artifact comprising, for each localized region, importance scores, confidence values, provenance and reproducibility metadata, and cross-modal correspondences where applicable; (iii) emitting said attribution artifact for downstream usage including at least one of: governance and audit logging, human-in-the-loop review, adaptive policy refinement, targeted runtime controls (including optional selective redaction or down-weighting), and curation of adversarial training curricula; (iv) maintaining the attribution artifact in an immutable or append-only audit trail linked to the corresponding input and system decision.

With regard to white-box/black-box/no-box distinction, in some embodiments, at least one of the Offline Protection Unit and the Online Protection Unit, is further configured to distinguish between: (i) a white-box attack context, wherein an adversary is assumed to have access to internal parameters, gradients, or architecture of the Protected Engine; (ii) a black-box attack context, wherein the adversary is assumed to have access only to inputs and outputs of the Protected Engine; and (iii) a no-box attack context, wherein the adversary is assumed to have no interactive access to the Protected Engine, including without executing, querying, or inspecting the Protected Engine, and prepares attacks offline and/or via indirect channels; and wherein the fortification operations are dynamically selected or adjusted based on whether the estimated adversarial context is white-box, black-box, or no-box.

With regard to physical attack taxonomy and defenses, in some embodiments, at least one of the Offline Protection Unit and the Online Protection Unit, is further configured to perform: (i) monitoring sensor-level inputs, physical interfaces, and hardware channels associated with the Protected Engine; (ii) detecting physical attacks that include at least one of: sensor spoofing, electromagnetic injection, optical perturbations, acoustic perturbations, or direct hardware tampering; (iii) applying protective actions against detected physical attacks, including at least one of: filtering affected sensor streams, isolating compromised hardware interfaces, switching to redundant sensing modalities, or triggering failsafe degradation modes of the Protected Engine.

With regard to a Brainstormer Unit verification loop, in some embodiments, actionable recommendations generated by the AI-based Brainstormer unit are executed initially in a sandboxed environment, and are promoted to active fortification of the Protected Engine only after passing one or more verification gates; wherein the verification gates comprise predefined acceptance thresholds for performance regression testing, safety validation, and attack-resilience validation.

With regard to defender access modality (white box, black box, no box), in some embodiments, at least one of the Offline Protection Unit and the Online Protection Unit, is further configured to: (i) determine a defender-access modality to the Protected Engine selected from: (A) a white-box modality in which the defender has access to internal parameters, gradients, or architecture of the Protected Engine; (B) a black-box modality in which the defender has access only to input-output interfaces of the Protected Engine; and (C) a no-box modality in which the defender prepares defenses without any interaction with the Protected Engine, including without executing, querying, or inspecting the Protected Engine; and (ii) prepare and deploy fortification operations according to the determined modality, comprising at least: (a) for the white-box modality: one or more of internal-state instrumentation during inference, gradient or activation monitoring, gradient obfuscation, randomized parameterization or architecture randomization, defensive distillation, and policy or parameter hardening applied within the Protected Engine; (b) for the black-box modality: one or more of query-adaptive rate limiting, input validation and adaptive filtering, surrogate or proxy model construction based on observed input-output behavior, boundary estimation via active probing, and deceptive or perturbed outputs against suspected hostile querying; (c) for the no-box modality: one or more of model-agnostic protective gateways instantiated from contextual specifications, regulatory constraints, or domain policies; pre-defined capability whitelists/blacklists, approval workflows, output redaction or templating, honey-token or decoy response policies, and offline surrogate approximation trained solely on external corpora or benchmarks, all defined and configured without executing, querying, or inspecting the Protected Engine.

In some embodiments, at least one of the Offline Protection Unit and the Online Protection Unit is further configured to: (i) analyze internal operational states of the Protected Engine during inference, including at least one of: intermediate activations, attention distributions, gradient vectors, and hidden-layer representations; (ii) correlate deviations or anomalies detected within said internal operational states with their respective originating inputs and/or resultant outputs; and (iii) based on such correlations, detect indications of adversarial manipulations, unstable or non-robust decision pathways, or latent systemic vulnerabilities that cannot be identified solely by observing the inputs or outputs of the Protected Engine.

In some embodiments, at least one of the Offline Protection Unit and the Online Protection Unit is further configured to: (i) apply one or more transformations to incoming inputs prior to ingestion by the Protected Engine, the transformations being selected from: sanitization, redaction, masking, re-weighting, normalization, canonicalization, paraphrasing, format conversion, structure-preserving rewriting, and policy-constrained perturbation; (ii) select a transformation policy dynamically according to at least one of: the modality of the input, contextual risk scoring, regulatory or organizational constraints, and historical operational behavior; (iii) verify that each transformed input satisfies acceptance conditions comprising: (A) preservation of intended benign semantics within a pre-defined similarity threshold, and (B) reduction of an estimated adversarial effectiveness score below a specified limit; and (iv) forward to the Protected Engine the transformed input together with an audit artifact encoding a reversible or otherwise traceable mapping between original and transformed segments.

In some embodiments, at least one of the Offline Protection Unit and the Online Protection Unit is further configured to: (i) localize, without necessarily altering the input, one or more suspected attack-contributing regions within the input, the regions comprising at least one of: token spans, image patches, audio time-frequency segments, API call sequences, code ranges, or interaction-trace subsequences; (ii) generate an attribution artifact for each localized region, the artifact comprising importance scores, confidence values, provenance metadata, reproducibility indicators, and, where applicable, cross-modal correspondences; (iii) emit said attribution artifact for downstream usage including at least one of: governance and audit logging, human-in-the-loop review, adaptive policy refinement, targeted runtime controls (including optional selective redaction or down-weighting), and curation of adversarial training curricula; and (iv) maintain said attribution artifact in an immutable or append-only audit trail that is securely linked to the corresponding input and system decision.

In some embodiments, at least one of the Offline Protection Unit and the Online Protection Unit is further configured to distinguish between: (i) a white-box attack context in which an adversary is assumed to have access to internal parameters, gradients, or architectural details of the Protected Engine; (ii) a black-box attack context in which the adversary is assumed to have access only to the inputs and outputs of the Protected Engine; and (iii) a no-box attack context in which the adversary is assumed to lack any interactive access to the Protected Engine, including without executing, querying, or inspecting the Protected Engine, and instead prepares attacks offline and/or via indirect channels; and wherein fortification operations are dynamically selected, adjusted, or prioritized in accordance with whether the estimated adversarial context is white-box, black-box, or no-box.

In some embodiments, at least one of the Offline Protection Unit and the Online Protection Unit is further configured to: (i) continuously monitor sensor-level inputs, physical interfaces, and hardware channels associated with the Protected Engine; (ii) detect physical attacks comprising at least one of: sensor spoofing, electromagnetic interference or injection, optical perturbations, acoustic perturbations, or direct hardware tampering; and (iii) apply protective measures against such detected physical attacks, including at least one of: filtering affected sensor streams, isolating compromised hardware interfaces, switching to redundant sensing modalities, or triggering a controlled failsafe degradation mode of the Protected Engine.

In some embodiments, actionable recommendations generated by the AI-based Brainstormer unit are executed initially within a sandboxed or otherwise non-production environment, and are promoted to active fortification of the Protected Engine only upon successful passage through one or more verification gates, the verification gates comprising pre-defined acceptance thresholds for performance regression testing, safety validation, and attack-resilience validation.

In some embodiments, at least one of the Offline Protection Unit and the Online Protection Unit is further configured to: (i) determine a defender-access modality to the Protected Engine selected from: (A) a white-box modality, in which the defender has access to internal parameters, gradients, or architectural elements of the Protected Engine; (B) a black-box modality, in which the defender has access only to the input-output interfaces of the Protected Engine; and (C) a no-box modality, in which the defender prepares fortifications without any direct interaction with the Protected Engine, including without executing, querying, or inspecting the Protected Engine; and then, (ii) prepare and deploy fortification operations in accordance with the determined modality, comprising at least: (a) for the white-box modality: one or more of internal-state instrumentation during inference, gradient or activation monitoring, gradient obfuscation, randomized parameterization or architecture randomization, defensive distillation, and policy or parameter hardening applied within the Protected Engine; (b) for the black-box modality: one or more of query-adaptive rate limiting, input validation and adaptive filtering, surrogate or proxy model construction based on observed input-output behavior, boundary estimation via active probing, and generation of deceptive or perturbed outputs against suspected hostile querying; and (c) for the no-box modality: one or more of model-agnostic protective gateways instantiated from contextual specifications, regulatory constraints, or domain policies; pre-defined capability whitelists or blacklists; approval workflows; output redaction or templating; honey-token or decoy response policies; and offline surrogate approximations trained solely on external corpora or benchmarks, all without executing, querying, or inspecting the Protected Engine.

The Applicant has further realized that another dimension of vulnerability arises not only from adversarial exploitation or model corruption, but from the inadvertent leakage of private, secret, or otherwise sensitive information, whether in the form of personally identifiable information (PII), proprietary datasets, confidential algorithms, or restricted software code. In conventional deployments of ML and LLM systems, there exists a latent risk that the model, once prompted in certain ways, may regenerate content that resembles fragments of its training data or otherwise expose materials that are not meant to be revealed outside their original domain of collection. Such risks do not necessarily require the presence of a hostile actor; even unintentional queries may draw out information that the system has memorized or internalized inappropriately. The Applicant has recognized that although some existing solutions attempt partial remedies (such as compressing outputs and comparing them against external repositories like VectorDB), these measures are inherently naive, as they cannot fully capture the semantic, contextual, or structural overlap between sensitive source material and generated outputs. A more sophisticated solution must be devised, one that incorporates multi-layered filtering, semantic fingerprinting of outputs, continuous reference to registries of protected assets, and adaptive monitoring that can prevent the transmission of unauthorized information before it reaches the user. In this regard, the present invention introduces fortification techniques that extend beyond conventional adversarial defenses to encompass safeguards against data and code leakage, thereby ensuring that the protected engine not only resists manipulation but also respects the boundaries of confidentiality, privacy, and intellectual property embedded within its operational corpus.

In addition, the Applicant has recognized that true robustness of AI protection requires a symmetrical view of defense, wherein both the protected engine and the end-user are shielded simultaneously through what may be described as a two-way firewall mechanism. Historically, emphasis has been placed primarily on protecting the system itself, such as preventing attempts to poison training datasets, misleading the inference pathway, stealing proprietary parameters, or exhausting computational resources. Yet, the Applicant has realized that equally critical is the obligation to protect the human user or beneficiary of the system from outputs or actions that may cause harm, whether in the form of offensive or defamatory texts, dangerous instructions that could be acted upon in the physical world, or unvetted recommendations that carry financial, psychological, or operational risk. This consideration is especially pressing in the domain of generative AI and agent-based models, whose outputs are not deterministic and whose errors may not be malicious but can still be damaging. Accordingly, the invention integrates a two-way firewall principle in which incoming queries and outgoing responses are both subject to adaptive interception, filtering, and fortification. Inputs are scrutinized not only for adversarial properties but also for latent instructions designed to trigger unauthorized or harmful behaviors, while outputs are dynamically evaluated to ensure that they remain within the safe, authorized, and intended boundaries of use. In some embodiments, this architecture extends even to image, video, or sensor-based systems, where generative or interpretive outputs could likewise pose unanticipated hazards. By formalizing the protection of both sides of the human-machine interface, the invention establishes a balanced trust framework, preventing misuse of the engine on one hand and misuse of its outputs on the other, thereby harmonizing resilience, safety, and user trust in a unified protective architecture.

The Applicant has further realized that the resilience of modern AI engines depends not only upon resisting adversarial manipulation, but also upon the ability to govern their own epistemic reliability, particularly in the context of factuality verification and hallucination mitigation. Conventional systems often generate fluent but ungrounded statements, sometimes referred to as “hallucinations,” which can erode user trust, propagate misinformation, or expose an operator to legal and reputational risk. In accordance with some embodiments, the Offline Protection Unit and/or the Online Protection Unit may be configured to intercept and evaluate factual assertions contained within proposed outputs, cross-referencing them against curated corpora, authenticated knowledge bases, or dynamic retrieval systems that are continuously updated with trustworthy sources.

The Applicant has also realized that verification must not be confined to binary acceptance or rejection, but instead should yield confidence and consistency scores, optionally drawing on cross-model consensus or multi-engine agreement protocols to detect divergence in interpretation. In situations where confidence falls below a pre-defined threshold, the system may adaptively decide to withhold a claim altogether, to substitute a verified summary, to annotate the assertion with explicit uncertainty markers and linked citations, or to route the matter to a human or automated approval workflow before transmission. Importantly, each verification operation generates persistent artifacts and metadata that are stored within an immutable audit trail, thereby providing both technical accountability and regulatory compliance with standards that increasingly mandate transparency and explainability. Through these mechanisms, the invention ensures that outputs are not only secure from adversarial distortion but also demonstrably tethered to verifiable fact, harmonizing robustness with epistemic integrity.

The Applicant has recognized that factual soundness alone is insufficient to ensure trustworthy AI operation, because models may inadvertently violate the policies and procedures established by their operators or institutional environments. In practice, large enterprises, financial institutions, healthcare providers, and governmental agencies operate under explicit procedural rules that govern permissible actions, pricing regimes, disclosure obligations, and interaction protocols. An AI system that generates responses outside of these defined boundaries may expose its operator to contractual breaches, financial loss, or regulatory infractions, even if the underlying output is factually correct.

Accordingly, in some embodiments, the system extends its protective firewall architecture to function as an enforcement layer for operator-defined policy constraints. In some embodiments, the system dynamically analyzes the outputs generated by the protected engine, identifying instances where proposed actions, recommendations, or responses conflict with codified organizational rules or contractual terms. For example, where internal procedures forbid the offering of discounts exceeding a particular threshold absent certain eligibility conditions, the firewall unit operates to detect and intercept attempts by the generative model to propose such impermissible transactions. In this way, the Applicant has realized that the firewall transcends traditional notions of adversarial defense and becomes a governance guardian, ensuring that outputs are not only accurate but also aligned with the institution's procedural frameworks. This dual emphasis on factuality and policy conformity establishes an integrated trust architecture that simultaneously safeguards technical reliability and institutional legitimacy.

Furthermore, the Applicant has realized that the trustworthiness of AI-mediated interaction must be reinforced by mechanisms that respect and enforce the permissions associated with individual users, thereby ensuring that no information or action is performed outside the scope of authorized access. In conventional deployments, a model may inadvertently reveal confidential data to unauthorized parties or may carry out instructions that a particular user has no right to initiate, creating both security vulnerabilities and compliance failures. In accordance with some embodiments, the protection framework incorporates a permissions enforcement mechanism that continuously cross-references user requests against an access-control schema maintained by the operator. If a user attempts to obtain data beyond their clearance level, the system dynamically withholds the requested information and generates an explanation of denied access. Similarly, if a user instructs the model to execute an action for which they lack the requisite role-based authorization, the system intervenes to decline execution and communicates the lack of permissions. This enforcement operates seamlessly within the same firewall infrastructure, ensuring that the scope of interaction remains bounded by the principle of least privilege. By embedding permission-sensitivity directly within the protective fabric of the AI engine, the Applicant has established a layered defense that guards not only against adversaries and hallucinations but also against overreach by legitimate but unauthorized users. In this way, the invention reinforces a holistic protective posture, uniting factual grounding, policy adherence, and permission enforcement within a coherent and adaptive defensive architecture.

In some embodiments, at least one of the Offline Protection Unit and the Online Protection Unit is further configured to verify factual assertions within generated outputs against authenticated corpora or retrieval systems, compute confidence and consistency scores, annotate low-confidence outputs with citations, and record verification artifacts in an immutable audit trail to ensure transparency and accountability.

In some embodiments, the protective firewall unit is further configured to enforce operator-defined policy constraints by dynamically analyzing proposed outputs, detecting conflicts with codified organizational rules or contractual procedures, intercepting impermissible actions, and ensuring that generated responses remain aligned with institutional frameworks governing permissible transactions, disclosures, and user interactions.

In some embodiments, the protective framework is further configured to enforce user permissions by cross-referencing incoming requests against an access-control schema, withholding unauthorized data, declining execution of prohibited actions, and dynamically communicating denied access, thereby ensuring that all interactions remain bounded by authorized privileges and preventing overreach by legitimate but unauthorized users.

The Applicant has realized that the effectiveness of a protection framework for AI engines is substantially enhanced when the system is capable of ingesting and reasoning about the broader operational context in which the engine functions. In conventional security approaches, the defensive mechanisms often operate in isolation, without any awareness of the circumstances, tasks, or domains in which the model is deployed, which results in generic safeguards that lack specificity and adaptability. In accordance with some embodiments, when a user initiates a pen-testing or protection workflow, the system requires that contextual information be supplied in order to construct a comprehensive understanding of the target engine's environment.

This contextual information may be captured in multiple ways, ranging from direct user input via a conversational chatbot interface, to ingestion of structured system instructions, to automated scraping of online resources such as URLs and service descriptions, and further to the collection of datasets composed of potential prompts, exemplar images, or live conversations. Additionally, users may upload files such as manuals, specifications, or technical documentation, all of which enrich the context.

Once this information is obtained, the system fuses it with metadata about the underlying model and data assets, as well as knowledge drawn from public sources or proprietary repositories, subjecting it to analytic processes that refine and normalize the contextual insights. The result of this process is the generation of a context artifact, which may be embodied as a textual representation suitable for injection into the platform's internal LLM prompts, but which may also comprise multimodal content that encapsulates the full scope of the operating domain. By maintaining and updating such artifacts, the system ensures that both protection and evaluation are continuously grounded in the actual functional landscape of the protected engine.

Building upon this, the Applicant has recognized that a high-level dynamic configuration mechanism must operate in close association with the context ingestion process, such that the firewall and pen-testing subsystems can be continuously adapted to reflect the evolving circumstances in which the engine is deployed. In contrast to traditional systems that maintain a fixed security configuration, the disclosed invention leverages contextual analysis to tailor protective strategies with specificity and precision.

For example, by analyzing the ingested context artifact, the system can discern which categories of adversarial threats are most relevant to the target domain, which ones are peripheral, and which are wholly irrelevant. This analysis informs the configuration of protective policies, detection thresholds, and mitigation modules in real time, thereby enabling the defensive posture to shift dynamically as context evolves. The Applicant has further realized that context-sensitive configuration enables resources to be concentrated on high-priority threat vectors while reducing overhead associated with unlikely risks, thereby balancing resilience with efficiency. The invention thus incorporates a feedback loop in which new context provided by the user, or detected automatically through monitoring, triggers re-evaluation and re-configuration of the firewall and pen-testing features. Through this adaptive process, the system is not only resistant to a static set of adversarial techniques but is continuously recalibrated to defend against the threat landscape most pertinent to the engine's operational use case, achieving a dynamic alignment between protection and real-world conditions.

Furthermore, the Applicant has realized that context must not only inform the general configuration of the protective system, but also permeate the internal logic of specific features so that each function operates with an awareness of the circumstances in which it is deployed. In some embodiments, feature-specific context awareness is implemented such that individual modules dynamically incorporate contextual inputs into their functional parameters. For example, in the case of defenses against prompt injection attacks, the system may generate adversarial prompts that explicitly incorporate contextual information in order to probe vulnerabilities in a manner that reflects the true operating environment.

Accordingly, the system does not merely simulate attacks in a vacuum, but instead tailors its adversarial interactions by embedding contextually relevant details directly into the attack vectors. Typically, the contextual information is passed as a structured text string injected into the prompts that guide the operation of the feature, though multimodal forms may also be utilized in cases where the context includes imagery, tabular data, or sensor inputs. By embedding the operational context into each protective function, the Applicant ensures that the defense system itself achieves a form of contextual intelligence, allowing it to identify vulnerabilities that might otherwise remain hidden in a generic testing regime. This deeper integration of context into both detection and adversarial emulation establishes a holistic defense environment where every protective layer is dynamically aligned not only with the architecture of the protected engine but also with the precise conditions of its use.

In some embodiments, at least one of the Offline Protection Unit or the Online Protection Unit is further configured to ingest contextual information about the designated AI engine through chatbot interfaces, structured instructions, URL scraping, dataset collection, live conversations, or uploaded documentation, to synthesize a multimodal context artifact combining model metadata, external knowledge, and analytic processing, such that subsequent protection operations are grounded in the specific environment of deployment.

In some embodiments, the “AI firewall unit” and pen-testing subsystems are dynamically configured based on contextual analysis, such that the ingested context artifact identifies relevant and irrelevant adversarial threat vectors, informs adaptive adjustment of detection thresholds and protective modules, and continuously recalibrates security policies in real time, thereby enabling concentration of defensive resources on high-priority risks and ensuring evolving resilience aligned with the operational environment of the protected engine.

In some embodiments, individual protective features incorporate feature-specific context awareness by receiving contextual information as structured text or multimodal parameters injected directly into prompts, thereby enabling adversarial simulation and vulnerability testing that reflects real operating conditions, including generation of context-tailored prompt injection attempts, such that the protective system achieves contextual intelligence and reveals vulnerabilities that remain undetected under generic, context-agnostic security evaluations.

The Applicant has realized that modern agentic systems, which rely on the dynamic orchestration of multiple tools to execute complex tasks, cannot be effectively protected by conventional perimeter defenses that monitor only the agent itself, but instead require a finer-grained framework that governs the intent and permissible behavior of each individual tool. In accordance with some embodiments, an intent-based firewall is introduced, which relies on a hierarchical taxonomy of intents specifically constructed for tools invoked by agents, beginning with abstract categories that describe broad classes of actions and progressively branching into more concrete and specific objectives. For example, while an abstract intent might be defined as the general act of performing a web operation, this intent is recursively refined into concrete instantiations such as posting a comment on a web forum or transmitting an email message, thereby providing a structured semantic ladder that maps tool operations from general categories down to actionable units.

Each intent is accompanied by parameters that determine the manner in which the action is executed, which may be static, such as the identity of the platform from which a tool operates, or dynamic, such as the recipient address that changes with every invocation. The Applicant has realized that by analyzing the tool description prior to its first call, certain parameters can be pre-classified as static (e.g., fixing the platform to “Slack” for a tool designed to send Slack messages), while others are left dynamic to capture variable user inputs. This distinction creates a predictable structure within which intent-based guardrails can operate. In accordance with some embodiments, the system receives contextual information about the tool, which may include documentation, operational details, parameter schemas, and possible values, and this context can be gathered through multiple pathways, including user-supplied descriptions, uploaded manuals, or automated analysis such as code scanning that identifies goals, parameter requirements, and expected ranges. Based on this contextual understanding, the system automatically selects and applies the appropriate firewall modules to the tool itself, rather than merely constraining the agent as a whole.

Accordingly, some embodiments provide a tool-level firewalling that creates a protective mesh in which each component is governed according to its intended use, thereby preventing misuse even if the overarching agent attempts to manipulate or exploit the tool in ways that diverge from authorized behavior. The Applicant has further realized that this framework provides a powerful mechanism for governance, particularly for Chief Information Security Officers and other oversight authorities, by granting them the ability to specify, enforce, and audit permissible operations at the granularity of tool intents. By embedding the firewall logic directly into the functional context of each tool, the system creates a robust governance layer that preserves operational flexibility for agentic systems while ensuring compliance with institutional policies and industry regulations. This approach is especially relevant for Multi-Capability Platforms, where tools with heterogeneous functions are simultaneously available, and it establishes a coherent governance regime in which every tool invocation is not only technically validated but also semantically authorized in accordance with the intent-taxonomy framework that is provided by embodiments of the invention.

With regard to intent-based tool firewall and context-driven selection, in some embodiments, an intent-based firewall unit governs tools invoked by agentic systems using a hierarchical taxonomy that maps abstract actions to concrete objectives; parameters are partitioned into static and dynamic classes pre-classified from tool descriptions; and tool context (e.g., documentation, operational modes, parameter schemas, and code-scan outputs) is ingested to automatically select tool-specific firewall modules independent of the agent, including deployments within multi-capability platforms and across federated environments.

With regard to per-tool authorization, as well as parameter validation and auditability, in some embodiments, the intent-based firewall unit enforces per-tool authorization by binding each invocation to an approved intent and pre-classified static parameters, validating dynamic parameters against contextual schemas, denying or rewriting non-compliant calls, and recording decision artifacts in an append-only audit trail, thereby enabling CISO-level governance and semantically authorized operations even when an agent attempts to misuse the tool within multi-capability platform deployments.

The Applicant has realized that reliable detection of adversarial behavior can be substantially enhanced when the Protected Engine is instrumented to observe, model, and reason over its own internal computational values during inference, rather than relying exclusively on external input-output behavior; in accordance with some embodiments, the system augments conventional perimeter defenses with an internal-state observer that serializes intermediate activations, attention distributions, hidden-layer representations, gradient statistics, and other latent descriptors into a telemetry stream suitable for learning discriminative and generative signatures of normal and hostile operation.

In a supervised configuration, the protection stack constructs a corpus containing both benign flows and confirmed attack flows, the latter curated from red-team campaigns, synthetic adversarial generators, penetration-testing harnesses, and field incidents, and then trains a classifier to separate these classes using the latent telemetry as features; the classifier may be realized as a lightweight neural head attached to selected layers, a margin-based model over pooled statistics, or a hybrid ensemble that fuses multiscale descriptors from early, middle, and late network stages, optionally incorporating temporal smoothing for autoregressive models or recurrent components. Supervised learning allows the detector to internalize nuanced multi-layer dependencies (such as co-occurring saturation in specific channels, anomalous attention head entanglement, or gradient-direction collapse) that often accompany successful exploits, while maintaining tight control over precision-recall tradeoffs by curriculum-tuning the positive class across perturbation strengths, transfer techniques, and query budgets.

Complementarily, in an unsupervised configuration, the system leverages the abundance of benign traffic to train one or more anomaly models that learn the manifold of legitimate internal dynamics, for example by fitting density estimators to low-rank embeddings of activations, training autoencoding or masked-prediction objectives on latent tensors, or estimating calibrated confidence envelopes around stability indices derived from Jacobian norms, Lipschitz surrogates, or mutual-information proxies between layers; such detectors can surface previously unseen attack families because they do not depend on labeled adversarial exemplars, albeit at the cost of a tendency to flag rare but harmless phenomena.

In order to mitigate false alarms without sacrificing novelty detection, the system composes multi-channel validators that compare latent anomalies with independent views of the same event (such as a content-side anomaly score computed from the input artifact itself, or a behavioral consistency check against a shadow run of the engine under benign perturbations) while also incorporating a “known-benign oddities” register in which recurrent, operationally acceptable irregularities (for example, specific domain-shift patterns or deployment-specific sensor quirks) are modeled and absorbed into the benign manifold. In some embodiments, suspicious interactions (e.g., suspected attacks, or ambiguous anomalies) are automatically escalated to a second-stage analyzer that performs deeper causal tests under controlled conditions, thereby using the unsupervised monitor as a high-recall front-end and the escalator as a precision-oriented arbiter that reduces operator load.

The Applicant has further realized that the Protected Engine can be extended so that it not only pursues its primary task but also continuously self-assesses its risk state through introspective structures: for large models, compact adapters analogous to low-rank adaptation modules may be inserted at designated layers and trained to maximize informativeness with respect to attack presence while remaining orthogonal to task-relevant pathways; these adapters expose attack-sensitive projections of the hidden state without materially perturbing baseline accuracy or latency, thereby enabling the engine to emit an inference-time “health signal” aligned to the same inputs and outputs it processes for utility.

This introspective capacity generalizes beyond single-model scenarios to networks of models, including tool-using agents or pipelines that combine LLMs with perception modules, where the protection layer correlates cross-component latent descriptors and detects inconsistencies (for instance, an upstream vision embedding exhibiting perturbation-sensitive drift while the downstream language head maintains brittle confidence) that are consistent with multi-stage attack chains. In addition to passive observation, the system actively probes stability properties that characterize robust reasoning: during triage, a surrogate variant of the engine (or a sandboxed copy) replays the same input under controlled micro-perturbations that would be expected to preserve semantics (small noise, format jitter, paraphrases, feature re-weightings) and compares latent trajectories and output distributions; many attacks fail such stability tests because their efficacy collapses under slight, benign changes, whereas legitimate decisions remain within learned tolerance bands.

The same approach can be extended from the input boundary into the network interior, by applying constrained perturbations or stochastic dropout to intermediate representations, either through native mechanisms (e.g., calibrated noise injections or layer-wise resampling) or by routing through a behaviorally equivalent surrogate instrumented for perturbation capability; when a decision proves excessively sensitive to infinitesimal, structure-preserving layer perturbations, the defense flags a suspect brittle pathway. Across supervised and unsupervised regimes, the protection platform maintains modality-aware baselines for each monitored signal, tracks drift over deployment epochs, and binds every inference to a cryptographically chained audit record that links the input, the output, the latent evidence, the detector verdicts, and any counterfactual probes executed. This record enables post-hoc forensics, facilitates continuous improvement of supervised corpora with adjudicated edge cases, and supports governance requirements that demand explainable rationale for security actions.

Importantly, some embodiments further avoid disclosure of proprietary techniques or sensitive collaborations by abstracting the described mechanisms at an architectural level while still teaching how the system expands a neural or multi-engine pipeline to include self-analysis and introspection as first-class functions: detectors are modular, hot-swappable, and trainable offline or online; adapters are parameter-efficient and gated by attestation; thresholds are policy-driven and context-conditioned; and escalations are executed in hermetic sandboxes to preclude side effects. By fusing discriminative supervision with generative modeling of benign dynamics, layering stability-based causal tests over latent probes, and integrating low-overhead introspective adapters that transform hidden computation into actionable security signals, the disclosed framework converts the opaque interior of complex AI systems into a measurable, governable space where adversarial influence has discernible signatures and where protective interventions can be justified, audited, and continuously refined without compromising primary task performance or intellectual property.

With regard to supervised internal-state classifier and audit binding, in some embodiments, at least one of the Offline Protection Unit and the Online Protection Unit serializes intermediate activations, attention distributions, hidden-state representations, and gradient statistics as latent telemetry; curates a corpus of benign and confirmed attack flows from red-team campaigns and production incidents; trains a classifier over multiscale descriptors (via a neural head or ensemble), calibrates precision-recall thresholds, and binds per-inference verdicts to a chained audit record linking inputs, outputs, and latent evidence.

With regard to unsupervised latent anomaly modeling with staged escalation, in some embodiments, the protection stack trains unsupervised anomaly models on benign latent tensors to learn the manifold of legitimate internal dynamics using density estimators, autoencoders, or masked-prediction objectives; computes calibrated envelopes over stability indices including Jacobian norms and mutual-information proxies; cross-validates latent anomalies against content-side scores and shadow replays; maintains a register of known-benign oddities; and escalates suspicious interactions to hermetic, causal tests in a second-stage analyzer.

With regard to stability probing via micro-layer and intra-layer perturbations), in some embodiments, stability probing is performed by replaying inputs through a surrogate or sandboxed variant under controlled micro-perturbations (e.g., noise, paraphrase, format jitter) and by applying constrained perturbations or stochastic dropout to intermediate representations; divergences in latent trajectories or output distributions beyond learned tolerance bands are treated as brittle pathways, triggering quarantine or canary routing, policy-driven fortification actions, and binding of probe evidence to the corresponding audit chain.

The Applicant has realized that a robust line of defense can be established by deliberately transforming the incoming input artifact before it reaches the core of the Protected Engine, not as a cosmetic pre-processing step but as an active, policy-governed intervention that disrupts adversarial leverage while preserving benign semantics within measurable tolerances. In accordance with some embodiments, the protection stack applies stochastic perturbations such as calibrated Gaussian noise to shatter finely tuned adversarial patterns, couples those injections with compression-decompression cycles that strip high-frequency or codec-incoherent artifacts, and further projects the input onto a safer subspace defined by either analytic bases or learned manifolds so that only components consistent with natural data statistics survive.

The Applicant has further realized that denoising is not merely a “cleanup” heuristic but a principled projection operator when implemented with generative priors: diffusion models trained to approximate the score field of natural images can be used to push perturbed inputs back toward the natural-image manifold, thereby erasing adversarial signatures that do not correspond to plausible content. Where diffusion is computationally heavy or latency-sensitive, lighter denoisers (e.g., ranging from total-variation and wavelet-threshold schemes to autoencoder-based reconstructions) are substituted under a gating policy that trades optimality for speed without abandoning the manifold-projection principle. To avoid over-reliance on any single transformation, some embodiments instantiate a diversified ensemble of parallel variants (e.g., multiple noise realizations, multiple compression qualities, multiple projection strengths) and pass all variants through the task model, after which a consensus adjudicator compares logits, embeddings, or task-specific invariants and returns an output only if a stability criterion is met, thereby converting fragile, attack-dependent decisions into majority-stable outcomes while flagging disagreements for further scrutiny.

The same pipeline integrates seamlessly with localization mechanisms: if an upstream analyzer identifies spatial patches, token spans, or time-frequency tiles suspected of carrying the attack, the transformer masks or attenuates only those regions, applies targeted manifold projection to the affected substructures, and preserves the remainder of the signal untouched, thus minimizing information loss and latency while neutralizing the focal perturbation. In the textual domain, the Applicant has recognized that so-called “textual patch attacks” often rely on extremely low-probability substrings, anomalous character n-gram distributions, or prompt scaffolds that statistically deviate from the operator's corpus. Accordingly, a language-model-driven prior computes token-level or span-level rarity measures, and substrings falling below stringent thresholds are masked, rewritten into canonical forms, or dropped entirely before the Protected Engine is engaged, breaking jailbreak triggers without altering the intended benign request. Across modalities, every transformation is selected by a context-aware policy that considers risk score, regulatory constraints, and service-level objectives; acceptance checks verify that the transformed artifact remains within a predefined semantic similarity band (e.g., measured by modality-appropriate metrics) and that estimated adversarial effectiveness is reduced below a calibrated bound.

Each decision is bound to an audit object that records the original artifact's hash, the sequence of applied transformations, the consensus statistics across variants, and the localization masks, enabling later forensic reconstruction and continuous improvement of the transformation bank. By treating input modification not as a monolithic filter but as an adaptive, evidence-producing control plane (e.g., spanning stochastic destruction of brittle perturbations, generative projection back to data manifolds, ensemble stability voting, and context-targeted masking), the system turns the attacker's sensitivity to carefully tuned patterns into a liability, while preserving task fidelity for legitimate users under explicit, measurable guarantees.

With regard to manifold-projection denoising with gated acceptance, in some embodiments, at least one of the Offline Protection Unit and the Online Protection Unit modifies inputs by injecting noise, applying compression-decompression, and projecting artifacts onto a “safe” subspace via denoising with diffusion-based generative priors; wherein latency-aware gating substitutes lighter denoisers when required; and wherein acceptance checks enforce modality-specific semantic similarity bounds and demonstrable reduction of adversarial effectiveness before forwarding the transformed artifact to the Protected Engine with an audit descriptor.

With regard to parallel variants with consensus adjudication and auditing, in some embodiments, the protection stack generates parallel transformed variants of a given input (e.g., comprising multiple noise realizations, compression qualities, and projection strengths) and executes the Protected Engine on each variant, and returns a result only when a consensus adjudicator finds logits, embeddings, or task invariants stable within learned tolerances; disagreements trigger quarantine or escalation, and the system records the transformation chain and consensus statistics in an append-only audit object.

With regard to localization-guided masking and textual rarity filtering, in some embodiments, localization signals identifying attack-bearing regions guide targeted masking or attenuation followed by manifold-projection of only the affected substructures, preserving untouched content; and wherein, for textual artifacts, spans whose probability falls below a stringent rarity threshold are masked or canonically rewritten to disrupt prompt-patch triggers; transformation selection is context-aware, and each action is validated for semantic fidelity and logged with corresponding masks and hashes.

The Applicant has realized that beyond merely labeling an input as adversarial or attempting to wash away its effects through global transformations, a materially stronger defensive posture emerges when the protection system can localize the attack itself, that is, identify and segment the precise spatial, temporal, or symbolic region within the artifact that carries the adversarial payload, and then act upon that region with surgical precision while preserving the remainder of the signal intact.

In accordance with some embodiments, the protection pipeline incorporates a localization analyzer that operates in conjunction with pre-ingestion gateways and post-generation validators, ingesting the raw input and producing an attribution mask that encodes the suspected origin of malicious influence at the granularity appropriate to the modality; for example, bounding polygons or pixel-level masks for images and video frames, time-frequency tiles for audio streams, token spans for textual prompts and interaction traces, and feature or field ranges for structured records. The Applicant has recognized that this capability directly addresses the classic protection-performance tradeoff: when the system knows where the attack is, it can neutralize only the affected substructure through masking, attenuation, or targeted manifold projection while leaving the remainder of the content unaltered, thereby maintaining task fidelity, latency budgets, and user experience in cases where blunt denoising would otherwise degrade legitimate signal.

In some embodiments, the localization analyzer is realized as a supervised detector trained on corpora containing annotated adversarial artifacts, which, for visual domains, reduces to an object detection or segmentation task augmented with adversarial priors and, for text, becomes a span-tagging or sequence-labeling problem that identifies injection scaffolds, low-entropy lure patterns, or statistically implausible n-gram formations; in other embodiments, large vision-language models provide cross-modal grounding that aligns suspicious visual patches with textual cues, enabling the system to triangulate composite attacks that rely on both content and instruction. Complementarily, the analyzer may employ unsupervised and self-supervised criteria that surface anomalous regions based on deviations from learned natural statistics (e.g., spectral outliers, abrupt distributional shifts in intermediate embeddings, instability under small semantic-preserving perturbations, or incongruent attention mass in heads that do not typically activate for the given context), thereby retaining sensitivity to novel attacks that were not present in the training distribution.

The localization output is not a mere visualization artifact but a first-class control signal: the protection engine can route masked variants through the Protected Engine to confirm that the suspect region is indeed causally implicated, can apply localized denoising or diffusion-based projection only where needed, can down-weight logits or constrain decoding in the vicinity of tagged spans, and can trigger targeted secondary scans where physical-world patches, stickers, or reflective overlays are suspected, enabling automated reporting to operators or external systems responsible for remediation in the environment. For textual domains, the system applies rarity-aware normalization that censors or canonicalizes substrings with vanishing prior probability under a domain language model, thus neutralizing prompt-patch anchors without disturbing the benign remainder of the user's request. For audio, time-frequency masks remove narrowband beacons and ultrasonic control tones while preserving intelligibility. For video and images, spatial masks confine cleaning to the minimal region necessary to restore consistency with the natural manifold.

In order to ensure accountability and reproducibility, each localization event is coupled with an audit artifact that records the mask geometry, confidence values, feature-space evidence, counterfactual ablations performed during causal testing, and the final mitigation applied, all cryptographically chained to the input and output so that downstream forensics can reconstruct the decision path and upstream training pipelines can incorporate hard negatives into future detectors. The Applicant has further realized that localization improves fleet-level governance: by aggregating normalized localization signatures across deployments, the system can identify recurring attack templates, update signatures and risk scores without service interruption, and propagate refined detectors through a controlled rollout, while the Protected Engine benefits from a continuous learning loop that sharpens both detection sensitivity and mitigation efficiency. In this manner, the invention elevates localization from a diagnostic convenience to a core defensive operation: rather than treating adversarial influence as an undifferentiated fog to be globally scrubbed, the system renders it a mappable, measurable, and controllable phenomenon with explicit boundaries and evidentiary support, enabling proportionate responses that are both technically effective and operationally economical.

With regard to localization masks with targeted mitigation, in some embodiments, at least one of the Offline Protection Unit and the Online Protection Unit is further configured to generate modality-aware attribution masks that localize putative attack regions—pixel or polygon masks for images and video, time-frequency tiles for audio, and token spans for text—and to apply targeted mitigation by masking, attenuation, or manifold projection solely within the localized region while preserving unaffected content, thereby reducing protection-performance tradeoffs.

With regard to supervised/unsupervised localization with causal audit, in some embodiments, at least one of the Offline Protection Unit and the Online Protection Unit trains supervised detectors on annotated adversarial corpora and unsupervised models that surface anomalous regions by deviations from natural statistics; escalates localized findings to causal tests using counterfactual ablations and stability replays; and binds mask geometry, confidence scores, and mitigation outcomes to a cryptographically chained audit artifact linked to the input and output.

With regard to fleet-level aggregation and controlled rollout, in some embodiments, localization signatures produced across deployments are normalized and aggregated to detect recurring attack templates, update risk scores, and refine detector parameters; and wherein updated localization models and mitigation policies are propagated via controlled rollout with canary evaluation, such that fleet-level governance gains continuous improvement while maintaining service stability and evidentiary continuity for regulators, incident responders, and downstream retraining pipelines.

The Applicant has realized that protection can and should extend to the output surface itself, treating every proposed response from the Protected Engine as a first-class artifact to be analyzed, validated, and, where necessary, transformed before release, thereby converting the egress pathway into an active control plane. In some embodiments, an output anomaly analyzer evaluates the response for semantic implausibility, policy deviation, privacy risk, toxicity, and goal-incongruent reasoning using calibrated confidence and entropy metrics, embedding-space distance to trusted exemplars, citation sufficiency, and alignment checks against operator policies and user permissions; when instability or risk is detected, the system can withhold, redact, or regenerate portions of the response under constrained decoding while annotating residual uncertainty.

Complementarily, the system can employ consensus-based adjudication by running the input (and optionally: semantically equivalent variants) through parallel inference paths that differ in decoding seeds, temperatures, system prompts, or surrogate models, then comparing logits, rationales, citations, and structured outputs for self-consistency; only responses that meet learned stability thresholds across these parallel views are promoted, while disagreements trigger targeted re-decoding, policy tightening, or escalation to a sandboxed reviewer.

This dual approach, of direct anomaly scrutiny and multi-path agreement, enables the platform to suppress brittle or adversarially amplified answers and to prefer responses that are demonstrably stable under benign perturbations, with every decision bound to a cryptographically chained audit object that records risk scores, consensus statistics, any transformations applied, and links to underlying evidence, thereby preserving both utility and institutional trustworthiness at the point where it matters most: the model's outward voice.

With regard to output anomaly analysis and controlled transformation, in some embodiments, an output-protection unit evaluates proposed responses for semantic implausibility, policy deviation, privacy leakage, toxicity, and goal-incongruent reasoning using confidence and entropy scores, embedding-space distance to exemplars, citation sufficiency, and alignment checks to operator policies and user permissions; and, upon risk detection, withholds, redacts, or regenerates content under constrained decoding while annotating uncertainty, binding judgments and transformations to a cryptographically chained audit artifact.

With regard to multi-path output consensus and escalation, in some embodiments, an output-consensus adjudicator executes parallel inference paths over the same input (and optionally semantically equivalent variants) varying decoding seeds, temperatures, prompts, or surrogate models; compares logits, rationales, citations, and structured fields for stability against learned thresholds; promotes consistent responses; and on disagreement triggers targeted re-decoding, policy tightening, or sandboxed review, recording consensus statistics and actions within an append-only audit ledger linked to the transaction.

The Applicant has realized that a black-box protection scenario (e.g., the operator exposes only an API and withholds or lacks access to internal parameters, gradients, or architectural details of the underlying model) is not an edge case but rather the dominant operational reality, especially when the customer embeds third-party proprietary engines such as commercial foundation models for which even the customer has no privileged visibility.

In some embodiments, the system therefore formalizes a model-agnostic defense plane that performs continuous risk assessment and active mitigation strictly at the I/O boundary, without executing, querying, or inspecting internal components beyond what the published interface permits. The system instantiates an intermediate gateway that receives user requests prior to submission to the Protected Engine and inspects model responses prior to egress, applying context-aware input validation, semantic rewriting, capability scoping, rate and budget governance, and policy-bound templating to constrain what the model is asked to do; and, symmetrically, applying output redaction, privacy and PII controls, citation and factuality checks, toxicity and safety screening, and uncertainty labeling to constrain what the model is allowed to say.

Where active interposition is not permitted, a pure observer mode attaches to the communication channel to compute behavioral telemetry, such as query composition features, cadence and burst patterns, response entropy and instability, transferability signatures against surrogates, and drift in aggregate outcomes. The system is configured for emitting near real-time alerts, scoring transactions, and driving automated throttling or human-in-the-loop escalation at the service boundary when suspicion crosses policy thresholds. To preserve customer autonomy and vendor neutrality, every control is declared through signed, auditable policies, and every decision is recorded in an append-only ledger that binds the input, the output, the applied constraints, and the measured risk to a cryptographic chain suitable for compliance review.

The Applicant has further realized that these two modes (intermediate-layer interposition, and channel-level observation) are not mutually exclusive; they can be composed so that passive sensing informs active gating, while canary prompts, boundary estimation with noninvasive probes, and offline surrogate modeling provide ancillary evidence to refine risk posture without touching the black-box core. In this way the invention delivers robust, regulator-ready defense and governance for black-box AI deployments, achieving principled control over capabilities, disclosures, and abuse vectors even when the internal model remains entirely opaque.

With regard to black-box interposition gateway, and input/output controls and audit, in some embodiments, at least one of the Offline Protection Unit and the Online Protection Unit is further configured to operate in a black-box interposition mode by mediating requests to and responses from the Protected Engine's API, performing input validation, rewriting, rate governance and policy-bound templating, and on egress applying output redaction, privacy controls, factuality checks, toxicity and safety screening, with all interventions bound to an append-only, cryptographically chained audit ledger.

With regard to black-box observer mode, as well as telemetry, response, and audit feature, in some embodiments, at least one of the Offline Protection Unit and the Online Protection Unit is further configured to operate in a black-box observer mode that does not inspect internal parameters, computing behavioral telemetry over the I/O channel, including query composition features, cadence and burst patterns, response entropy and instability, and transferability signatures against surrogates; triggering policy-driven alerts, automated throttling, or human-in-the-loop escalation; and recording decisions and evidence in a cryptographically chained audit record.

Some embodiments provide a tri-space analytical architecture that enables cross-lens data integrity evaluation. In some embodiments, the platform introduces a tri-space analytical architecture that transforms raw datasets into three complementary representations (semantic, tabular, and latent) and then keeps all three “views” available to every downstream evaluator. The system does not merely compute embeddings; it explicitly constructs and persists the three spaces, and the analysis flow binds each capability (e.g., data integrity inspection, performance diagnosis, fairness auditing) to the particular space or combination of spaces best suited for that task.

In practice, this allows, for example, integrity checks to operate on tabular statistics while cluster-level performance probes run over the latent manifold, with contextual narratives drawn from the semantic layer. These spaces are created deliberately and reused throughout the workflow, rather than being ad-hoc artifacts computed case by case, thereby establishing a uniform substrate for cross-capability reasoning and comparison. This persistent, cross-referenced tri-space design is an enabling feature: it yields consistent identifiers between spaces, lets conclusions travel from one analytic lens to another without lossy translation, and materially reduces the chance of contradictory diagnoses across modules because they anchor to shared transformations. This architecture upgrades “feature extraction” into a first-class, system-wide data model that is analysis-aware and lifecycle-long.

In some embodiments, the platform operationalizes a multi-level feature engineering pipeline that outputs two synchronized tables: an image-level table and an instance-level table. These tables are not generic metadata dumps; they are curated to span ascending rungs of informational richness. First, fundamental image attributes (dimensions, encoding) are collected; second, classical computer-vision measurements (brightness, contrast, HSV statistics) are computed; third, aesthetic composition features (Rule-of-Thirds adherence, entropy, depth-of-field, edges, energy, homogeneity) are extracted; fourth, contextual/semantic descriptors (weather, scenery, human pose/positioning, clothing) are derived using state-of-the-art generative and language models; fifth, label-based statistics are compiled at both image and object instance granularity (object counts, dominant classes, per-instance blur, size, and class). By structuring features in this tiered fashion and by emitting both image-scope and instance-scope tables, subsequent algorithms can reason at the right granularity without re-parsing images. The result is a portable “analysis substrate” that allows integrity checks, performance correlations, fairness audits, and error forensics to share a common schema while still addressing instance-specific edge cases.

In some embodiments, the platform implements a two-stage correlation protocol that guards against spurious shortcuts and hidden label misrepresentations. Stage one computes correlation scores between every engineered feature and the labels, explicitly surfacing any feature that alone could predict a class, as an early warning that the model may be over-relying on an incidental cue (e.g., “time of day” accidentally acting as a vehicle proxy). Stage two then drills into the distribution of labels within salient feature categories to detect misrepresentation pockets (for example, confirming whether “person” occurrences vary materially across weather buckets), thereby distinguishing genuine causal signals from dataset quirks. The system may utilize follow-up distributional tests that verify that apparent correlations are not artifacts of under- or over-represented subgroups. The outcome is not a generic “correlation heatmap,” but a governance-grade decision: either flag a bias risk for remediation or document that the training signal is multi-feature and broadly representative. This staged protocol hardens model development against brittle generalization by transforming correlation from a visualization into a formal gate for trustworthiness.

In some embodiments, the system performs systematic single-feature outlier detection on the engineered tabular space before any model-level conclusions are drawn. For each feature, descriptive statistics establish baselines, and robust fences (e.g., IQR) identify anomalous samples that sit far outside the typical range. Rather than treating outliers as automatically “bad,” the workflow elevates outlier adjudication into a context-aware decision: an observation flagged in one deployment may be perfectly representative in another. The system's treatment includes box-plot inspections across selected features and worked examples of high-value outliers (e.g., homogeneity spikes or severe blur) that would otherwise pollute training or skew evaluation. Importantly, the outlier pipeline is integrated into the lifecycle: detected anomalies can be removed or quarantined before retraining, with the provenance of each decision recorded so later audits can justify dataset hygiene. By formalizing this as a first-class, pre-analysis step on the properties table, the system ensures that downstream fairness, performance, and robustness conclusions are not silently confounded by a small number of extreme, low-quality, or corrupted samples.

In some embodiments, the platform extends anomaly scrutiny beyond univariate fences and into multi-feature and manifold-aware detection. A dedicated routine inspects joint relationships within the tabular space to surface records that look plausible in isolation yet are inconsistent in combination (e.g., unusual blur-contrast-box-size co-occurrences). Complementing that, the latent-space analyzer runs clustering and anomaly detectors on embedding vectors to expose subtle, structure-level outliers that evade tabular heuristics. The system reports concrete outcomes (e.g., dozens of multi-feature outliers identified), demonstrating that manifold analytics materially improves data integrity over single-feature screening. Because both the tabular and latent detectors are anchored to the same tri-space identifiers, flagged samples remain traceable across views, and remediation can target root causes (data capture artifacts versus semantic rarity). This dual-lens anomaly control prevents model overfitting to exotic pockets and reduces surprise failure modes in deployment by expelling distributional “stragglers” prior to training or by quarantining them for special-handling evaluation sets.

In some embodiments, the system trains explicit failure-risk predictors over the tabular space and uses explainable AI to attribute why and where detectors will fail, turning bias discovery from anecdote into supervised inference. The predictors are fit to forecast the probability of model failure using the engineered features (including bounding-box geometry and scene semantics), and then XAI methods decompose those predictions to isolate which factors drive errors. This yields actionable, class-specific and/or context-specific insights such as: slender objects and exceptionally large objects are failure-prone (with different error types by aspect ratio), indoor scenes underperform outdoor ones, and high entropy or strong blur pushes the model toward mistakes; even partially occluded faces are a weak point. Because the pipeline is predictive and interpretable, it directly informs data augmentation, labeling priorities, and thresholding strategies. Rather than cataloging “biases” qualitatively, the feature quantifies them and tags their causes, so mitigation can be precisely targeted to visual or geometric conditions that most compromise reliability.

In some embodiments, the platform implements a fairness-validation workflow that couples statistical audits with controlled synthetic generation to probe demographic equity under matched scene conditions. Beyond reporting “rate” differences, the process composes hold-out scenarios (for instance, equalizing subject distance or environmental context) so that sensitivity to protected attributes is measured without confounding factors. It then augments scarce cases with generated samples (e.g., gender-specific exemplars) to validate that gaps are not artifacts of sampling noise and to stress-test the detector's invariance to identity features. The output is a set of quantitative findings and visual validations (e.g., no-detection rates by subgroup, example galleries), and concrete remediation levers such as curating additional instances for underrepresented cohorts or retraining with synthetic complements. Treating fairness as a testable property with its own generation tools, rather than an after-the-fact report, is an innovative feature: it embeds bias validation into the same disciplined pipeline used for robustness, using the same engineered spaces and reproducible generation steps.

In some embodiments, the system adds reliability engineering via confidence calibration at both aggregate and class levels, producing “stated-vs-measured” reliability curves that expose miscalibration pockets. The system can point out over-confidence zones for a baseline model, where predictions at nominal 50-60 percent confidence can realize markedly lower precision in practice, contrasting with regions where the alternative model is comparatively well-calibrated. By quantifying these deltas per class (e.g., persons, cars, trucks), the platform can recommend class-specific thresholds or temperature scaling to recover reliability without bluntly lowering global sensitivity. Since the calibration analysis is integrated with OOD and performance views, it also warns when models become under-confident in the presence of dirt or other distribution shifts (e.g., cases where a “timid” detector may suppress otherwise correct detections). This elevates calibration from a plotting exercise to an operational control: it ties confidence shaping to concrete failure trade-offs, with measured evidence for each class and deployment context.

In some embodiments, the platform deploys an inference-time OOD sentinel derived from its anomaly-detection stack, explicitly validated by constructing realistic shifts (e.g., “dirty camera” artifacts) and then measuring how confidence behaves under those shifts. The workflow simulates OOD by programmatically applying occluding noise not present in the training distribution, compares clean vs. OOD accuracy and error profiles, and then inspects calibration to verify whether the model's stated confidence tracks its true correctness. The reported findings (e.g., accuracy declines across metrics and systematic under-confidence in the 0.5-0.8 band) translate directly into production guidance: add OOD and drift detectors, and tune thresholds or mitigation logic when the sentinel fires. An innovative aspect here is the closed loop: an OOD detector that is not an abstract score, but one whose effect on decision reliability has been empirically characterized against the same calibration instruments used in pre-deployment analysis.

In some embodiments, the system introduces a data-source OOD guard that reasons at the granularity of upstream providers, not only individual images. Rather than treating the input stream as homogeneous, the platform projects sources into a shared representation space and computes distribution-similarity scores to detect when a particular camera, pipeline, or dataset branch drifts away from the training profile. Visualization of source clusters and per-source similarity enables operators to isolate whether a surge in errors stems from a specific supplier (e.g., a new preprocessing chain or sensor revision) instead of a global model issue. This source-aware detector is actionable: it lets teams quarantine or reweight a source, trigger targeted collection, or open a remediation ticket with the data provider, all before large-scale model degradation occurs. By elevating “source” to a first-class statistical entity, the system closes a notorious blind spot in vision deployments where silent pipeline changes create misdiagnosed model failures.

In some embodiments, the system advances its operational resilience by embedding a drift detection mechanism that not only signals distributional shifts but dissects their underlying dimensions with granularity. Unlike conventional models that treat drift as a binary event, this architecture decomposes observed variations into data drift and concept drift, thereby distinguishing between input distribution changes—such as lighting transitions from day to night or relocation into new geographic domains—and semantic redefinitions where the same physical input may require new labels. The detector is constructed on engineered features that span both tabular and latent spaces, ensuring that its sensitivity is tuned to the same structural representations already underpinning fairness and anomaly checks.

When drift is detected, the mechanism annotates the precise axes along which it emerges, whether tied to environmental context, temporal cadence, or evolving class semantics. This precision allows for targeted mitigations such as adaptive thresholds, location-specific recalibration, or supplementary fine-tuning with freshly acquired examples, rather than blunt global retraining. Crucially, the drift analysis is not an ad-hoc evaluation triggered by failure symptoms; instead, it operates as a persistent monitoring service, continuously comparing live inputs to historical baselines. By situating drift as a lifecycle-long, dimension-aware control surface, the platform offers operators the ability to anticipate degradation before accuracy collapses, thereby transforming drift detection from a diagnostic into a predictive, actionable safeguard.

In some embodiments, the platform formalizes a security analysis framework that introduces a structured evasion-attack taxonomy, anchoring its definitions to operational threat models rather than abstract adversarial literature. This taxonomy separates attacks into multiple axes: intended effect (false negatives, false positives, denial-of-service by over-detection, semantic distortion), method (imperceptible pixel perturbations, universal masks, physical patches, spoofing sequences), attacker access level (white-box, query-based, or no-box), and capability provenance (open-source exploits, academic code releases, custom toolchains). By enforcing this multi-dimensional categorization, the system transforms vague notions of “adversarial attack” into concrete, testable profiles that map directly to countermeasures.

For example, in environments where no-box attackers predominate, the framework prioritizes transfer-based defenses and false-positive sentinels, while query-rich environments emphasize throttling and anomaly-based monitoring. The innovation lies in the taxonomy's coupling to automated penetration testing harnesses: once a category is defined, the system can synthesize attack vectors that correspond to it and evaluate how detection, calibration, or OOD modules respond. This structured approach eliminates ambiguity in security audits, ensuring that coverage is not only broad but aligned to real-world adversarial capacities. In short, the taxonomy creates a programmable bridge between theoretical attack spaces and operational defenses, elevating security validation to the same rigor as fairness and reliability testing within the lifecycle framework.

In some embodiments, the architecture introduces a unifying capability whereby drift detection outputs and evasion-taxonomy insights are aligned into a single assurance loop. Traditional pipelines treat dataset drift and adversarial attack as independent phenomena, yet both degrade reliability under changing conditions. The system of some embodiments bridges them by projecting drift signals into the same representational axes employed by the evasion-taxonomy framework, thereby permitting cross-analysis: for instance, a sudden drift in night-time imagery can be evaluated against susceptibility to physical patch attacks under low-illumination, yielding a composite risk score. This integration permits operators to prioritize mitigations not only by the severity of drift but also by the likelihood that adversaries could exploit those distributional weaknesses. Furthermore, the alignment supports proactive defense-detectors trained on historical drift events can be stress-tested with attack taxonomies that simulate adversarial adaptation to similar shifts, ensuring that security postures evolve in tandem with environmental realities. Reporting is structured so that calibration, fairness, anomaly, and security modules are cross-referenced, reducing the chance of fragmented assessments. The benefit of this integrated assurance loop is twofold: operational continuity in the face of organic distribution shifts and reinforced resilience against opportunistic adversarial manipulation. By unifying drift awareness with structured attack modeling, the system elevates deployment readiness into a continuous discipline, where security and adaptability co-evolve as explicit, auditable properties of the pipeline.

In some embodiments, an analysis engine persistently constructs and maintains three canonical data spaces—a semantic space, a tabular property space, and a latent manifold—and further binds each diagnostic or governance capability to at least one of said spaces, the system assigning stable cross-space identifiers so that findings, thresholds, and annotations propagate in a lossless manner between spaces, thereby preventing contradictory conclusions and enabling cross-lens validation during model development, evaluation, deployment, and audit.

In some embodiments, a feature-engineering pipeline emits synchronized, schema-stable outputs comprising an image-level table and an instance-level table that jointly encode tiers of information including image attributes, classical vision measures, aesthetic composition metrics, contextual descriptors, and label-centered statistics, the tables being key-aligned to permit granular reasoning across images and object instances without re-parsing the corpus, thereby enabling interchangeable integrity checks, performance forensics, and fairness analysis at multiple resolutions.

In some embodiments, a correlation auditor implements a two-stage protocol that first computes per-feature correlation scores against ground-truth labels to surface shortcut predictors, and then evaluates label distributions within salient feature partitions to test representativeness, the auditor issuing governance-grade flags when a single feature substantially predicts a label and documenting non-action when distributions remain balanced, thereby reducing spurious generalization and regulating acceptance gates for dataset curation and model sign-off.

In some embodiments, a hygiene module performs single-feature outlier screening on the properties table using descriptive statistics and robust interquartile-range fences, elevates flagged elements for context-aware adjudication, and records provenance of removal, quarantine, or retention decisions, the module thereby attenuating the confounding influence of extreme, corrupted, or goal-irrelevant samples prior to retraining and preserving an auditable trail for subsequent compliance reviews, incident response, or lifecycle governance.

In some embodiments, an anomaly controller executes dual-lens detection that (i) analyzes joint relationships among tabular features to surface inconsistent co-occurrences and (ii) clusters embedding vectors within the latent space to expose manifold-level outliers, both detectors anchoring to shared identifiers so that remediation targets capture error sources including capture artifacts or semantic rarity, thereby reducing overfitting to exotic pockets and stabilizing deployment behavior across heterogeneous operating conditions.

In some embodiments, a supervised failure-risk predictor is trained upon engineered features including bounding-box geometry and scene semantics to estimate per-sample failure probability, and explainable-AI attributors decompose said estimates into factor contributions, the system surfacing class- and context-specific drivers such as aspect-ratio extremity, indoor settings, entropy, or blur, thereby directing data augmentation, labeling priorities, and thresholding strategies toward conditions that most degrade reliability for specified use contexts.

In some embodiments, a fairness validator couples statistical subgroup audits with controlled synthetic generation that equalizes confounding scene variables, augments scarce demographic exemplars, and measures sensitivity to protected attributes under matched conditions, the validator outputting quantitative disparity measures, exemplar galleries, and concrete remediation levers including targeted curation, weighting, and synthetic complements, thereby transforming fairness from observational reporting into an experiment-driven, reproducible evaluation integrated with the same engineered analysis spaces.

In some embodiments, a calibration analyzer constructs stated-versus-measured reliability curves at aggregate and per-class levels, detects confidence miscalibration pockets, and prescribes class-specific mitigations including threshold adjustment and temperature scaling, the analyzer further cross-referencing out-of-distribution and drift indicators to identify contexts of systematic under- or over-confidence, and issuing guardrail warnings when timid detectors suppress otherwise correct detections, thereby recovering precision without blunt sensitivity losses.

In some embodiments, an inference-time out-of-distribution sentinel is validated using programmatically constructed distribution shifts including occlusion and dirty-camera artifacts, compares clean and shifted accuracy and error profiles, and links confidence behavior to decision reliability, the system configuring class-aware thresholds and mitigation logic responsive to sentinel activations, thereby closing the loop between out-of-distribution detection and calibrated decision control for production deployments subject to environmental perturbations.

In some embodiments, a source-aware distribution guard projects upstream data sources into a shared representation, computes per-source similarity metrics relative to training distributions, and visualizes source clusters to isolate provider-specific drift, the guard enabling quarantine or reweighting of suspect sources and initiating targeted collection or remediation workflows with upstream providers, thereby preventing silent pipeline regressions from being misdiagnosed as global model failures and preserving service-level reliability.

In some embodiments, a drift detector operates continuously over live inputs against historical baselines, distinguishes data drift from concept drift using engineered features spanning tabular and latent spaces, and annotates axes of change including lighting, geography, temporal cadence, and label semantics; and wherein responsive controls apply targeted mitigations comprising adaptive thresholds, region-specific recalibration, and selective fine-tuning on freshly collected samples, thereby enabling predictive, dimension-aware intervention before service degradation.

In some embodiments, a security framework codifies a multidimensional evasion-attack taxonomy partitioned by intended effect, attack method, attacker access, and capability provenance, and automatically instantiates penetration tests conforming to each category; and wherein defense selection is prioritized to operational threat models by coupling transfer-robust detectors, query throttling, anomaly monitoring, and false-positive sentinels with calibration and out-of-distribution modules, thereby converting abstract adversarial risk into repeatable, coverage-measured lifecycle validation.

In some embodiments, drift-analysis outputs are projected into representational axes shared with an evasion-attack taxonomy, a risk aligner computing composite scores that combine measured drift severity with adversarial exploitability under corresponding conditions; and wherein proactive defenses stress-test detectors using attack classes matched to historical or emergent drifts, orchestrate class-specific thresholding, selective retraining, or source quarantine, and emit cross-referenced reports unifying calibration, fairness, anomaly, and security assessments.

Some embodiments may include a non-transitory storage medium or storage article having stored thereon instructions or code that, when executed by a machine or a hardware processor, cause such machine or hardware processor to perform a method as described. Some implementations may utilize an automated method or automated process, or a machine-implemented method or process, or as a semi-automated or partially-automated method or process, or as a set of steps or operations which may be executed or performed by a computer or machine or system or other device.

Some embodiments may be implemented using suitable hardware components and/or software components; a processor able to execute code or programs or machine-readable instructions (e.g., a Central Processing Unit (CPU), a Digital Signal Processor (DSP), an Integrated Circuit (IC), a logic unit, or the like); a storage unit to store received data and/or processed data (e.g., hard disk drive, solid state drive); a memory unit to store data for short term (e.g., Random Access Memory (RAM) memory, Flash memory); a transceiver able to send and receive data using one or more wireless communication protocols (e.g., Wi-Fi communication, cellular communication, TCP/IP communication); and other suitable components (e.g., input unit such as keyboard and mouse; output unit such as display unit; power source; or the like).

Some implementations may utilize code or program code or machine-readable instructions or machine-readable code, which may be stored on a non-transitory storage medium or non-transitory storage article (e.g., a CD-ROM, a DVD-ROM, a physical memory unit, a physical storage unit), such that the program or code or instructions, when executed by a processor or a machine or a computer, cause such processor or machine or computer to perform a method or process as described herein. Such code or instructions may be or may comprise, for example, one or more of: software, a software module, an application, a program, a subroutine, instructions, an instruction set, computing code, words, values, symbols, strings, variables, source code, compiled code, interpreted code, executable code, static code, dynamic code; including (but not limited to) code or instructions in high-level programming language, low-level programming language, object-oriented programming language, visual programming language, compiled programming language, interpreted programming language, C, C++, C#, Java, JavaScript, SQL, Ruby on Rails, Go, Cobol, Fortran, ActionScript, AJAX, XML, JSON, Lisp, Eiffel, Verilog, Hardware Description Language (HDL), Register-Transfer Level (RTL), BASIC, Visual BASIC, MATLAB, Pascal, HTML, HTML5, CSS, Perl, Python, PHP, Dart, machine language, machine code, assembly language, or the like.

In some embodiments, the term “user” may be: a human user operating a computerized device or an electronic device (e.g., a desktop computer, a laptop computer, a tablet, a smartphone), or may be an AI-based Agentic Unit, or may be a humanoid robot or other robot or other machine or a software module or a hardware module or a hybrid hardware-and-software module that is programmed or configured or prompted to make decisions and/or to perform operations or actions.

Discussions herein utilizing terms such as, for example, “processing”, “computing”, “calculating”, “generating”, “determining”, “establishing”, “analyzing”, “checking”, “detecting”, “measuring”, or the like, may refer to operation(s) and/or process(es) of a processor, a computer, a computing platform, a computing system, or other electronic device or computing device, that may automatically and/or autonomously manipulate and/or transform data represented as physical (e.g., electronic) quantities within registers and/or accumulators and/or memory units and/or storage units into other data or that may perform other suitable operations.

Some embodiments may perform steps or operations such as, for example, “determining”, “identifying”, “comparing”, “checking”, “querying”, “searching”, “matching”, and/or “analyzing”, by utilizing, for example: a pre-defined threshold value to which one or more parameter values may be compared; a comparison between (i) sensed or measured or calculated value(s), and (ii) pre-defined or dynamically-generated threshold value(s) and/or range values and/or upper limit value and/or lower limit value and/or maximum value and/or minimum value; a comparison or matching between sensed or measured or calculated data, and one or more values as stored in a look-up table or a legend table or a legend list or a database of possible values or ranges; a comparison or matching or searching process which searches for matches and/or identical results and/or similar results among multiple values or limits that are stored in a database or look-up table; utilization of one or more equations, formula, weighted formula, and/or other calculation in order to determine similarity or a match between or among parameters or values; utilization of comparator units, lookup tables, threshold values, conditions, conditioning logic, Boolean operator(s) and/or other suitable components and/or operations.

The terms “plurality” and “a plurality”, as used herein, include, for example, “multiple” or “two or more”. For example, “a plurality of items” includes two or more items.

References to “one embodiment”, “an embodiment”, “demonstrative embodiment”, “various embodiments”, “some embodiments”, and/or similar terms, may indicate that the embodiment(s) so described may optionally include a particular feature, structure, or characteristic, but not every embodiment necessarily includes the particular feature, structure, or characteristic. Furthermore, repeated use of the phrase “in one embodiment” does not necessarily refer to the same embodiment, although it may. Similarly, repeated use of the phrase “in some embodiments” does not necessarily refer to the same set or group of embodiments, although it may.

As used herein, and unless otherwise specified, the utilization of ordinal adjectives such as “first”, “second”, “third”, “fourth”, and so forth, to describe an item or an object, merely indicates that different instances of such like items or objects are being referred to; and does not intend to imply as if the items or objects so described must be in a particular given sequence, either temporally, spatially, in ranking, or in any other ordering manner.

Some implementations may be used in, or in conjunction with, various devices and systems, for example, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a tablet, an on-board device, an off-board device, a hybrid device, a vehicular device, a non-vehicular device, a mobile or portable device, a consumer device, a non-mobile or non-portable device, an appliance, a wireless communication station, a wireless communication device, a wireless Access Point (AP), a wired or wireless router or gateway or switch or hub, a wired or wireless modem, a video device, an audio device, an audio-video (A/V) device, a wired or wireless network, a wireless area network, a Wireless Video Area Network (WVAN), a Local Area Network (LAN), a Wireless LAN (WLAN), a Personal Area Network (PAN), a Wireless PAN (WPAN), or the like.

Some implementations may be used in conjunction with one way and/or two-way radio communication systems, cellular radio-telephone communication systems, a mobile phone, a cellular telephone, a wireless telephone, a Personal Communication Systems (PCS) device, a PDA or handheld device which incorporates wireless communication capabilities, a mobile or portable Global Positioning System (GPS) device, a device which incorporates a GPS receiver or transceiver or chip, a device which incorporates an RFID element or chip, a Multiple Input Multiple Output (MIMO) transceiver or device, a Single Input Multiple Output (SIMO) transceiver or device, a Multiple Input Single Output (MISO) transceiver or device, a device having one or more internal antennas and/or external antennas, Digital Video Broadcast (DVB) devices or systems, multi-standard radio devices or systems, a wired or wireless handheld device, e.g., a Smartphone, a Wireless Application Protocol (WAP) device, or the like.

Some implementations may comprise, or may be implemented by using, an “app” or application which may be downloaded or obtained from an “app store” or “applications store”, for free or for a fee, or which may be pre-installed on a computing device or electronic device, or which may be otherwise transported to and/or installed on such computing device or electronic device.

Functions, operations, components and/or features described herein with reference to one or more implementations, may be combined with, or may be utilized in combination with, one or more other functions, operations, components and/or features described herein with reference to one or more other implementations. Some embodiments may comprise any possible or suitable combinations, re-arrangements, assembly, re-assembly, or other utilization of some or all of the modules or functions or components or units that are described herein, even if they are discussed in different locations or different chapters of the above discussion, or even if they are shown across different drawings or multiple drawings.

While certain features of some demonstrative embodiments have been illustrated and described herein, various modifications, substitutions, changes, and equivalents may occur to those skilled in the art. Accordingly, the claims are intended to cover all such modifications, substitutions, changes, and equivalents.

What is claimed is:

1. A system comprising:
one or more processors that are configured to execute code,
wherein the one or more processors are operably associated with one or more memory units that are configured to store code;
wherein the system is configured to protect a Protected Engine that is a unit selected from the group consisting of: a Machine Learning (ML) unit, a Deep Learning (DL) unit, a Reinforcement Learning (RL) unit, a Supervised Learning (SL) unit, an Artificial Intelligence (AI) unit, a Neural Network (NN) unit, a Large Language Model (LLM) unit, a large Vision-and-Language Model (VLM), a Large Multi-Modalities Model (LMMM), an AI-based Agentic unit;
wherein the system is configured to protect the Protected Engine against at least one of: malicious inputs, malicious queries, malicious training data, malicious attacks;
wherein the system comprises at least one of:
(a) an Offline Protection Unit, that is configured: to analyze one or more characteristics of the Protected Engine, and to perform offline fortification of said Protected Engine against attacks by changing one or more operational properties or operational parameters of the Protected Engine and to reduce its vulnerability to attacks;
(b) an Online Protection Unit, that is configured to perform analysis of at least one of: (i) one or more inputs that are ingested by the Protected Engine, (ii) one or more outputs that are generated by the Protected Engine; and based on said analysis, to dynamically perform online fortification of said Protected Engine against attacks by dynamically changing one or more operational properties or operational parameters of the Protected Engine to reduce its vulnerability to attacks.

2. The system of claim 1,
wherein at least one of the Offline Protection Unit and the Online Protection Unit, is further configured to perform:
(i) conducting, via an adversarial training module, controlled penetration testing against the Protected Engine;
(ii) recording successful bypass characteristics with metadata indicating origin, reproducibility, and severity;
(iii) incorporating said successful bypass characteristics into subsequent fortification cycles, and utilizing said successful bypass characteristics to update defensive policies while verifying absence of performance regressions using predefined acceptance thresholds.

3. The system of claim 1,
wherein at least one of the Offline Protection Unit and the Online Protection Unit, is further configured to perform:
(i) generating synthetic adversarial inputs from previously-detected vulnerabilities, based on one or more constrained perturbation strategies;
(ii) re-training the Protected Engine by curriculum scheduling of said synthetic adversarial inputs;
(iii) validating mitigation effectiveness on holdout attack suites, by checking whether or not residual risk metrics fall below specified tolerance levels.

4. The system of claim 1,
wherein at least one of the Offline Protection Unit and the Online Protection Unit, is further configured to perform:
(i) automatically parsing regulatory and legal texts, that pertain to regulatory and legal constraints on electronic systems, into machine-interpretable technical specifications;
(ii) automatically evaluating operational parameters of the Protected Engine against the machine-interpretable technical specifications;
(iii) automatically identifying compliance deficiencies that require remediation;
(iv) automatically mapping each identified deficiency to one or more particular technical controls and evidentiary artifacts that are suitable for at least one of: an audit process, an attestation process, a lifecycle governance process.

5. The system of claim 1,
wherein at least one of the Offline Protection Unit and the Online Protection Unit, is further configured to perform:
(i) parsing texts that correspond to jurisdictional Right to Explanation rules, and automatically generating machine-readable specifications that correspond to said jurisdictional Right to Explanation rules;
(ii) invoking an Explainability Module to be operatively associated with the Protected Engine, wherein said Explainability Module operates by guide and enforcing automatic compliance of the Protected Engine with said machine-readable specifications that correspond to said jurisdictional Right to Explanation rules.

6. The system of claim 5,
wherein the Explainability Module is configured to generate an immutable audit-trail having append-only properties;
wherein the Explainability Module is further configured to enable consent management and provenance capture.

7. The system of claim 5,
wherein the Explainability Module comprises, or is operably associated with, one or more bias detection analyzers that are configured to detect bias and to align parameters of the Protected Engine with parsed regulatory requirements while also generating verifiable compliance evidence.

8. The system of claim 1,
wherein at least one of the Offline Protection Unit and the Online Protection Unit, is further configured to perform:
performing fortification operations to protect, against attacks and against malicious utilization, an AI-based Agentic Unit that is capable of autonomously utilizing digital tools for collecting information and for making decisions and for triggering real-world actions based on said decisions.

9. The system of claim 8,
wherein performing the fortification operations in step (i) comprises:
(A) verifying operational traces resulting from actions of said AI-based Agentic Unit;
(B) enforcing decision boundaries on decisions of said AI-based Agentic Unit;
(C) checking collaborative interactions between said AI-based Agentic Unit and one or more other AI-based Agentic Units.

10. The system of claim 9,
wherein performing the fortification operations in step (i) further comprises:
(D) enforcing rate-limiting on invocation of digital tools by said AI-based Agentic Unit;
(E) sandboxing external actions that are triggered by said AI-based Agentic Unit;
(F) constraining elevated-risk capabilities of said AI-based Agentic Unit to pre-approved contexts that also include revocation conditions.

11. The system of claim 8,
wherein performing the fortification operations in step (i) comprises:
(A) assessing interactive environments that said AI-based Agentic Unit is accessing or attempts to access;
(B) evaluating a sequence of invocations of digital tools by said AI-based Agentic Unit;
(C) monitoring communication channels utilized by said AI-based Agentic Unit;
(D) based on steps (A) and (B) and (C), detecting anomalous actions of said AI-based Agentic Unit that are estimated to be inconsistent with expected autonomy or with coordination parameters; and adapting one or more protection mechanisms towards said AI-based Agentic Unit by performing at least one of: (D1) enforcing pre-condition checks, (D2) enforcing post-condition checks, (D3) confirming invariants, (D4) throttling unsafe behaviors, (D5) grounding queries generated by said AI-based Agentic Unit.

12. The system of claim 1,
wherein at least one of the Offline Protection Unit and the Online Protection Unit, is further configured to perform:
(i) validating integrity of reward signals of a Reinforcement Learning unit;
(ii) confirming authenticity of state and space definitions of the Reinforcement Learning unit;
(iii) verifying environment dynamics within a training arena by checking cryptographic hashes or signed descriptors of environment artifacts, and preventing malicious alterations that induce unsafe or deceptive learning trajectories during training of said Reinforcement Learning unit.

13. The system of claim 1,
wherein at least one of the Offline Protection Unit and the Online Protection Unit, is further configured to perform:
(i) automatically imposing and enforcing safe exploration boundaries within a training arena for a Reinforcement Learning unit, by rejecting state transitions that are outside permitted ranges.

14. The system of claim 1,
wherein at least one of the Offline Protection Unit and the Online Protection Unit, is further configured to perform:
(i) automatically imposing and enforcing safe exploration boundaries within a training arena for a Reinforcement Learning unit, by rejecting state transitions that are outside permitted ranges;
(ii) detecting adversarial modifications to environment mechanics in the training arena in which the Reinforcement Learning unit is trained;
(iii) pausing or stopping a training session of the Reinforcement Learning unit if an estimated risk scores exceed a threshold value.

15. The system of claim 1,
wherein at least one of the Offline Protection Unit and the Online Protection Unit, is further configured to perform:
(i) analyzing interaction histories associated with training sessions of a Reinforcement Learning unit;
(ii) validating causal relationships between states and actions of the Reinforcement Learning unit, by utilizing causal graphs and counter-factual checks;
(iii) verifying that observed state trajectories of the Reinforcement Learning unit match legitimate operational sequences; and flagging anomalous deviations that are indicative of trace-manipulating attacks or gradual policy corruption.

16. The system of claim 1,
wherein at least one of the Offline Protection Unit and the Online Protection Unit, is further configured to perform:
(i) applying temporal pattern recognition across extended sequences of interactions of an AI-based Agentic Unit;
(ii) identifying deviations from baseline behaviors of said AI-based Agentic Unit, by utilizing one or more sequential anomaly detectors;
(iii) classifying said deviations as either (I) benign deviations or (II) risky deviations that are part of malicious attempts to corrupt long-term operational behavior of the AI-based Agentic Unit;
and performing escalation operations or remediation operations that are conditioned on deviation persistence, deviation amplitude, and contextual criticality.

17. The system of claim 1,
wherein at least one of the Offline Protection Unit and the Online Protection Unit, is further configured to perform:
(i) performing an evaluation of actions and interactions that are performed by an AI-based Agentic Unit, to generate performance metrics that reflect: (I) quality and scope of digital tool usage by the AI-based Agentic Unit, (II) effectiveness level of web-searches performed by the AI-based Agentic Unit, (III) effectiveness level of database queries performed by the AI-based Agentic Unit;
(ii) correlating between (I) degradations of said performance metrics, and (II) detected indicators of adversarial exploitation or manipulative query injection;
(iii) automatically distinguishing between a benign variance and an attack-driven shift, by employing at least one of: (I) a set of rules and conditions, (II) a pre-trained Machine Learning (ML) model, (III) a statistical analysis, to distinguish natural variance from attack-driven shifts.

18. The system of claim 1,
wherein at least one of the Offline Protection Unit and the Online Protection Unit, is further configured to perform:
(i) generating evaluation metrics for an AI-based Agentic Unit, by (I) performing assessment of multi-step planning by the AI-based Agentic Unit, and (II) measuring efficiency in utilizing information resources and digital tools by the AI-based Agentic Unit, and (III) estimating an effectiveness of collaboration of the AI-based Agentic Unit with digital tools, and (IV) determining a goal achievement rate of said AI-based Agentic Unit;
(ii) based on the evaluation metrics that were determined in step (i), automatically distinguishing between: (I) a benign or an under-performing AI-based Agentic Unit, and (B) an attack-driven AI-based Agentic Unit,
wherein said distinguishing is performed by employing at least one of: (I) a set of rules and conditions, (II) a pre-trained Machine Learning (ML) model, (III) a statistical analysis, to distinguish natural variance from attack-driven shifts.

19. The system of claim 1,
wherein at least one of the Offline Protection Unit and the Online Protection Unit, is further configured to perform:
(i) enforcing governance policies by restricting decision-autonomy boundaries of an AI-based Agentic Unit;
(ii) constraining tool-usage behaviors of the AI-based Agentic Unit by enforcing at least one of: capability white-lists for the AI-based Agentic Unit, capabilities black-lists for the AI-based Agentic Unit;
(iii) defining acceptable limits for autonomous decision-making by the AI-based Agentic Unit, and automatically triggering approval workflows for elevated operations of the AI-based Agentic Unit, and automatically triggering revocation of operations attempted by the AI-based Agentic Unit upon detected mis-use or upon attempted policy circumvention.

20. The system of claim 1,
wherein at least one of the Offline Protection Unit and the Online Protection Unit, is further configured to perform:
(i) analyzing operational context of the Protected Engine, by (I) evaluating a deployment environment of the Protected Engine, and (II) evaluating regulatory obligations that apply to an entity operating the Protected Engine, and (III) evaluating use-case criticality associated with the Protected Engine, and (IV) evaluating threat landscape related to the Protected Engine, and (V) evaluating operational patterns of the Protected Engine;
(ii) responsive to the analyzing of step (i) in view of contextual characterization, adding or modifying protective actions towards the Protected Engine.

21. The system of claim 1,
wherein at least one of the Offline Protection Unit and the Online Protection Unit, is further configured to perform:
(i) ingesting publicly-available information, organizational guidelines, historical operational records, and domain-specific regulations;
(ii) synthesizing the inputs of step (i) into a contextual representation using entity resolution and provenance scoring;
(iii) adapting protection strategies of the Protected Engine to said contextual representation, while also preserving explainability and traceable justification.

22. The system of claim 1,
wherein at least one of the Offline Protection Unit and the Online Protection Unit, is further configured to perform:
(i) operating an autonomous protection layer that detects distribution shifts, evolving threats, regulatory changes, operational modifications, and deployment updates;
(ii) re-allocating defensive resources toward higher-priority vulnerabilities of the Protected Engine by optimizing selection, sequencing, and frequency of protective evaluations.

23. The system of claim 1,
wherein at least one of the Offline Protection Unit and the Online Protection Unit, is further configured to perform:
(i) managing governance by defining, scheduling, and executing required evaluations of the Protected Engine;
(ii) optimizing defensive operations for the Protected Engine, through criticality-weighted prioritization and dependency-aware planning;
(iii) balancing between (I) computational resource utilization and (II) vulnerabilities and regulatory requirements, based on an adaptive and performance-constrained policy.

24. The system of claim 1,
wherein at least one of the Offline Protection Unit and the Online Protection Unit, is further configured to perform:
re-classifying a previously-evaluated action or output or input of the Protected Engine, that had previously been classified as benign or legitimate, into a re-classification as hostile or malicious;
wherein the re-classifying is based on analyzing operational context of the Protected Engine, by (I) evaluating a deployment environment of the Protected Engine, and (II) evaluating regulatory obligations that apply to an entity operating the Protected Engine, and (III) evaluating use-case criticality associated with the Protected Engine, and (IV) evaluating threat landscape related to the Protected Engine, and (V) evaluating operational patterns of the Protected Engine.

25. The system of claim 1,
wherein at least one of the Offline Protection Unit and the Online Protection Unit, is further configured to perform:
dynamically and automatically modifying an architecture of the Protected Engine, by causing the Protected Engine to selectively output deceptive or obfuscated results, toward entities identified as malicious-query originators.

26. The system of claim 1,
wherein at least one of the Offline Protection Unit and the Online Protection Unit, is further configured to perform:
modifying the Protected Engine to automatically output, as a defensive control, one or more misleading responses that comprise decoy information, intentionally incomplete information, or perturbed outputs that are selectively directed to suspected hostile sources; wherein said misleading responses at least potentially contribute to reducing an effectiveness of subsequent adversarial probing by adversaries or adversarial adaptation by adversaries.

27. The system of claim 1,
wherein at least one of the Offline Protection Unit and the Online Protection Unit, is further configured to perform:
automatically invoking a secondary AI-based engine, (i) to perform classification and contextual analysis of an input query from an originating entity, and (ii) to determine whether or not said input query is part of a malicious attack against the Protected Engine.

28. The system of claim 1,
wherein at least one of the Offline Protection Unit and the Online Protection Unit, is further configured to perform:
automatically invoking a secondary AI-based engine to analyze semantics and context, of an incoming query that is incoming to the Protected Engine, and to detect indirect traces of adversarial activity or coordinated probing or automated exploitation that are indicative of an attack targeting the Protected Engine or targeting component that are dependent thereon.

29. The system of claim 1,
wherein at least one of the Offline Protection Unit and the Online Protection Unit, is further configured to perform:
automatically modifying an operational structure of the Protected Engine, by converting it into a multi-engine pipeline or a multi-engine cascade, to distribute processing and to enable cross-validation of intermediate results for increased resilience relative to operation as a single stand-alone engine.

30. The system of claim 1,
wherein at least one of the Offline Protection Unit and the Online Protection Unit, is further configured to perform:
automatically modifying the Protected Engine, from operating as an independent unit, to operating as a participant within a coordinated multi-engine pipeline that supplies redundancy, consistency checks, and enhanced robustness against malicious attacks compared to isolated operation of the Protected Engine.

31. The system of claim 1,
wherein at least one of the Offline Protection Unit and the Online Protection Unit,
comprises a Weak-Spot Detector that is configured (i) to cluster input data into groups according to shared attributes, and (ii) to compare accuracy of the Protected Engine across said groups, and (iii) to quantify deviations, and (iv) to identify weaknesses in handling inputs by detecting weaknesses that exhibit specific common characteristics that are likely to induce error.

32. The system of claim 1,
wherein at least one of the Offline Protection Unit and the Online Protection Unit,
comprises a Detector that is configured (i) to partition incoming inputs into subsets, and (ii) to evaluate accuracy of performance of the Protected Engine accuracy across said subsets, and (iii) to automatically flag vulnerabilities of the Protected Engine based upon a detection of outcomes that are inaccurate or unstable for inputs demonstrating recurring patterns or properties that are estimated to be associated with elevated risk.

33. The system of claim 1,
wherein at least one of the Offline Protection Unit and the Online Protection Unit,
comprises an AI-based Brainstormer unit that invokes a plurality of LLMs and an LLM coordination unit, wherein the AI-based Brainstormer unit organizes automated interactions among the plurality of LLMs, and synthesizes outputs generated by the LLMs, and generates actionable recommendations based on synthesized outputs from the LLMs;
wherein the actionable recommendations from the AI-based Brainstormer unit are utilized automatically by at least one of the Offline Protection Unit and the Online Protection Unit to fortify the Protected Engine against attacks.

34. The system of claim 1,
wherein at least one of the Offline Protection Unit and the Online Protection Unit,
comprises an AI-based Brainstormer unit that is associated with a plurality of LLMs and a moderator model,
wherein the AI-based Brainstormer unit allocates interaction slots to the LLMs, manages inter-model communications, and extracts combined insights to enhance resilience of the Protected Engine against attacks;
wherein the AI-based Brainstormer unit generates actionable insights that are utilized automatically, by at least one of the Offline Protection Unit and the Online Protection Unit, to fortify the Protected Engine against attacks.

35. The system of claim 1,
wherein at least one of the Offline Protection Unit and the Online Protection Unit,
is implemented by itself by utilizing a Protective Engine that is at least one of: a Machine Learning (ML) unit, a Deep Learning (DL) unit, a Reinforcement Learning (RL) unit, a Supervised Learning (SL) unit, an Artificial Intelligence (AI) unit, a Neural Network (NN) unit, a Large Language Model (LLM) unit, a large Vision-and-Language Model (VLM), a Large Multi-Modalities Model (LMMM), an AI-based Agentic unit,
and applies recursively, to its own Protective Engine, fortification methods that it also applies towards the Protected Engine.

36. The system of claim 1,
wherein at least one of the Offline Protection Unit and the Online Protection Unit is further configured:
to verify factual assertions within generated outputs of the Protected Engine, against authenticated corpora or retrieval systems,
to compute confidence and consistency scores,
to annotate low-confidence outputs with citations, and
to record verification artifacts in an immutable audit trail to ensure transparency and accountability.

37. The system of claim 1, comprising:
a protective AI firewall unit, that is configured to enforce operator-defined policy constraints by (a) dynamically analyzing proposed outputs of the Protected Engine, (b) detecting conflicts with codified organizational rules or contractual procedures, (c) intercepting impermissible actions, and (d) ensuring that generated responses from the Protected Engine remain aligned with pre-defined institutional frameworks governing permissible transactions, disclosures, and user interactions.

38. The system of claim 1, comprising:
a protection unit configured to enforce user permissions by (a) cross-referencing incoming requests to the Protected Engine against an access-control schema, (b) withholding unauthorized data from the Protected Engine, (c) causing the Protected Engine to decline execution of prohibited actions, and (e) ensuring that interactions remain bounded by authorized privileges and preventing overreach by unauthorized users.

39. The system of claim 1,
wherein individual protective units of the system incorporate feature-specific context awareness, by receiving contextual information as structured text or multi-modal parameters that are injected directly into prompts, and by enabling adversarial simulation and vulnerability testing that reflects real operating conditions comprising at least generation of context-tailored prompt injection attempts, wherein the system is configured to achieve contextual intelligence and reveals vulnerabilities that remain undetected under generic context-agnostic security evaluations.

40. The system of claim 1, comprising:
a supervised internal-state classifier, that is trained on labeled corpora of benign patterns and attack patterns, that utilizes multi-scale latent descriptors, and serializes telemetry from monitored layers of the Protected Engine;
wherein the supervised internal-state classifier generates as output attack likelihood indicators that are bound to audit records;
wherein the supervised internal-state classifier generates audit bindings that comprise input hashes, classifier verdicts, and causal attribution links;
wherein the supervised internal-state classifier is configured to ensure that attack determinations are reproducible, reviewable, and cryptographically verifiable within post-incident forensic analysis.

41. The system of claim 1, comprising:
anomaly detection models that are trained on benign latent tensors,
and that are configured (a) to detect deviations in activation distributions, and (b) to generate stability indices;
wherein flagged anomalies are cross-validated by ensemble detectors and escalated to causal tests when thresholds are exceeded;
wherein the escalation workflow binds localized latent evidence and stability metrics to audit artifacts, to ensure proportionate and explainable defense activation against previously unseen adversarial strategies.

42. The system of claim 1, comprising:
an Input Modification Unit that is configured to project signals into a safe subspace by injecting stochastic perturbations, performing one or more compression and decompression cycles, and applying diffusion-based denoising that is pre-trained to restore natural data manifolds;
one or more Input Acceptance Gates that are configured (a) to evaluate adversarial risk of inputs to the Protected Engine based on semantic similarity to known malicious inputs, (b) to authorize advancement of only sufficiently preserved signals to the Protected Engine.

43. The system of claim 1, comprising:
a protection unit that is configured (a) to generate multiple parallel transformed versions of an input through distinct transformation pathways, (b) to submit said multiple parallel transformed versions concurrently to the Protected Engine, (c) to aggregate results from the Protected Engine via consensus adjudication that favors majority or weighted stability;
wherein discrepancies above learned thresholds trigger at least one of: input quarantines, confidence downgrades, attack mitigation actions;
wherein consensus outcomes, disagreements, and associated metadata are preserved within audit artifacts for accountability.

44. The system of claim 1, comprising:
a protection unit that is configured (a) to mask or attenuate suspected adversarial regions within multi-modal inputs, based on localization detectors and improbable text token rarity metrics, (b) to actively limit adversarial inputs while preserving unaffected content;
wherein localized transformations are logged with mask geometries, rarity thresholds, and decision rationales.

45. The system of claim 1,
wherein at least one of the Offline Protection Unit and the Online Protection Unit is further configured:
(a) to generate modality-aware attribution masks that localize putative attack regions,
wherein the masks comprise:
pixel-based masks or polygon-based masks for images and videos,
time-and-frequency tiles for audio,
token spans for text;
(b) to apply targeted mitigation of malicious inputs by masking, attenuation, or manifold projection solely within the localized attack region while preserving unaffected content.

46. The system of claim 1,
wherein at least one of the Offline Protection Unit and the Online Protection Unit is configured:
(a) to train supervised detectors on annotated adversarial corpora and unsupervised models that surface anomalous regions by deviations from natural statistics;
(b) to escalate localized findings to causal tests using counter-factual ablations and stability replays;
(c) to bind mask geometry, confidence scores, and mitigation outcomes to an audit artifact linked to the input and output.

47. The system of claim 1, comprising:
an Output Protection Unit that is configured (a) to evaluate proposed responses for semantic implausibility, policy deviation, privacy leakage, toxicity, and goal-incongruent reasoning, by utilizing (i) confidence scores, entropy scores, embedding-space distance to exemplars, citation sufficiency, and alignment checks to operator policies and user permissions;
(b) upon risk detection, to withhold or redact or regenerate content, under constrained decoding, to provide modified output from the Protected Engine.

48. The system of claim 1,
wherein at least one of the Offline Protection Unit and the Online Protection Unit is further configured to operate in a black-box interposition mode, by (i) mediating requests to and responses from an API of the Protected Engine, and (ii) performing input validation, and (iii) rewriting inputs, and (iv) enforcing rate governance and policy-bound templating, and (v) on egress applying output redaction, privacy controls, factuality checks, toxicity screening, and safety screening.

49. The system of claim 1,
wherein at least one of the Offline Protection Unit and the Online Protection Unit is further configured (a) to operate in a black-box observer mode that does not inspect internal parameters of the Protected Engine, and (b) to determine behavioral telemetry over an input-and-output channel of the Protected Engine by analyzing (b1) query composition features and (b2) cadence and burst patterns and (b3) response entropy and instability, and (c) to trigger policy-based alerts and automated throttling.

50. The system of claim 1, comprising:
a fairness validator unit that is configured (a) to automatically conduct sub-group audits under covariate control, by generating matched-condition counterfactuals and synthetic exemplars via one or more generative models, and (b) to automatically quantify disparity using metrics that comprise at least one of true-positive-rate gap, false-negative-rate difference, equalized-odds deviation, demographic parity delta, and (c) to automatically generate a remediation plan comprising one or more of re-weighting coefficients, sampling quotas, targeted curation of underrepresented cohorts.

51. The system of claim 1, comprising:
a Continuous Drift Detector that is configured (a) to dynamically differentiate between (I) covariate data-oriented drift and (II) concept-oriented label-semantic drift, by monitoring change-points in feature distributions and performance residuals using, and (b) to generate drift vectors along interpretable axes that comprise at least one of lighting, geography, time-of-day, class semantics, and (c) to trigger one or more targeted mitigation actions comprising at least one of adaptive thresholds, localized recalibration, and selective fine-tuning.

52. The system of claim 1, comprising:
a Drift Detector Unit that generates drift indicators that are projected into representational axes that are shared with an evasion-attack taxonomy;
a Risk Aligner Unit that computes composite risk scores as a function of drift severity and adversarial exploitability under matched conditions;
an Attack Simulator to generate and execute scenario simulations to stress-test protections detectors.

53. A computerized method,
that is implementable by utilizing one or more processors that are configured to execute code, wherein the one or more processors are operably associated with one or more memory units that are configured to store code;
wherein the computerized method comprises:
protecting a Protected Engine that is a unit selected from the group consisting of: a Machine Learning (ML) unit, a Deep Learning (DL) unit, a Reinforcement Learning (RL) unit, a Supervised Learning (SL) unit, an Artificial Intelligence (AI) unit, a Neural Network (NN) unit, a Large Language Model (LLM) unit, a large Vision-and-Language Model (VLM), a Large Multi-Modalities Model (LMMM), an AI-based Agentic unit;
protecting said Protected Engine against at least one of: malicious inputs, malicious queries, malicious training data, malicious attacks;
by performing at least one of:
(a) operating an Offline Protection Unit, to analyze one or more characteristics of the Protected Engine, and to perform offline fortification of said Protected Engine against attacks by changing one or more operational properties or operational parameters of the Protected Engine and to reduce its vulnerability to attacks;
(b) operating an Online Protection Unit, to perform analysis of at least one of: (i) one or more inputs that are ingested by the Protected Engine, (ii) one or more outputs that are generated by the Protected Engine; and based on said analysis, to dynamically perform online fortification of said Protected Engine against attacks by dynamically changing one or more operational properties or operational parameters of the Protected Engine to reduce its vulnerability to attacks.
